(19) United States
(12) Patent Application Publication
(10) Pub. No.: US 2022/0365189 A1
(43) Pub. Date: Nov. 17, 2022

(54) RANGE CALIBRATION FOR LIDAR SYSTEMS

(71) Applicant: Luminar, LLC, Orlando, FL (US)

(72) Inventor: James T. Nathan, Orlando, FL (US)

(21) Appl. No.: 17/741,576

(22) Filed: May 11, 2022

Related U.S. Application Data
(60) Provisional application No. 63/186,941, filed on May 11, 2021.

(51) Int. Cl. G01S 7/497; G01S 17/10; G01S 7/4865

(52) U.S. Cl. CPC G01S 7/497; G01S 17/10; G01S 7/4865

(57) ABSTRACT

A system comprises an interface and an optical network. The interface is configured to receive a pulse of light emitted by a lidar device and the optical network is configured to provide a particular temporal delay of one or more different temporal delays to the received pulse of light. The system is configured to direct the temporal delayed pulse to the lidar device.

### CROSS REFERENCE TO OTHER APPLICATIONS

This application claims priority to U.S. Provisional Patent Application No. 63/186,941 entitled RANGE CALIBRATION AND GEOMETRIC CALIBRATION FOR LIDAR SYSTEMS filed May 11, 2021 which is incorporated herein by reference for all purposes.

### BACKGROUND OF THE INVENTION

Light detection and ranging (lidar) is a technology that can be used to measure distances to remote targets. Typically, a lidar system includes a light source and an optical receiver. The light source can include, for example, a laser which emits light having a particular operating wavelength. The operating wavelength of a lidar system may lie, for example, in the infrared, visible, or ultraviolet portions of the electromagnetic spectrum. The light source emits light toward a target which scatters the light, and some of the scattered light is received back at the receiver. The system determines the distance to the target based on one or more characteristics associated with the received light. For example, the lidar system may determine the distance to the target based on the time of flight for a pulse of light emitted by the light source to travel to the target and back to the lidar system.

### BRIEF DESCRIPTION OF THE DRAWINGS

Various embodiments of the invention are disclosed in the following detailed description and the accompanying drawings.

FIG. 1 illustrates an example light detection and ranging (lidar) system.

FIG. 2 illustrates an example scan pattern produced by a lidar system.

FIG. 3 illustrates an example lidar system with an example rotating polygon mirror.

FIG. 4 illustrates an example light-source field of view (FOVL) and receiver field of view (FOVR) for a lidar system.

FIG. 5 illustrates an example unidirectional scan pattern that includes multiple pixels and multiple scan lines.

FIG. 6 illustrates an example lidar system that includes a light source that emits pulses of light.

FIG. 7 illustrates an example receiver that includes a detector, an electronic amplifier, and a pulse-detection circuit.

FIG. 8 illustrates an example receiver and an example voltage signal corresponding to a received pulse of light.

FIG. 9 illustrates an embodiment of a system for performing calibration of a lidar system.

FIG. 10 illustrates an embodiment of a calibration support platform for performing calibration of a lidar system.

FIG. 11 illustrates an embodiment of a transceiver assembly for performing calibration of a lidar system.

FIG. 12 illustrates an embodiment of a transceiver assembly for performing calibration of a lidar system.

FIG. 13 illustrates an embodiment of an optical network for performing calibration of a lidar system.

FIG. 14 illustrates an embodiment of a variable optical delay unit for performing calibration of a lidar system.

FIG. 15 illustrates an embodiment of a variable optical delay unit for performing calibration of a lidar system.

FIG. 16 illustrates an embodiment of a monitoring module for performing calibration of a lidar system.

FIG. 17 illustrates an embodiment of a system for performing calibration of a lidar system.

FIG. 18 illustrates an embodiment of a target element for performing calibration of a lidar system.

FIG. 19 illustrates an embodiment of a cross section of a fixture with a target element for performing calibration of a lidar system.

FIG. 20 illustrates an embodiment of a target element for performing calibration of a lidar system.

FIG. 21 illustrates an embodiment of a target element for performing calibration of a lidar system.

FIG. 22 is a flow chart illustrating an embodiment of a process for performing a range calibration of a lidar system.

FIG. 23 is a flow chart illustrating an embodiment of a process for configuring a calibration system for performing range calibration of a lidar system.

FIG. 24 is a flow chart illustrating an embodiment of a process for performing a geometric calibration of a lidar system.

FIG. 25 is a flow chart illustrating an embodiment of a process for configuring a calibration system for performing geometric calibration of a lidar system.

FIG. 26 illustrates an example computer system.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Lidar system calibration is disclosed. Using the disclosed systems and techniques, a lidar system can be calibrated for accuracy in a test environment with limited space. In various embodiments, a lidar system is mounted to a calibration system that simulates a target object at a distance. The calibration system is configured to test the lidar system and can include a variety of tests including tests with different simulated distances. The calibration system includes an optical platform for controlling stability including minimizing vibrations and for aiming the test lidar system. The calibration system further includes one or more transceiver assemblies for capturing at least a portion of the emitted output beams from the lidar system and transmitting back the simulated reflections of the output beams on one or more simulated targets. In various embodiments, each target and its configured distance are simulated using an optical network. The simulated distance of the optical network can be configured from a large range of distances, such as from 5 to 300+ meters. The optical network can further attenuate a received light signal to simulate environmental and/or target properties such as reflectance. For example, the calibration system can be used for calibrating reflectance measurements of a lidar system.

In various embodiments, the disclosed calibration systems are highly accurate and have significant performance, space, and cost advantages. For example, the disclosed calibration systems can be applied to verify ranges within +5 to −5 mm or less. Moreover, the disclosed systems are significantly more compact than configuring a live target in a real-world test environment. By simulating the target using at least in part an optical network to introduce delays, the disclosed calibration systems require a minimal footprint while improving accuracy. Additionally, the minimal footprint allows the disclosed systems to be housed indoors and are insensitive to weather and occlusions. The configurable nature of the calibration system further allows for performing a wide variety of tests to simulate different test conditions in a repeatable, reliable, and cost-effective manner. The calibration system can be used for verification of existing lidar systems and/or to calibrate and/or tune a lidar system for production.

In some embodiments, a calibration system for calibrating the distance measurement of a lidar system may include an optical receiver, an optical transmitter, and a network of free-space, fiber-optic, and/or other optical components (which may be referred to as a network of devices, a fiber-optic network, an optical network, or a network). The optical receiver may be referred to as an optical input device, and the optical transmitter may be referred to as an optical output device. In some embodiments, the optical receiver and optical transmitter are implemented as part of a transceiver assembly. A lidar system or rangefinder that is undergoing calibration may be referred to as a lidar system under test or as a device under test (DUT). The DUT launches pulses of light into free space. Some of the pulses are incident on the receiver of the calibration system. The receiver may couple one or more of the incident pulses into an optical waveguide, such as an optical fiber, where a network of devices may measure, temporally delay, and/or modulate the pulses. A temporally delayed and/or modulated optical pulse exits the transmitter and returns via free-space propagation to the lidar system. The lidar system perceives the pulse as a return of arbitrary range and reflectance, depending on the chosen temporal delay and modulation parameters. In this way, the range-calibration system acts as a surrogate for a large range of ideal targets. In various embodiments, a range-calibration system may include a chain of optical devices that act as a surrogate target of arbitrary range and reflectance.

In some embodiments, an optical-measurement device may be used periodically, or integrated permanently, with the disclosed calibration systems to precisely measure the time-of-flight (ToF) or optical path length (OPL) through one or all of the configurations of an optical network of a calibration system. The optical-measurement device may include an optical frequency-domain reflectometer (OFDR), an optical spectrum analyzer (OSA), or an optical time-domain reflectometer (OTDR). The optical-measurement device may be used to establish a ground truth for each configuration of the range-calibration system regardless of optical path perturbation. In some scenarios, perturbations may arise due to changes in the state of the device under test or the calibration system, such as the use of an optical switch, adjustment of free-space optics, replacement of the device under test, or path-length changes associated with changes in ambient temperature. An OSA, in combination with an optical source with the appropriately large spectral bandwidth, may be used as an OFDR to estimate absolute OPL via measurement of the longitudinal mode spacing of a cavity formed by the OFDR and the DUT.

In some embodiments, an embodiment of the disclosed calibration system is utilized for use with a rangefinder subassembly as a lidar system, as opposed to a fully assembled lidar sensor head. As used herein, the term lidar system may refer to a complete lidar sensor head or a portion or subassembly thereof (e.g., a rangefinder subassembly of a lidar system). A rangefinder subassembly may include a light source that emits pulses of light and a receiver that detects received pulses of light. A rangefinder subassembly may also include a scanner that scans the emitted pulses of light across a field of regard.

In some embodiments, a range-calibration system may be used to simulate (i) targets located over any suitable range of distances (e.g., from 2 m to 20 km) from a lidar system and/or (ii) targets having any suitable optical reflectivity (e.g., from 10% reflectivity to 90% reflectivity). For example, a range-calibration system may be used to simulate targets located at a continuously adjustable distance from the lidar system of 20 m to 250 m. As another example, a range-calibration system may be used to simulate targets located at one or more particular discrete distances from the lidar system (e.g., 30 m, 50, 100 m, 200 m, 250 m, 300 m, 450 m). As another example, a range-calibration system may be used to simulate targets having a particular fixed reflectivity (e.g., 10% reflectivity) or a continuously adjustable reflectivity (e.g., 10% to 50% reflectivity). Both range and reflectance may be adjusted at the same time, for example, to simulate a 10% reflective target at a 200 m distance.

In some embodiments, a calibration system comprises an interface and an optical network. The interface is configured to receive a pulse of light emitted by a lidar device. For example, a lidar device under test is configured to emit a pulse of light as part of a calibration process. The emitted pulse of light is received at an interface of the calibration system. The input interface can be an input to a transceiver assembly of the calibration system. In some embodiments, the optical network is configured to provide a particular temporal delay of one or more different temporal delays to the received pulse of light. For example, the transceiver assembly directs the received pulse of light to an optical network, where the pulse is delayed due to the pulse's time-of-flight in the optical network. The particular amount of delay to add to the pulse can be configurable. In various embodiments, the calibration system is configured to direct the temporal delayed pulse to the lidar device. The lidar system detects the delayed pulse and determines a distance measurement based on the emitted pulse of light and its corresponding return pulse. By comparing the determined distance measurement to the true (or reference) distance value, the lidar system can be calibrated for accuracy.

In some embodiments, the disclosed calibration systems can further perform geometric calibration. For example, a lidar system is mounted to a calibration system that can be surrounded by one or more lidar calibration targets. For example, three or more calibration targets are placed in the lidar system's field of view. In some embodiments, the different calibration targets correspond to different points in the test lidar system's field of view and each simulates a different target at a configured simulated distance. Each disclosed lidar calibration target includes a waveguide, such as one using multi-mode optical fibers. When a light pulse from the lidar system reaches a calibration target, a portion of light is captured and travels along the waveguide of the calibration target. When the far end of the waveguide is reached, reflections are generated, for example, using a Fresnel reflection at the end of a fiber end face, and are returned back towards the test lidar system. At the test lidar system, the reflected light pulse is received and analyzed for accuracy. In various embodiments, the azimuth, elevation, and range values reported by the test lidar system are compared to expected values and used to calibrate and/or verify the accuracy of the test lidar system.

In some embodiments, a geometric calibration system provides a ground-truth geometry that is compared with azimuth, elevation, or range values reported by a lidar system under test. The reported azimuth, elevation, or range values reported by the lidar sensor may be in conflict with the ground truth geometry of an imaged scene. Using the calibration system, the accuracy of a lidar sensor of a lidar system can be measured and improved. For example, the geometric calibration results can include correction values to adjust and/or calibrate the geometric accuracy of the lidar system.

A geometric calibration system may include a geometric-calibration target with three or more optical waveguides (e.g., optical fibers) positioned in particular locations relative to a lidar system under test. In some embodiments, the geometric-calibration target is a fixture and each waveguide is associated with a target element mounted on the fixture. The lidar system images the geometric-calibration target and the resultant data is processed. The output is a set of transformation parameters that correspond to a geometric calibration for the lidar system. In some embodiments, geometric calibration results are determined and can include one or more azimuth correction values and/or one or more elevation correction values.

The geometric-calibration target may be a fixture and can include any suitable number of target elements with optical waveguides which subtend different points in the field of regard (FOR) of the lidar system under test. In some embodiments, the waveguides may have auxiliary optics to improve coupling of energy between the lidar system and the target. For example, a lens may be positioned at the input of each waveguide to couple light into the waveguide.

In various embodiments, as part of a calibration process, the lidar system under test scans an emitted optical beam across a field of regard of the lidar system. A portion of the pulses of light from the lidar system may be coupled into the optical waveguides of the geometric-calibration target. For example, a target element can capture a portion of a light pulse emitted from the lidar system and propagate the light pulse through an optical network. In various embodiments, the pulses propagate along the length of the optical fiber. At the far end of the optical fiber, reflections are generated and return along the core back toward the DUT. In some embodiments, these reflections may be generated by Fresnel reflection (e.g., from the end or back face of the optical fiber). From the perspective of the lidar system, the return pulses appear to arrive from a much further distance than the near (or front) face of the target element due to the time-of-flight (ToF) of the pulse through the optical network. This ToF delay of the pulses of light may allow the geometric-calibration system to overcome a minimum-distance limitation for geometric calibration. For example, a lidar system may be unable to detect a pulse of light scattered from a target located less than 2 to 5 meters away.

In various embodiments, the geometry reported by the lidar system under test may be compared against the known geometry of the geometric-calibration target. Any discrepancy between the reported geometry and the known geometry may be used to determine a correction to apply to the azimuth, elevation, or range values reported by the lidar system. In some embodiments, a geometric-calibration system may be used to provide an indication of reflectance uniformity.

In some embodiments, a geometric-calibration target may include any suitable number of target elements with optical fibers (e.g., 2, 3, 5, 10, 20, 50, or 100 optical fibers), and the input end of each fiber face may be positioned at a particular location in a rigid fixture. Each fiber input end represents a sample point of the geometric-calibration system. The fixture geometry may be characterized, for example, with a coordinate measurement machine (CMM) or a reference lidar system. Only one or a few sensor poses may be required because the sample points may fill the FOR and may be closely spaced.

In some embodiments, a system comprises a first and second interface. For example, a geometric-calibration system includes two (or more) target elements, each with an input interface. At least a portion of a first interface is configured to receive a first pulse of light emitted by a lidar device positioned at a placement location. For example, the first target element receives a first pulse of light from a lidar device under test. In some embodiments, a first optical guide is configured to propagate the received first pulse of light, wherein at least a portion of the first interface is configured to emit towards the lidar device from a first reference output location a first free-space optical beam version of the received first pulse of light that propagated through the first optical guide. For example, the first target element includes a waveguide to propagate and then reflect the received light back to the lidar device as a free-space optical beam. At least a portion of a second interface is configured to receive a second pulse of light emitted by the lidar device positioned at the same placement location. For example, the second target element receives a second pulse of light from the lidar device under test. A lidar device may emit two or more pulses simultaneously. The second pulse may be a pulse subsequent or simultaneous to the first pulse. In some embodiments, a second optical guide is configured to propagate the received second pulse of light, wherein at least a portion of the second interface is configured to emit towards the lidar device from a second reference output location a second free-space optical beam version of the received second pulse of light that propagated through the second optical guide. For example, similar to the first target element, the second target element also includes a waveguide to propagate and then reflect the received light back to the lidar device as a free-space optical beam. The lidar device receives both free-space optical beams, one from a location associated with the first target element and one from a location associated with the second target element. Using the emitted and received light pulses, the lidar device can determine a geometric position for each target element, for example, by azimuth, elevation, and range relative to the lidar device. By comparing the determined position with their actual configured reference locations, the lidar device can be calibrated for accuracy.

A lidar system operates in a vehicle and includes multiple “eyes,” each of which has its own field of regard, or an angular range over which the eye scans targets using pulses of light in accordance with a scan pattern. The fields of regard can combine along a certain dimension (e.g., horizontally) to define the overall field of regard of the lidar system. The lidar system then can use data received via both eyes to generate a point cloud or otherwise process the received data.

In a two-eye configuration of the lidar system, the two eyes can be housed together and scan the respective fields of regard via a shared window or separate windows, or the eyes can be housed separately. In the latter case, an assembly referred to as a “sensor head” can include a scanner, a receiver, and an optical element such as a collimator or a laser diode to generate or convey a beam of light.

Depending on the implementation, each eye of a lidar system can include a separate scanner (e.g., each eye can be equipped with a pivotable scan mirror to scan the field of regard vertically and another pivotable scan mirror to scan the field of regard horizontally), a partially shared scanner (e.g., each eye can be equipped with a pivotable scan mirror to scan the field of regard vertically, and a shared polygon mirror can scan the corresponding fields of regard horizontally, using different reflective surfaces), or a fully shared scanner (e.g., a pivotable planar mirror can scan the fields of regard vertically by reflecting incident beams at different regions on the reflective surface, and a shared polygon mirror can scan the corresponding fields of regard horizontally, using different reflective surfaces).

Different hardware configurations allow the lidar system to operate the eyes more independently of each other, as is the case with separate scanners, or less independently, as is the case with a fully shared scanner. For example, the two or more eyes may scan the respective fields of regard using similar or different scan patterns. In one implementation, the two eyes trace out the same pattern, but with a certain time differential to maintain angular separation between light-source fields of view and thereby reduce the probability of cross-talk events between the sensor heads. In another implementation, the two eyes scan the corresponding fields of regard according to different scan patterns, at least in some operational states (e.g., when the vehicle is turning right or left).

Further, according to one approach, two eyes of a lidar system are arranged so that the fields of regard of the eyes are adjacent and non-overlapping. For example, each field of regard can span approximately 60 degrees horizontally and 30 degrees vertically, so that the combined field of regard of the lidar system spans approximately 120 degrees horizontally and 30 degrees vertically. The corresponding scanners (or paths within a shared scanner) can point away from each other at a certain angle, for example, so that the respective fields of regard abut approximately at an axis corresponding to the forward-facing direction of the vehicle.

Alternatively, the lidar system can operate in a “cross-eyed” configuration to create an area of overlap between the fields of regard. The area of overlap can be approximately centered along the forward-facing direction or another direction, which in some implementations a controller can determine dynamically. In this implementation, the two sensor heads can yield a higher density of scan in the area that generally is more important. In some implementations, the fields of regard in a cross-eyed two-eye configuration are offset from each other by a half-pixel value, so that the area of overlap has twice as many pixels. In general, the fields of regard can overlap angularly or translationally. To reduce the probability of cross-talk events (e.g., the situation when a pulse emitted by the light source associated with the first eye is received by the receiver of the second eye), the lidar system can use output beams with different wavelengths.

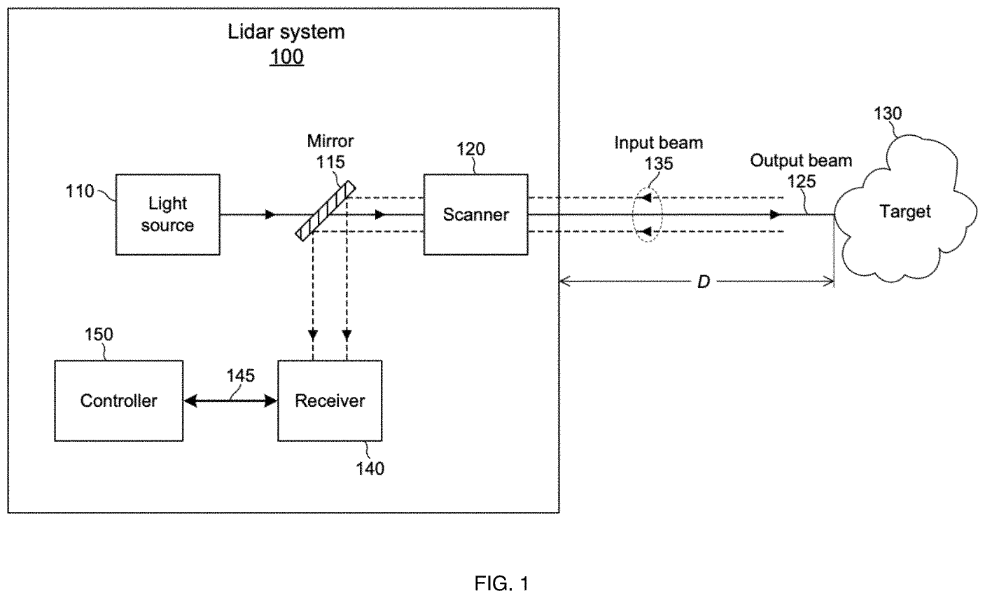

FIG. 1 illustrates an example light detection and ranging (lidar) system 100. In particular embodiments, a lidar system 100 may be referred to as a laser ranging system, a laser radar system, a LIDAR system, a lidar sensor, or a laser detection and ranging (LADAR or ladar) system. In particular embodiments, a lidar system 100 may include a light source 110, mirror 115, scanner 120, receiver 140, or controller 150. The light source 110 may include, for example, a laser which emits light having a particular operating wavelength in the infrared, visible, or ultraviolet portions of the electromagnetic spectrum. As an example, light source 110 may include a laser with one or more operating wavelengths between approximately 900 nanometers (nm) and 2000 nm. The light source 110 emits an output beam of light 125 which may be continuous wave (CW), pulsed, or modulated in any suitable manner for a given application. The output beam of light 125 is directed downrange toward a remote target 130. As an example, the remote target 130 may be located a distance D of approximately 1 m to 1 km from the lidar system 100.

Once the output beam 125 reaches the downrange target 130, the target may scatter or reflect at least a portion of light from the output beam 125, and some of the scattered or reflected light may return toward the lidar system 100. In the example of FIG. 1, the scattered or reflected light is represented by input beam 135, which passes through scanner 120 and is reflected by mirror 115 and directed to receiver 140. In particular embodiments, a relatively small fraction of the light from output beam 125 may return to the lidar system 100 as input beam 135. As an example, the ratio of input beam 135 average power, peak power, or pulse energy to output beam 125 average power, peak power, or pulse energy may be approximately 10⁻¹, 10⁻², 10⁻³, 10⁻⁴, 10⁻⁵, 10⁻⁶, 10⁻⁷, 10⁻⁸, 10⁻⁹, 10⁻¹⁰, 10⁻¹¹, or 10⁻¹². As another example, if a pulse of output beam 125 has a pulse energy of 1 microjoule (μJ), then the pulse energy of a corresponding pulse of input beam 135 may have a pulse energy of approximately 10 nanojoules (nJ), 1 nJ, 100 picojoules (pJ), 10 pJ, 1 pJ, 100 femtojoules (fJ), 10 fJ, 1 fJ, 100 attojoules (aJ), 10 aJ, 1 aJ, or 0.1 aJ.

In particular embodiments, output beam 125 may include or may be referred to as an optical signal, output optical signal, emitted optical signal, emitted pulse of light, laser beam, light beam, optical beam, emitted beam, emitted light, or beam. In particular embodiments, input beam 135 may include or may be referred to as a received optical signal, received pulse of light, input pulse of light, input optical signal, return beam, received beam, return light, received light, input light, scattered light, or reflected light. As used herein, scattered light may refer to light that is scattered or reflected by a target 130. As an example, an input beam 135 may include: light from the output beam 125 that is scattered by target 130; light from the output beam 125 that is reflected by target 130; or a combination of scattered and reflected light from target 130.

In particular embodiments, receiver 140 may receive or detect photons from input beam 135 and produce one or more representative signals. For example, the receiver 140 may produce an output electrical signal 145 that is representative of the input beam 135, and the electrical signal 145 may be sent to controller 150. In particular embodiments, receiver 140 or controller 150 may include a processor, computing system (e.g., an ASIC or FPGA), or other suitable circuitry. A controller 150 may be configured to analyze one or more characteristics of the electrical signal 145 from the receiver 140 to determine one or more characteristics of the target 130, such as its distance downrange from the lidar system 100. This may be done, for example, by analyzing a time of flight or a frequency or phase of a transmitted beam of light 125 or a received beam of light 135. If lidar system 100 measures a time of flight of ΔT (e.g., ΔT represents a round-trip time of flight for an emitted pulse of light to travel from the lidar system 100 to the target 130 and back to the lidar system 100), then the distance D from the target 130 to the lidar system 100 may be expressed as D=c·ΔT/2, where c is the speed of light (approximately 3.0×10⁸ m/s). As an example, if a time of flight is measured to be ΔT=300 ns, then the distance from the target 130 to the lidar system 100 may be determined to be approximately D=45.0 m. As another example, if a time of flight is measured to be ΔT=1.33 μs, then the distance from the target 130 to the lidar system 100 may be determined to be approximately D=199.5 m. In particular embodiments, a distance D from lidar system 100 to a target 130 may be referred to as a distance, depth, or range of target 130. As used herein, the speed of light c refers to the speed of light in any suitable medium, such as for example in air, water, or vacuum. As an example, the speed of light in vacuum is approximately 2.9979×10⁸ m/s, and the speed of light in air (which has a refractive index of approximately 1.0003) is approximately 2.9970×10⁸ m/s.

In particular embodiments, light source 110 may include a pulsed or CW laser. As an example, light source 110 may be a pulsed laser configured to produce or emit pulses of light with a pulse duration or pulse width of approximately 10 picoseconds (ps) to 100 nanoseconds (ns). The pulses may have a pulse duration (Δτ) of approximately 100 ps, 200 ps, 400 ps, 1 ns, 2 ns, 5 ns, 10 ns, 20 ns, 50 ns, 100 ns, or any other suitable pulse duration. As another example, light source 110 may be a pulsed laser that produces pulses with a pulse duration of approximately 1-5 ns. As another example, light source 110 may be a pulsed laser that produces pulses at a pulse repetition frequency of approximately 80 kHz to 10 MHz or a pulse period (e.g., a time between consecutive pulses) of approximately 100 ns to 12.5 μs. In particular embodiments, light source 110 may have a substantially constant pulse repetition frequency, or light source 110 may have a variable or adjustable pulse repetition frequency. As an example, light source 110 may be a pulsed laser that produces pulses at a substantially constant pulse repetition frequency of approximately 640 kHz (e.g., 640,000 pulses per second), corresponding to a pulse period of approximately 1.56 μs. As another example, light source 110 may have a pulse repetition frequency (which may be referred to as a repetition rate) that can be varied from approximately 200 kHz to 3 MHz. As used herein, a pulse of light may be referred to as an optical pulse, a light pulse, or a pulse.

In particular embodiments, light source 110 may include a pulsed or CW laser that produces a free-space output beam 125 having any suitable average optical power. As an example, output beam 125 may have an average power of approximately 1 milliwatt (mW), 10 mW, 100 mW, 1 watt (W), 10 W, or any other suitable average power. In particular embodiments, output beam 125 may include optical pulses with any suitable pulse energy or peak optical power. As an example, output beam 125 may include pulses with a pulse energy of approximately 0.01 μJ, 0.1 μJ, 0.5 μJ, 1 μJ, 2 μJ, 10 μJ, 100 μJ, 1 mJ, or any other suitable pulse energy. As another example, output beam 125 may include pulses with a peak power of approximately 10 W, 100 W, 1 kW, 5 kW, 10 kW, or any other suitable peak power. The peak power (Pₚₑₐₖ) of a pulse of light can be related to the pulse energy (E) by the expression E=Pₚₑₐₖ·Δt, where Δt is the duration of the pulse, and the duration of a pulse may be defined as the full width at half maximum duration of the pulse. For example, an optical pulse with a duration of 1 ns and a pulse energy of 1 μJ has a peak power of approximately 1 kW. The average power (Pₐᵥ) of an output beam 125 can be related to the pulse repetition frequency (PRF) and pulse energy by the expression Pₐᵥ=PRF·E. For example, if the pulse repetition frequency is 500 kHz, then the average power of an output beam 125 with 1-μJ pulses is approximately 0.5 W.

In particular embodiments, light source 110 may include a laser diode, such as for example, a Fabry-Perot laser diode, a quantum well laser, a distributed Bragg reflector (DBR) laser, a distributed feedback (DFB) laser, a vertical-cavity surface-emitting laser (VCSEL), a quantum dot laser diode, a grating-coupled surface-emitting laser (GCSEL), a slab-coupled optical waveguide laser (SCOWL), a single-transverse-mode laser diode, a multi-mode broad area laser diode, a laser-diode bar, a laser-diode stack, or a tapered-stripe laser diode. As an example, light source 110 may include an aluminum-gallium-arsenide (AlGaAs) laser diode, an indium-gallium-arsenide (InGaAs) laser diode, an indium-gallium-arsenide-phosphide (InGaAsP) laser diode, or a laser diode that includes any suitable combination of aluminum (Al), indium (In), gallium (Ga), arsenic (As), phosphorous (P), or any other suitable material. In particular embodiments, light source 110 may include a pulsed or CW laser diode with a peak emission wavelength between 1200 nm and 1600 nm. As an example, light source 110 may include a current-modulated InGaAsP DFB laser diode that produces optical pulses at a wavelength of approximately 1550 nm. As another example, light source 110 may include a laser diode that emits light at a wavelength between 1500 nm and 1510 nm.

In particular embodiments, light source 110 may include a pulsed or CW laser diode followed by one or more optical-amplification stages. For example, a seed laser diode may produce a seed optical signal, and an optical amplifier may amplify the seed optical signal to produce an amplified optical signal that is emitted by the light source 110. In particular embodiments, an optical amplifier may include a fiber-optic amplifier or a semiconductor optical amplifier (SOA). For example, a pulsed laser diode may produce relatively low-power optical seed pulses which are amplified by a fiber-optic amplifier. As another example, a light source 110 may include a fiber-laser module that includes a current-modulated laser diode with an operating wavelength of approximately 1550 nm followed by a single-stage or a multi-stage erbium-doped fiber amplifier (EDFA) or erbium-ytterbium-doped fiber amplifier (EYDFA) that amplifies the seed pulses from the laser diode. As another example, light source 110 may include a continuous-wave (CW) or quasi-CW laser diode followed by an external optical modulator (e.g., an electro-optic amplitude modulator). The optical modulator may modulate the CW light from the laser diode to produce optical pulses which are sent to a fiber-optic amplifier or SOA. As another example, light source 110 may include a pulsed or CW seed laser diode followed by a semiconductor optical amplifier (SOA). The SOA may include an active optical waveguide configured to receive light from the seed laser diode and amplify the light as it propagates through the waveguide. The optical gain of the SOA may be provided by pulsed or direct-current (DC) electrical current supplied to the SOA. The SOA may be integrated on the same chip as the seed laser diode, or the SOA may be a separate device with an anti-reflection coating on its input facet or output facet. As another example, light source 110 may include a seed laser diode followed by an SOA, which in turn is followed by a fiber-optic amplifier. For example, the seed laser diode may produce relatively low-power seed pulses which are amplified by the SOA, and the fiber-optic amplifier may further amplify the optical pulses.

In particular embodiments, light source 110 may include a direct-emitter laser diode. A direct-emitter laser diode (which may be referred to as a direct emitter) may include a laser diode which produces light that is not subsequently amplified by an optical amplifier. A light source 110 that includes a direct-emitter laser diode may not include an optical amplifier, and the output light produced by a direct emitter may not be amplified after it is emitted by the laser diode. The light produced by a direct-emitter laser diode (e.g., optical pulses, CW light, or frequency-modulated light) may be emitted directly as a free-space output beam 125 without being amplified. A direct-emitter laser diode may be driven by an electrical power source that supplies current pulses to the laser diode, and each current pulse may result in the emission of an output optical pulse.

In particular embodiments, light source 110 may include a diode-pumped solid-state (DPSS) laser. A DPSS laser (which may be referred to as a solid-state laser) may refer to a laser that includes a solid-state, glass, ceramic, or crystal-based gain medium that is pumped by one or more pump laser diodes. The gain medium may include a host material that is doped with rare-earth ions (e.g., neodymium, erbium, ytterbium, or praseodymium). For example, a gain medium may include a yttrium aluminum garnet (YAG) crystal that is doped with neodymium (Nd) ions, and the gain medium may be referred to as a Nd:YAG crystal. A DPSS laser with a Nd:YAG gain medium may produce light at a wavelength between approximately 1300 nm and approximately 1400 nm, and the Nd:YAG gain medium may be pumped by one or more pump laser diodes with an operating wavelength between approximately 730 nm and approximately 900 nm. A DPSS laser may be a passively Q-switched laser that includes a saturable absorber (e.g., a vanadium-doped crystal that acts as a saturable absorber). Alternatively, a DPSS laser may be an actively Q-switched laser that includes an active Q-switch (e.g., an acousto-optic modulator or an electro-optic modulator). A passively or actively Q-switched DPSS laser may produce output optical pulses that form an output beam 125 of a lidar system 100.

In particular embodiments, an output beam of light 125 emitted by light source 110 may be a collimated optical beam having any suitable beam divergence, such as for example, a full-angle beam divergence of approximately 0.5 to 10 milliradians (mrad). A divergence of output beam 125 may refer to an angular measure of an increase in beam size (e.g., a beam radius or beam diameter) as output beam 125 travels away from light source 110 or lidar system 100. In particular embodiments, output beam 125 may have a substantially circular cross section with a beam divergence characterized by a single divergence value. As an example, an output beam 125 with a circular cross section and a full-angle beam divergence of 2 mrad may have a beam diameter or spot size of approximately 20 cm at a distance of 100 m from lidar system 100. In particular embodiments, output beam 125 may have a substantially elliptical cross section characterized by two divergence values. As an example, output beam 125 may have a fast axis and a slow axis, where the fast-axis divergence is greater than the slow-axis divergence. As another example, output beam 125 may be an elliptical beam with a fast-axis divergence of 4 mrad and a slow-axis divergence of 2 mrad.

In particular embodiments, an output beam of light 125 emitted by light source 110 may be unpolarized or randomly polarized, may have no specific or fixed polarization (e.g., the polarization may vary with time), or may have a particular polarization (e.g., output beam 125 may be linearly polarized, elliptically polarized, or circularly polarized). As an example, light source 110 may produce light with no specific polarization or may produce light that is linearly polarized.

In particular embodiments, lidar system 100 may include one or more optical components configured to reflect, focus, filter, shape, modify, steer, or direct light within the lidar system 100 or light produced or received by the lidar system 100 (e.g., output beam 125 or input beam 135). As an example, lidar system 100 may include one or more lenses, mirrors, filters (e.g., band-pass or interference filters), beam splitters, polarizers, polarizing beam splitters, wave plates (e.g., half-wave or quarter-wave plates), diffractive elements, holographic elements, isolators, optical splitters, couplers, detectors, beam combiners, or collimators. The optical components in a lidar system 100 may be free-space optical components, fiber-coupled optical components, or a combination of free-space and fiber-coupled optical components.

In particular embodiments, lidar system 100 may include a telescope, one or more lenses, or one or more mirrors configured to expand, focus, or collimate the output beam 125 or the input beam 135 to a desired beam diameter or divergence. As an example, the lidar system 100 may include one or more lenses to focus the input beam 135 onto a photodetector of receiver 140. As another example, the lidar system 100 may include one or more flat mirrors or curved mirrors (e.g., concave, convex, or parabolic mirrors) to steer or focus the output beam 125 or the input beam 135. For example, the lidar system 100 may include an off-axis parabolic mirror to focus the input beam 135 onto a photodetector of receiver 140. As illustrated in FIG. 1, the lidar system 100 may include mirror 115 (which may be a metallic or dielectric mirror), and mirror 115 may be configured so that light beam 125 passes through the mirror 115 or passes along an edge or side of the mirror 115 and input beam 135 is reflected toward the receiver 140. As an example, mirror 115 (which may be referred to as an overlap mirror, superposition mirror, or beam-combiner mirror) may include a hole, slot, or aperture which output light beam 125 passes through. As another example, rather than passing through the mirror 115, the output beam 125 may be directed to pass alongside the mirror 115 with a gap (e.g., a gap of width approximately 0.1 mm, 0.5 mm, 1 mm, 2 mm, 5 mm, or 10 mm) between the output beam 125 and an edge of the mirror 115.

In particular embodiments, mirror 115 may provide for output beam 125 and input beam 135 to be substantially coaxial so that the two beams travel along approximately the same optical path (albeit in opposite directions). The input and output beams being substantially coaxial may refer to the beams being at least partially overlapped or sharing a common propagation axis so that input beam 135 and output beam 125 travel along substantially the same optical path (albeit in opposite directions). As an example, output beam 125 and input beam 135 may be parallel to each other to within less than 10 mrad, 5 mrad, 2 mrad, 1 mrad, 0.5 mrad, or 0.1 mrad. As output beam 125 is scanned across a field of regard, the input beam 135 may follow along with the output beam 125 so that the coaxial relationship between the two beams is maintained.

In particular embodiments, lidar system 100 may include a scanner 120 configured to scan an output beam 125 across a field of regard of the lidar system 100. As an example, scanner 120 may include one or more scanning mirrors configured to pivot, rotate, oscillate, or move in an angular manner about one or more rotation axes. The output beam 125 may be reflected by a scanning mirror, and as the scanning mirror pivots or rotates, the reflected output beam 125 may be scanned in a corresponding angular manner. As an example, a scanning mirror may be configured to periodically pivot back and forth over a 30-degree range, which results in the output beam 125 scanning back and forth across a 60-degree range (e.g., a 0-degree rotation by a scanning mirror results in a 20-degree angular scan of output beam 125).

In particular embodiments, a scanning mirror (which may be referred to as a scan mirror) may be attached to or mechanically driven by a scanner actuator or mechanism which pivots or rotates the mirror over a particular angular range (e.g., over a 5° angular range, 30° angular range, 60° angular range, 120° angular range, 360° angular range, or any other suitable angular range). A scanner actuator or mechanism configured to pivot or rotate a mirror may include a galvanometer scanner, a resonant scanner, a piezoelectric actuator, a voice coil motor, an electric motor (e.g., a DC motor, a brushless DC motor, a synchronous electric motor, or a stepper motor), a microelectromechanical systems (MEMS) device, or any other suitable actuator or mechanism. As an example, a scanner 120 may include a scanning mirror attached to a galvanometer scanner configured to pivot back and forth over a 1° to 30° angular range. As another example, a scanner 120 may include a scanning mirror that is attached to or is part of a MEMS device configured to scan over a 1° to 30° angular range. As another example, a scanner 120 may include a polygon mirror configured to rotate continuously in the same direction (e.g., rather than pivoting back and forth, the polygon mirror continuously rotates 360 degrees in a clockwise or counterclockwise direction). The polygon mirror may be coupled or attached to a synchronous motor configured to rotate the polygon mirror at a substantially fixed rotational frequency (e.g., a rotational frequency of approximately 1 Hz, 10 Hz, 50 Hz, 100 Hz, 500 Hz, or 1,000 Hz).

In particular embodiments, scanner 120 may be configured to scan the output beam 125 (which may include at least a portion of the light emitted by light source 110) across a field of regard of the lidar system 100. A field of regard (FOR) of a lidar system 100 may refer to an area, region, or angular range over which the lidar system 100 may be configured to scan or capture distance information. As an example, a lidar system 100 with an output beam 125 with a 30-degree scanning range may be referred to as having a 30-degree angular field of regard. As another example, a lidar system 100 with a scanning mirror that rotates over a 30-degree range may produce an output beam 125 that scans across a 60-degree range (e.g., a 60-degree FOR). In particular embodiments, lidar system 100 may have a FOR of approximately 10°, 20°, 40°, 60°, 120°, 360°, or any other suitable FOR.

In particular embodiments, scanner 120 may be configured to scan the output beam 125 horizontally and vertically, and lidar system 100 may have a particular FOR along the horizontal direction and another particular FOR along the vertical direction. As an example, lidar system 100 may have a horizontal FOR of 10° to 120° and a vertical FOR of 2° to 45°. In particular embodiments, scanner 120 may include a first scan mirror and a second scan mirror, where the first scan mirror directs the output beam 125 toward the second scan mirror, and the second scan mirror directs the output beam 125 downrange from the lidar system 100. As an example, the first scan mirror may scan the output beam 125 along a first direction, and the second scan mirror may scan the output beam 125 along a second direction that is substantially orthogonal to the first direction. As another example, the first scan mirror may scan the output beam 125 along a substantially horizontal direction, and the second scan mirror may scan the output beam 125 along a substantially vertical direction (or vice versa). As another example, the first and second scan mirrors may each be driven by galvanometer scanners. As another example, the first or second scan mirror may include a polygon mirror driven by an electric motor. In particular embodiments, scanner 120 may be referred to as a beam scanner, optical scanner, or laser scanner.

In particular embodiments, one or more scanning mirrors may be communicatively coupled to controller 150 which may control the scanning mirror(s) so as to guide the output beam 125 in a desired direction downrange or along a desired scan pattern. In particular embodiments, a scan pattern may refer to a pattern or path along which the output beam 125 is directed. As an example, scanner 120 may include two scanning mirrors configured to scan the output beam 125 across a 60° horizontal FOR and a 20° vertical FOR. The two scanner mirrors may be controlled to follow a scan path that substantially covers the 60°×20° FOR. As an example, the scan path may result in a point cloud with pixels that substantially cover the 60°×20° FOR. The pixels may be approximately evenly distributed across the 60°×20° FOR. Alternatively, the pixels may have a particular nonuniform distribution (e.g., the pixels may be distributed across all or a portion of the 60°×20° FOR, and the pixels may have a higher density in one or more particular regions of the 60°×20° FOR).

In particular embodiments, a lidar system 100 may include a scanner 120 with a solid-state scanning device. A solid-state scanning device may refer to a scanner 120 that scans an output beam 125 without the use of moving parts (e.g., without the use of a mechanical scanner, such as a mirror that rotates or pivots). For example, a solid-state scanner 120 may include one or more of the following: an optical phased array scanning device; a liquid-crystal scanning device; or a liquid lens scanning device. A solid-state scanner 120 may be an electrically addressable device that scans an output beam 125 along one axis (e.g., horizontally) or along two axes (e.g., horizontally and vertically). In particular embodiments, a scanner 120 may include a solid-state scanner and a mechanical scanner. For example, a scanner 120 may include an optical phased array scanner configured to scan an output beam 125 in one direction and a galvanometer scanner that scans the output beam 125 in an orthogonal direction. The optical phased array scanner may scan the output beam relatively rapidly in a horizontal direction across the field of regard (e.g., at a scan rate of 50 to 1,000 scan lines per second), and the galvanometer may pivot a mirror at a rate of 1-30 Hz to scan the output beam 125 vertically.

In particular embodiments, a lidar system 100 may include a light source 110 configured to emit pulses of light and a scanner 120 configured to scan at least a portion of the emitted pulses of light across a field of regard of the lidar system 100. One or more of the emitted pulses of light may be scattered by a target 130 located downrange from the lidar system 100, and a receiver 140 may detect at least a portion of the pulses of light scattered by the target 130. A receiver 140 may be referred to as a photoreceiver, optical receiver, optical sensor, detector, photodetector, or optical detector. In particular embodiments, lidar system 100 may include a receiver 140 that receives or detects at least a portion of input beam 135 and produces an electrical signal that corresponds to input beam 135. As an example, if input beam 135 includes an optical pulse, then receiver 140 may produce an electrical current or voltage pulse that corresponds to the optical pulse detected by receiver 140. As another example, receiver 140 may include one or more avalanche photodiodes (APDs) or one or more single-photon avalanche diodes (SPADs). As another example, receiver 140 may include one or more PN photodiodes (e.g., a photodiode structure formed by a p-type semiconductor and an n-type semiconductor, where the PN acronym refers to the structure having p-doped and n-doped regions) or one or more PIN photodiodes (e.g., a photodiode structure formed by an undoped intrinsic semiconductor region located between p-type and n-type regions, where the PIN acronym refers to the structure having p-doped, intrinsic, and n-doped regions). An APD, SPAD, PN photodiode, or PIN photodiode may each be referred to as a detector, photodetector, or photodiode. A detector may have an active region or an avalanche-multiplication region that includes silicon, germanium, InGaAs, InAsSb (indium arsenide antimonide), AlAsSb (aluminum arsenide antimonide), or AlInAsSb (aluminum indium arsenide antimonide). The active region may refer to an area over which a detector may receive or detect input light. An active region may have any suitable size or diameter, such as for example, a diameter of approximately 10 μm, 25 μm, 50 μm, 80 μm, 100 μm, 200 μm, 500 μm, 1 mm, 2 mm, or 5 mm.

In particular embodiments, receiver 140 may include electronic circuitry that performs signal amplification, sampling, filtering, signal conditioning, analog-to-digital conversion, time-to-digital conversion, pulse detection, threshold detection, rising-edge detection, or falling-edge detection. As an example, receiver 140 may include a transimpedance amplifier that converts a received photocurrent (e.g., a current produced by an APD in response to a received optical signal) into a voltage signal. The voltage signal may be sent to pulse-detection circuitry that produces an analog or digital output signal 145 that corresponds to one or more optical characteristics (e.g., rising edge, falling edge, amplitude, duration, or energy) of a received optical pulse. As an example, the pulse-detection circuitry may perform a time-to-digital conversion to produce a digital output signal 145. The electrical output signal 145 may be sent to controller 150 for processing or analysis (e.g., to determine a time-of-flight value corresponding to a received optical pulse).

In particular embodiments, a controller 150 (which may include or may be referred to as a processor, an FPGA, an ASIC, a computer, or a computing system) may be located within a lidar system 100 or outside of a lidar system 100. Alternatively, one or more parts of a controller 150 may be located within a lidar system 100, and one or more other parts of a controller 150 may be located outside a lidar system 100. In particular embodiments, one or more parts of a controller 150 may be located within a receiver 140 of a lidar system 100, and one or more other parts of a controller 150 may be located in other parts of the lidar system 100. For example, a receiver 140 may include an FPGA or ASIC configured to process an output electrical signal from the receiver 140, and the processed signal may be sent to a computing system located elsewhere within the lidar system 100 or outside the lidar system 100. In particular embodiments, a controller 150 may include any suitable arrangement or combination of logic circuitry, analog circuitry, or digital circuitry.

In particular embodiments, controller 150 may be electrically coupled or communicatively coupled to light source 110, scanner 120, or receiver 140. As an example, controller 150 may receive electrical trigger pulses or edges from light source 110, where each pulse or edge corresponds to the emission of an optical pulse by light source 110. As another example, controller 150 may provide instructions, a control signal, or a trigger signal to light source 110 indicating when light source 110 should produce optical pulses. Controller 150 may send an electrical trigger signal that includes electrical pulses, where each electrical pulse results in the emission of an optical pulse by light source 110. In particular embodiments, the frequency, period, duration, pulse energy, peak power, average power, or wavelength of the optical pulses produced by light source 110 may be adjusted based on instructions, a control signal, or trigger pulses provided by controller 150. In particular embodiments, controller 150 may be coupled to light source 110 and receiver 140, and controller 150 may determine a time-of-flight value for an optical pulse based on timing information associated with when the pulse was emitted by light source 110 and when a portion of the pulse (e.g., input beam 135) was detected or received by receiver 140. In particular embodiments, controller 150 may include circuitry that performs signal amplification, sampling, filtering, signal conditioning, analog-to-digital conversion, time-to-digital conversion, pulse detection, threshold detection, rising-edge detection, or falling-edge detection.

In particular embodiments, lidar system 100 may include one or more processors (e.g., a controller 150) configured to determine a distance D from the lidar system 100 to a target 130 based at least in part on a round-trip time of flight for an emitted pulse of light to travel from the lidar system 100 to the target 130 and back to the lidar system 100. The target 130 may be at least partially contained within a field of regard of the lidar system 100 and located a distance D from the lidar system 100 that is less than or equal to an operating range (R_{OP}) of the lidar system 100. In particular embodiments, an operating range (which may be referred to as an operating distance) of a lidar system 100 may refer to a distance over which the lidar system 100 is configured to sense or identify targets 130 located within a field of regard of the lidar system 100. The operating range of lidar system 100 may be any suitable distance, such as for example, 25 m, 50 m, 100 m, 200 m, 250 m, 500 m, or 1 km. As an example, a lidar system 100 with a 200-m operating range may be configured to sense or identify various targets 130 located up to 200 m away from the lidar system 100. The operating range R_{OP} of a lidar system 100 may be related to the time τ between the emission of successive optical signals by the expression R_{OP}=c·τ/2. For a lidar system 100 with a 200-m operating range (R_{OP}=200 m), the time τ between successive pulses (which may be referred to as a pulse period, a pulse repetition interval (PRI), or a time period between pulses) is approximately 2·R_{OP}/c≅1.33 μs. The pulse period τ may also correspond to the time of flight for a pulse to travel to and from a target 130 located a distance R_{OP} from the lidar system 100. Additionally, the pulse period τ may be related to the pulse repetition frequency (PRF) by the expression τ=1/PRF. For example, a pulse period of 1.33 μs corresponds to a PRF of approximately 752 kHz.

In particular embodiments, a lidar system 100 may be used to determine the distance to one or more downrange targets 130. By scanning the lidar system 100 across a field of regard, the system may be used to map the distance to a number of points within the field of regard. Each of these depth-mapped points may be referred to as a pixel or a voxel. A collection of pixels captured in succession (which may be referred to as a depth map, a point cloud, or a frame) may be rendered as an image or may be analyzed to identify or detect objects or to determine a shape or distance of objects within the FOR. As an example, a point cloud may cover a field of regard that extends 60° horizontally and 15° vertically, and the point cloud may include a frame of 100-2000 pixels in the horizontal direction by 4-400 pixels in the vertical direction.

In particular embodiments, lidar system 100 may be configured to repeatedly capture or generate point clouds of a field of regard at any suitable frame rate between approximately 0.1 frames per second (FPS) and approximately 1,000 FPS. As an example, lidar system 100 may generate point clouds at a frame rate of approximately 0.1 FPS, 0.5 FPS, 1 FPS, 2 FPS, 5 FPS, 10 FPS, 20 FPS, 100 FPS, 500 FPS, or 1,000 FPS. As another example, lidar system 100 may be configured to produce optical pulses at a rate of 5×10⁵ pulses/second (e.g., the system may determine 500,000 pixel distances per second) and scan a frame of 1000×50 pixels (e.g., 50,000 pixels/frame), which corresponds to a point-cloud frame rate of 10 frames per second (e.g., 10 point clouds per second). In particular embodiments, a point-cloud frame rate may be substantially fixed, or a point-cloud frame rate may be dynamically adjustable. As an example, a lidar system 100 may capture one or more point clouds at a particular frame rate (e.g., 1 Hz) and then switch to capture one or more point clouds at a different frame rate (e.g., 10 Hz). A slower frame rate (e.g., 1 Hz) may be used to capture one or more high-resolution point clouds, and a faster frame rate (e.g., 10 Hz) may be used to rapidly capture multiple lower-resolution point clouds.

In particular embodiments, a lidar system 100 may be configured to sense, identify, or determine distances to one or more targets 130 within a field of regard. As an example, a lidar system 100 may determine a distance to a target 130, where all or part of the target 130 is contained within a field of regard of the lidar system 100. All or part of a target 130 being contained within a FOR of the lidar system 100 may refer to the FOR overlapping, encompassing, or enclosing at least a portion of the target 130. In particular embodiments, target 130 may include all or part of an object that is moving or stationary relative to lidar system 100. As an example, target 130 may include all or a portion of a person, vehicle, motorcycle, truck, train, bicycle, wheelchair, pedestrian, animal, road sign, traffic light, lane marking, road-surface marking, parking space, pylon, guard rail, traffic barrier, pothole, railroad crossing, obstacle in or near a road, curb, stopped vehicle on or beside a road, utility pole, house, building, trash can, mailbox, tree, any other suitable object, or any suitable combination of all or part of two or more objects. In particular embodiments, a target may be referred to as an object.

In particular embodiments, light source 110, scanner 120, and receiver 140 may be packaged together within a single housing, where a housing may refer to a box, case, or enclosure that holds or contains all or part of a lidar system 100. As an example, a lidar-system enclosure may contain a light source 110, mirror 115, scanner 120, and receiver 140 of a lidar system 100. Additionally, the lidar-system enclosure may include a controller 150. The lidar-system enclosure may also include one or more electrical connections for conveying electrical power or electrical signals to or from the enclosure. In particular embodiments, one or more components of a lidar system 100 may be located remotely from a lidar-system enclosure. As an example, all or part of light source 110 may be located remotely from a lidar-system enclosure, and pulses of light produced by the light source 110 may be conveyed to the enclosure via optical fiber. As another example, all or part of a controller 150 may be located remotely from a lidar-system enclosure.

In particular embodiments, light source 110 may include an eye-safe laser, or lidar system 100 may be classified as an eye-safe laser system or laser product. An eye-safe laser, laser system, or laser product may refer to a system that includes a laser with an emission wavelength, average power, peak power, peak intensity, pulse energy, beam size, beam divergence, exposure time, or scanned output beam such that emitted light from the system presents little or no possibility of causing damage to a person's eyes. As an example, light source 110 or lidar system 100 may be classified as a Class 1 laser product (as specified by the 60825-1:2014 standard of the International Electrotechnical Commission (IEC)) or a Class I laser product (as specified by Title 21, Section 1040.10 of the United States Code of Federal Regulations (CFR)) that is safe under all conditions of normal use. In particular embodiments, lidar system 100 may be an eye-safe laser product (e.g., with a Class 1 or Class I classification) configured to operate at any suitable wavelength between approximately 900 nm and approximately 2100 nm. As an example, lidar system 100 may include a laser with an operating wavelength between approximately 1200 nm and approximately 1400 nm or between approximately 1400 nm and approximately 1600 nm, and the laser or the lidar system 100 may be operated in an eye-safe manner. As another example, lidar system 100 may be an eye-safe laser product that includes a scanned laser with an operating wavelength between approximately 900 nm and approximately 1700 nm. As another example, lidar system 100 may be a Class 1 or Class I laser product that includes a laser diode, fiber laser, or solid-state laser with an operating wavelength between approximately 1200 nm and approximately 1600 nm. As another example, lidar system 100 may have an operating wavelength between approximately 1500 nm and approximately 1510 nm.

In particular embodiments, one or more lidar systems 100 may be integrated into a vehicle. As an example, multiple lidar systems 100 may be integrated into a car to provide a complete 360-degree horizontal FOR around the car. As another example, 2-10 lidar systems 100, each system having a 45-degree to 180-degree horizontal FOR, may be combined together to form a sensing system that provides a point cloud covering a 360-degree horizontal FOR. The lidar systems 100 may be oriented so that adjacent FORs have an amount of spatial or angular overlap to allow data from the multiple lidar systems 100 to be combined or stitched together to form a single or continuous 360-degree point cloud. As an example, the FOR of each lidar system 100 may have approximately 1-30 degrees of overlap with an adjacent FOR. In particular embodiments, a vehicle may refer to a mobile machine configured to transport people or cargo. For example, a vehicle may include, may take the form of, or may be referred to as a car, automobile, motor vehicle, truck, bus, van, trailer, off-road vehicle, farm vehicle, lawn mower, construction equipment, forklift, robot, golf cart, motorhome, taxi, motorcycle, scooter, bicycle, skateboard, train, snowmobile, watercraft (e.g., a ship or boat), aircraft (e.g., a fixed-wing aircraft, helicopter, or dirigible), unmanned aerial vehicle (e.g., drone), or spacecraft. In particular embodiments, a vehicle may include an internal combustion engine or an electric motor that provides propulsion for the vehicle.

In particular embodiments, one or more lidar systems 100 may be included in a vehicle as part of an advanced driver assistance system (ADAS) to assist a driver of the vehicle in operating the vehicle. For example, a lidar system 100 may be part of an ADAS that provides information (e.g., about the surrounding environment) or feedback to a driver (e.g., to alert the driver to potential problems or hazards) or that automatically takes control of part of a vehicle (e.g., a braking system or a steering system) to avoid collisions or accidents. A lidar system 100 may be part of a vehicle ADAS that provides adaptive cruise control, automated braking, automated parking, collision avoidance, alerts the driver to hazards or other vehicles, maintains the vehicle in the correct lane, or provides a warning if an object or another vehicle is in a blind spot.

In particular embodiments, one or more lidar systems 100 may be integrated into a vehicle as part of an autonomous-vehicle driving system. As an example, a lidar system 100 may provide information about the surrounding environment to a driving system of an autonomous vehicle. An autonomous-vehicle driving system may be configured to guide the autonomous vehicle through an environment surrounding the vehicle and toward a destination. An autonomous-vehicle driving system may include one or more computing systems that receive information from a lidar system 100 about the surrounding environment, analyze the received information, and provide control signals to the vehicle's driving systems (e.g., brakes, accelerator, steering mechanism, lights, or turn signals). As an example, a lidar system 100 integrated into an autonomous vehicle may provide an autonomous-vehicle driving system with a point cloud every 0.1 seconds (e.g., the point cloud has a 10 Hz update rate, representing 10 frames per second). The autonomous-vehicle driving system may analyze the received point clouds to sense or identify targets 130 and their respective locations, distances, or speeds, and the autonomous-vehicle driving system may update control signals based on this information. As an example, if lidar system 100 detects a vehicle ahead that is slowing down or stopping, the autonomous-vehicle driving system may send instructions to release the accelerator and apply the brakes.

In particular embodiments, an autonomous vehicle may be referred to as an autonomous car, driverless car, self-driving car, robotic car, or unmanned vehicle. In particular embodiments, an autonomous vehicle may refer to a vehicle configured to sense its environment and navigate or drive with little or no human input. As an example, an autonomous vehicle may be configured to drive to any suitable location and control or perform all safety-critical functions (e.g., driving, steering, braking, parking) for the entire trip, with the driver not expected to control the vehicle at any time. As another example, an autonomous vehicle may allow a driver to safely turn their attention away from driving tasks in particular environments (e.g., on freeways), or an autonomous vehicle may provide control of a vehicle in all but a few environments, requiring little or no input or attention from the driver.

In particular embodiments, an autonomous vehicle may be configured to drive with a driver present in the vehicle, or an autonomous vehicle may be configured to operate the vehicle with no driver present. As an example, an autonomous vehicle may include a driver's seat with associated controls (e.g., steering wheel, accelerator pedal, and brake pedal), and the vehicle may be configured to drive with no one seated in the driver's seat or with little or no input from a person seated in the driver's seat. As another example, an autonomous vehicle may not include any driver's seat or associated driver's controls, and the vehicle may perform substantially all driving functions (e.g., driving, steering, braking, parking, and navigating) without human input. As another example, an autonomous vehicle may be configured to operate without a driver (e.g., the vehicle may be configured to transport human passengers or cargo without a driver present in the vehicle). As another example, an autonomous vehicle may be configured to operate without any human passengers (e.g., the vehicle may be configured for transportation of cargo without having any human passengers onboard the vehicle).

In particular embodiments, an optical signal (which may be referred to as a light signal, a light waveform, an optical waveform, an output beam, an emitted optical signal, or emitted light) may include pulses of light, CW light, amplitude-modulated light, frequency-modulated (FM) light, or any suitable combination thereof. Although this disclosure describes or illustrates example embodiments of lidar systems 100 or light sources 110 that produce optical signals that include pulses of light, the embodiments described or illustrated herein may also be applied, where appropriate, to other types of optical signals, including continuous-wave (CW) light, amplitude-modulated optical signals, or frequency-modulated optical signals. For example, a lidar system 100 as described or illustrated herein may be a pulsed lidar system and may include a light source 110 configured to produce pulses of light. Alternatively, a lidar system 100 may be configured to operate as a frequency-modulated continuous-wave (FMCW) lidar system and may include a light source 110 configured to produce CW light or a frequency-modulated optical signal.

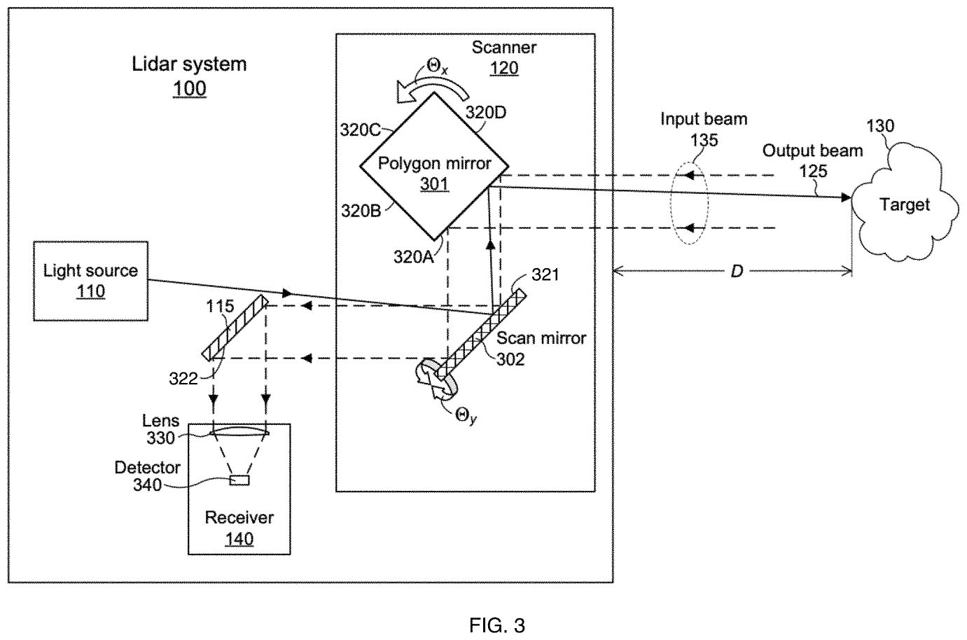

In particular embodiments, a lidar system 100 may be an FMCW lidar system where the emitted light from the light source 110 (e.g., output beam 125 in FIG. 1 or FIG. 3) includes frequency-modulated light. A pulsed lidar system is a type of lidar system 100 in which the light source 110 emits pulses of light, and the distance to a remote target 130 is determined based on the round-trip time-of-flight for a pulse of light to travel to the target 130 and back. Another type of lidar system 100 is a frequency-modulated lidar system, which may be referred to as a frequency-modulated continuous-wave (FMCW) lidar system. An FMCW lidar system uses frequency-modulated light to determine the distance to a remote target 130 based on a frequency of received light (which includes emitted light scattered by the remote target) relative to a frequency of local-oscillator (LO) light. A round-trip time for the emitted light to travel to a target 130 and back to the lidar system may correspond to a frequency difference between the received scattered light and the LO light. A larger frequency difference may correspond to a longer round-trip time and a greater distance to the target 130. The frequency difference between the received scattered light and the LO light may be referred to as a beat frequency.

For example, for a linearly chirped light source (e.g., a frequency modulation that produces a linear change in frequency with time), the larger the frequency difference between the LO light and the received light, the farther away the target 130 is located. The frequency difference may be determined by mixing the received light with the LO light (e.g., by coupling the two beams onto a detector so that they are coherently mixed or combined together, or by mixing analog electric signals corresponding to the received light and the emitted light) to produce a beat signal and determining the beat frequency of the beat signal. For example, an electrical signal from an APD may be analyzed using a fast Fourier transform (FFT) technique to determine the frequency difference between the emitted light and the received light. If a linear frequency modulation m (e.g., in units of Hz/s) is applied to a CW laser, then the round-trip time ΔT may be related to the frequency difference between the received scattered light and the emitted light ΔΦ by the expression Δτ=ΔΦ/m. Additionally, the distance D from the target 130 to the lidar system 100 may be expressed as D=c·ΔΦ/(2m), where c is the speed of light. For example, for a light source 110 with a linear frequency modulation of 10¹² Hz/s (or, 1 MHz/μs), if a frequency difference (between the received scattered light and the emitted light) of 330 kHz is measured, then the distance to the target is approximately 50 meters (which corresponds to a round-trip time of approximately 330 ns). As another example, a frequency difference of 1.33 MHz corresponds to a target located approximately 200 meters away.

A light source 110 for an FMCW lidar system may include (i) a direct-emitter laser diode, (ii) a seed laser diode followed by an SOA, (iii) a seed laser diode followed by a fiber-optic amplifier, or (iv) a seed laser diode followed by an SOA and then a fiber-optic amplifier. A seed laser diode or a direct-emitter laser diode may be operated in a CW manner (e.g., by driving the laser diode with a substantially constant DC current), and a frequency modulation may be provided by an external modulator (e.g., an electro-optic phase modulator may apply a frequency modulation to seed-laser light). Alternatively, a frequency modulation may be produced by applying a current modulation to a seed laser diode or a direct-emitter laser diode. The current modulation (which may be provided along with a DC bias current) may produce a corresponding refractive-index modulation in the laser diode, which results in a frequency modulation of the light emitted by the laser diode. The current-modulation component (and the corresponding frequency modulation) may have any suitable frequency or shape (e.g., piecewise linear, sinusoidal, triangle-wave, or sawtooth). For example, the current-modulation component (and the resulting frequency modulation of the emitted light) may increase or decrease monotonically over a particular time interval. As another example, the current-modulation component may include a triangle or sawtooth wave with an electrical current that increases or decreases linearly over a particular time interval, and the light emitted by the laser diode may include a corresponding frequency modulation in which the optical frequency increases or decreases approximately linearly over the particular time interval. For example, a light source 110 that emits light with a linear frequency change of 200 MHz over a 2-μs time interval may be referred to as having a frequency modulation m of 10¹⁴ Hz/s (or, 100 MHz/μs).

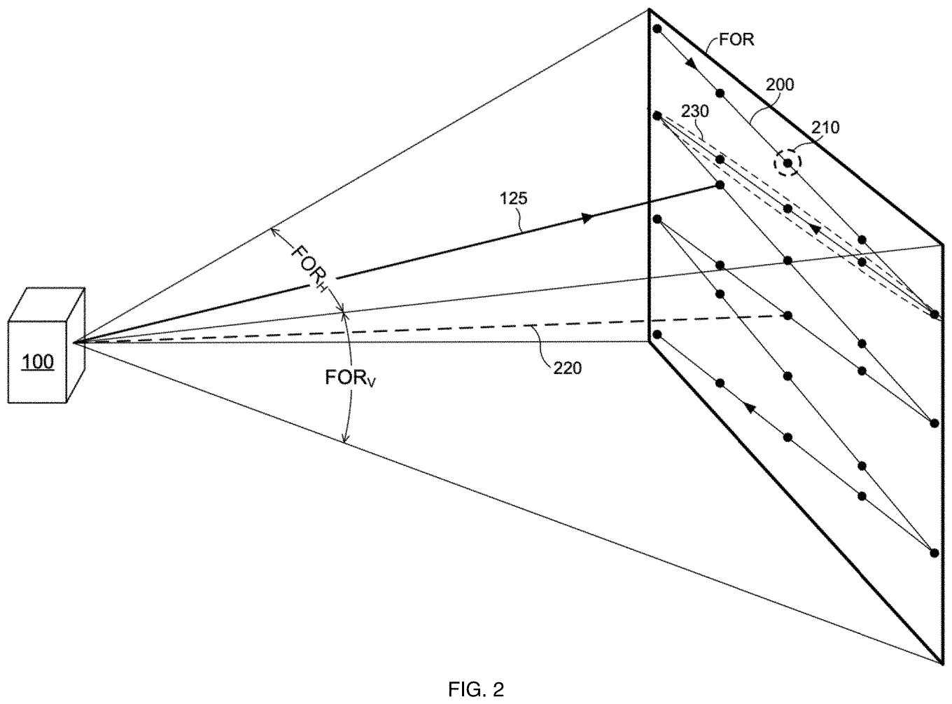

FIG. 2 illustrates an example scan pattern 200 produced by a lidar system 100. A scanner 120 of the lidar system 100 may scan the output beam 125 (which may include multiple emitted optical signals) along a scan pattern 200 that is contained within a field of regard (FOR) of the lidar system 100. A scan pattern 200 (which may be referred to as an optical scan pattern, optical scan path, scan path, or scan) may represent a path or course followed by output beam 125 as it is scanned across all or part of a FOR. Each traversal of a scan pattern 200 may correspond to the capture of a single frame or a single point cloud. In particular embodiments, a lidar system 100 may be configured to scan output optical beam 125 along one or more particular scan patterns 200. In particular embodiments, a scan pattern 200 may scan across any suitable field of regard (FOR) having any suitable horizontal FOR (FOR_{H}) and any suitable vertical FOR (FOR_{V}). For example, a scan pattern 200 may have a field of regard represented by angular dimensions (e.g., FOR_{H}×FOR_{V}) 40°×30°, 90°×40°, or 60°×15°. As another example, a scan pattern 200 may have a FOR_{H} greater than or equal to 10°, 25°, 30°, 40°, 60°, 90°, or 120°. As another example, a scan pattern 200 may have a FOR_{V} greater than or equal to 2°, 5°, 10°, 15°, 20°, 30°, or 45°.

In the example of FIG. 2, reference line 220 represents a center of the field of regard of scan pattern 200. In particular embodiments, reference line 220 may have any suitable orientation, such as for example, a horizontal angle of 0° (e.g., reference line 220 may be oriented straight ahead) and a vertical angle of 0° (e.g., reference line 220 may have an inclination of 0°), or reference line 220 may have a nonzero horizontal angle or a nonzero inclination (e.g., a vertical angle of +10° or −10°). In FIG. 2, if the scan pattern 200 has a 60°×15° field of regard, then scan pattern 200 covers a ±30° horizontal range with respect to reference line 220 and a ±7.5° vertical range with respect to reference line 220. Additionally, optical beam 125 in FIG. 2 has an orientation of approximately −15° horizontal and +3° vertical with respect to reference line 220. Optical beam 125 may be referred to as having an azimuth of −15° and an altitude of +3° relative to reference line 220. In particular embodiments, an azimuth (which may be referred to as an azimuth angle) may represent a horizontal angle with respect to reference line 220, and an altitude (which may be referred to as an altitude angle, elevation, or elevation angle) may represent a vertical angle with respect to reference line 220.

In particular embodiments, a scan pattern 200 may include multiple pixels 210, and each pixel 210 may be associated with one or more laser pulses or one or more distance measurements. Additionally, a scan pattern 200 may include multiple scan lines 230, where each scan line represents one scan across at least part of a field of regard, and each scan line 230 may include multiple pixels 210. In FIG. 2, scan line 230 includes five pixels 210 and corresponds to an approximately horizontal scan across the FOR from right to left, as viewed from the lidar system 100. In particular embodiments, a cycle of scan pattern 200 may include a total of Pₓ×P_{y} pixels 210 (e.g., a two-dimensional distribution of Pₓ by P_{y} pixels). As an example, scan pattern 200 may include a distribution with dimensions of approximately 100-2,000 pixels 210 along a horizontal direction and approximately 4-400 pixels 210 along a vertical direction. As another example, scan pattern 200 may include a distribution of 1,000 pixels 210 along the horizontal direction by 64 pixels 210 along the vertical direction (e.g., the frame size is 1000×64 pixels) for a total of 64,000 pixels per cycle of scan pattern 200. In particular embodiments, the number of pixels 210 along a horizontal direction may be referred to as a horizontal resolution of scan pattern 200, and the number of pixels 210 along a vertical direction may be referred to as a vertical resolution. As an example, scan pattern 200 may have a horizontal resolution of greater than or equal to 100 pixels 210 and a vertical resolution of greater than or equal to 4 pixels 210. As another example, scan pattern 200 may have a horizontal resolution of 100-2,000 pixels 210 and a vertical resolution of 4-400 pixels 210.

In particular embodiments, each pixel 210 may be associated with a distance (e.g., a distance to a portion of a target 130 from which an associated laser pulse was scattered) or one or more angular values. As an example, a pixel 210 may be associated with a distance value and two angular values (e.g., an azimuth and altitude) that represent the angular location of the pixel 210 with respect to the lidar system 100. A distance to a portion of target 130 may be determined based at least in part on a time-of-flight measurement for a corresponding pulse. An angular value (e.g., an azimuth or altitude) may correspond to an angle (e.g., relative to reference line 220) of output beam 125 (e.g., when a corresponding pulse is emitted from lidar system 100) or an angle of input beam 135 (e.g., when an input signal is received by lidar system 100). In particular embodiments, an angular value may be determined based at least in part on a position of a component of scanner 120. As an example, an azimuth or altitude value associated with a pixel 210 may be determined from an angular position of one or more corresponding scanning mirrors of scanner 120.

FIG. 3 illustrates an example lidar system 100 with an example rotating polygon mirror 301. In particular embodiments, a scanner 120 may include a polygon mirror 301 configured to scan output beam 125 along a particular direction. In the example of FIG. 3, scanner 120 includes two scanning mirrors: (1) a polygon mirror 301 that rotates along the Θₓ direction and (2) a scanning mirror 302 that oscillates back and forth along the Θ_{y} direction. The output beam 125 from light source 110, which passes alongside mirror 115, is reflected by reflecting surface 321 of scan mirror 302 and is then reflected by a reflecting surface (e.g., surface 320A, 320B, 320C, or 320D) of polygon mirror 301. Scattered light from a target 130 returns to the lidar system 100 as input beam 135. The input beam 135 reflects from polygon mirror 301, scan mirror 302, and mirror 115, which directs input beam 135 through focusing lens 330 and to the detector 340 of receiver 140. As shown in FIG. 3, scan mirror 302 includes reflecting surface 321 and mirror 115 includes reflecting surface 322. The detector 340 may be a PN photodiode, a PIN photodiode, an APD, an SPAD, or any other suitable detector. A reflecting surface 320 (which may be referred to as a reflective surface) may include a reflective metallic coating (e.g., gold, silver, or aluminum) or a reflective dielectric coating, and the reflecting surface 320 may have any suitable reflectivity R at an operating wavelength of the light source 110 (e.g., R greater than or equal to 70%, 80%, 90%, 95%, 98%, or 99%).

In particular embodiments, a polygon mirror 301 may be configured to rotate along a Θₓ or Θ_{y} direction and scan output beam 125 along a substantially horizontal or vertical direction, respectively. A rotation along a Ox direction may refer to a rotational motion of mirror 301 that results in output beam 125 scanning along a substantially horizontal direction. Similarly, a rotation along a Θ_{y} direction may refer to a rotational motion that results in output beam 125 scanning along a substantially vertical direction. In FIG. 3, mirror 301 is a polygon mirror that rotates along the Θₓ direction and scans output beam 125 along a substantially horizontal direction, and mirror 302 pivots along the Θ_{y} direction and scans output beam 125 along a substantially vertical direction. In particular embodiments, a polygon mirror 301 may be configured to scan output beam 125 along any suitable direction. As an example, a polygon mirror 301 may scan output beam 125 at any suitable angle with respect to a horizontal or vertical direction, such as for example, at an angle of approximately 0°, 10°, 20°, 30°, 45°, 60°, 70°, 80°, or 90° with respect to a horizontal or vertical direction.

In particular embodiments, a polygon mirror 301 may refer to a multi-sided object having reflective surfaces 320 on two or more of its sides or faces. As an example, a polygon mirror may include any suitable number of reflective faces (e.g., 2, 3, 4, 5, 6, 7, 8, or 10 faces), where each face includes a reflective surface 320. A polygon mirror 301 may have a cross-sectional shape of any suitable polygon, such as for example, a triangle (with three reflecting surfaces 320), square (with four reflecting surfaces 320), pentagon (with five reflecting surfaces 320), hexagon (with six reflecting surfaces 320), heptagon (with seven reflecting surfaces 320), or octagon (with eight reflecting surfaces 320). In FIG. 3, the polygon mirror 301 has a substantially square cross-sectional shape and four reflecting surfaces (320A, 320B, 320C, and 320D). The polygon mirror 301 in FIG. 3 may be referred to as a square mirror, a cube mirror, or a four-sided polygon mirror. In FIG. 3, the polygon mirror 301 may have a shape similar to a cube, cuboid, or rectangular prism. Additionally, the polygon mirror 301 may have a total of six sides, where four of the sides include faces with reflective surfaces (320A, 320B, 320C, and 320D).

In particular embodiments, a polygon mirror 301 may be continuously rotated in a clockwise or counter-clockwise rotation direction about a rotation axis of the polygon mirror 301. The rotation axis may correspond to a line that is perpendicular to the plane of rotation of the polygon mirror 301 and that passes through the center of mass of the polygon mirror 301. In FIG. 3, the polygon mirror 301 rotates in the plane of the drawing, and the rotation axis of the polygon mirror 301 is perpendicular to the plane of the drawing. An electric motor may be configured to rotate a polygon mirror 301 at a substantially fixed frequency (e.g., a rotational frequency of approximately 1 Hz (or 1 revolution per second), 10 Hz, 50 Hz, 100 Hz, 500 Hz, or 1,000 Hz). As an example, a polygon mirror 301 may be mechanically coupled to an electric motor (e.g., a synchronous electric motor) which is configured to spin the polygon mirror 301 at a rotational speed of approximately 160 Hz (or, 9600 revolutions per minute (RPM)).

In particular embodiments, output beam 125 may be reflected sequentially from the reflective surfaces 320A, 320B, 320C, and 320D as the polygon mirror 301 is rotated. This results in the output beam 125 being scanned along a particular scan axis (e.g., a horizontal or vertical scan axis) to produce a sequence of scan lines, where each scan line corresponds to a reflection of the output beam 125 from one of the reflective surfaces of the polygon mirror 301. In FIG. 3, the output beam 125 reflects off of reflective surface 320A to produce one scan line. Then, as the polygon mirror 301 rotates, the output beam 125 reflects off of reflective surfaces 320B, 320C, and 320D to produce a second, third, and fourth respective scan line. In particular embodiments, a lidar system 100 may be configured so that the output beam 125 is first reflected from polygon mirror 301 and then from scan mirror 302 (or vice versa). As an example, an output beam 125 from light source 110 may first be directed to polygon mirror 301, where it is reflected by a reflective surface of the polygon mirror 301, and then the output beam 125 may be directed to scan mirror 302, where it is reflected by reflective surface 321 of the scan mirror 302. In the example of FIG. 3, the output beam 125 is reflected from the polygon mirror 301 and the scan mirror 302 in the reverse order. In FIG. 3, the output beam 125 from light source 110 is first directed to the scan mirror 302, where it is reflected by reflective surface 321, and then the output beam 125 is directed to the polygon mirror 301, where it is reflected by reflective surface 320A.

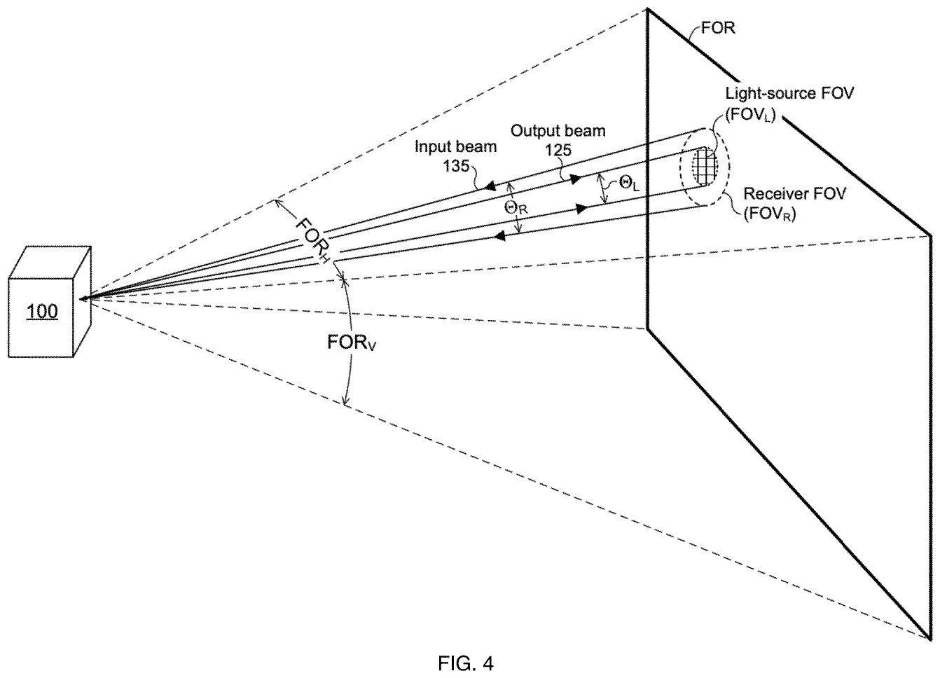

FIG. 4 illustrates an example light-source field of view (FOVL) and receiver field of view (FOVR) for a lidar system 100. A light source 110 of lidar system 100 may emit pulses of light as the FOVL and FOVR are scanned by scanner 120 across a field of regard (FOR). In particular embodiments, a light-source field of view may refer to an angular cone illuminated by the light source 110 at a particular instant of time. Similarly, a receiver field of view may refer to an angular cone over which the receiver 140 may receive or detect light at a particular instant of time, and any light outside the receiver field of view may not be received or detected. As an example, as the light-source field of view is scanned across a field of regard, a portion of a pulse of light emitted by the light source 110 may be sent downrange from lidar system 100, and the pulse of light may be sent in the direction that the FOVL is pointing at the time the pulse is emitted. The pulse of light may scatter off a target 130, and the receiver 140 may receive and detect a portion of the scattered light that is directed along or contained within the FOVR.

In particular embodiments, scanner 120 may be configured to scan both a light-source field of view and a receiver field of view across a field of regard of the lidar system 100. Multiple pulses of light may be emitted and detected as the scanner 120 scans the FOVL and FOVR across the field of regard of the lidar system 100 while tracing out a scan pattern 200. In particular embodiments, the light-source field of view and the receiver field of view may be scanned synchronously with respect to one another, so that as the FOVL is scanned across a scan pattern 200, the FOVR follows substantially the same path at the same scanning speed. Additionally, the FOVL and FOVR may maintain the same relative position to one another as they are scanned across the field of regard. As an example, the FOVL may be substantially overlapped with or centered inside the FOVR (as illustrated in FIG. 4), and this relative positioning between FOVL and FOVR may be maintained throughout a scan. As another example, the FOVR may lag behind the FOVL by a particular, fixed amount throughout a scan (e.g., the FOVR may be offset from the FOVL in a direction opposite the scan direction).

In particular embodiments, the FOVL may have an angular size or extent OL that is substantially the same as or that corresponds to the divergence of the output beam 125, and the FOVR may have an angular size or extent OR that corresponds to an angle over which the receiver 140 may receive and detect light. In particular embodiments, the receiver field of view may be any suitable size relative to the light-source field of view. As an example, the receiver field of view may be smaller than, substantially the same size as, or larger than the angular extent of the light-source field of view. In particular embodiments, the light-source field of view may have an angular extent of less than or equal to 50 milliradians, and the receiver field of view may have an angular extent of less than or equal to 50 milliradians. The FOVL may have any suitable angular extent Θ_{L}, such as for example, approximately 0.1 mrad, 0.2 mrad, 0.5 mrad, 1 mrad, 1.5 mrad, 2 mrad, 3 mrad, 5 mrad, 10 mrad, 20 mrad, 40 mrad, or 50 mrad. Similarly, the FOVR may have any suitable angular extent Θ_{R}, such as for example, approximately 0.1 mrad, 0.2 mrad, 0.5 mrad, 1 mrad, 1.5 mrad, 2 mrad, 3 mrad, 5 mrad, 10 mrad, 20 mrad, 40 mrad, or 50 mrad. In particular embodiments, the light-source field of view and the receiver field of view may have approximately equal angular extents. As an example, OL and OR may both be approximately equal to 1 mrad, 2 mrad, or 4 mrad. In particular embodiments, the receiver field of view may be larger than the light-source field of view, or the light-source field of view may be larger than the receiver field of view. As an example, OL may be approximately equal to 3 mrad, and OR may be approximately equal to 4 mrad. As another example, OR may be approximately L times larger than OL, where L is any suitable factor, such as for example, 1.1, 1.2, 1.5, 2, 3, 5, or 10.

In particular embodiments, a pixel 210 may represent or may correspond to a light-source field of view or a receiver field of view. As the output beam 125 propagates from the light source 110, the diameter of the output beam 125 (as well as the size of the corresponding pixel 210) may increase according to the beam divergence OL. As an example, if the output beam 125 has a Θ_{L} of 2 mrad, then at a distance of 100 m from the lidar system 100, the output beam 125 may have a size or diameter of approximately 20 cm, and a corresponding pixel 210 may also have a corresponding size or diameter of approximately 20 cm. At a distance of 200 m from the lidar system 100, the output beam 125 and the corresponding pixel 210 may each have a diameter of approximately 40 cm.

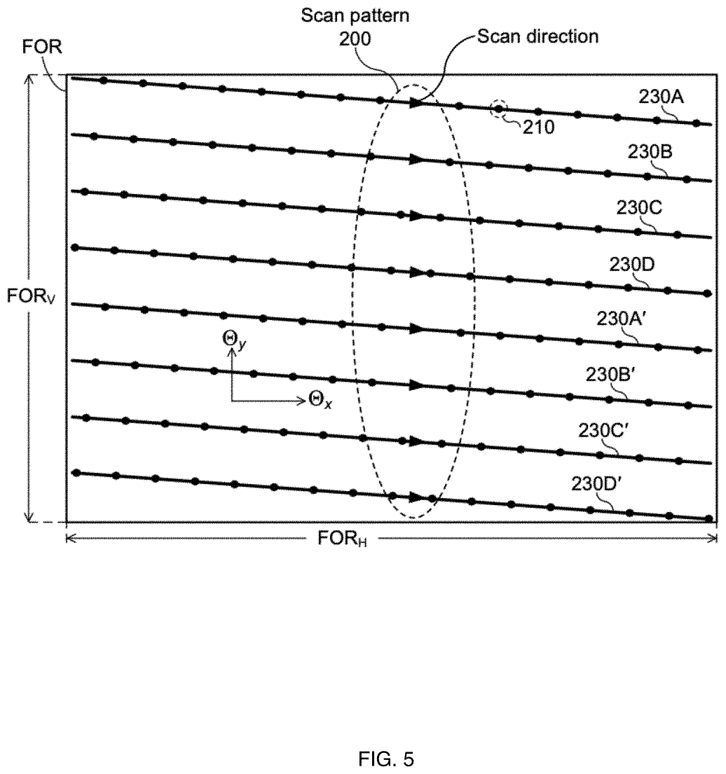

FIG. 5 illustrates an example unidirectional scan pattern 200 that includes multiple pixels 210 and multiple scan lines 230. In particular embodiments, scan pattern 200 may include any suitable number of scan lines 230 (e.g., approximately 1, 2, 5, 10, 20, 50, 100, 500, or 1,000 scan lines), and each scan line 230 of a scan pattern 200 may include any suitable number of pixels 210 (e.g., 1, 2, 5, 10, 20, 50, 100, 200, 500, 1,000, 2,000, or 5,000 pixels). The scan pattern 200 illustrated in FIG. 5 includes eight scan lines 230, and each scan line 230 includes approximately 16 pixels 210. In particular embodiments, a scan pattern 200 where the scan lines 230 are scanned in two directions (e.g., alternately scanning from right to left and then from left to right) may be referred to as a bidirectional scan pattern 200, and a scan pattern 200 where the scan lines 230 are scanned in the same direction may be referred to as a unidirectional scan pattern 200. The scan pattern 200 in FIG. 2 may be referred to as a bidirectional scan pattern, and the scan pattern 200 in FIG. 5 may be referred to as a unidirectional scan pattern 200 where each scan line 230 travels across the FOR in substantially the same direction (e.g., approximately from left to right as viewed from the lidar system 100). In particular embodiments, scan lines 230 of a unidirectional scan pattern 200 may be directed across a FOR in any suitable direction, such as for example, from left to right, from right to left, from top to bottom, from bottom to top, or at any suitable angle (e.g., at a 0°, 5°, 10°, 30°, or 45° angle) with respect to a horizontal or vertical axis. In particular embodiments, each scan line 230 in a unidirectional scan pattern 200 may be a separate line that is not directly connected to a previous or subsequent scan line 230.

In particular embodiments, a unidirectional scan pattern 200 may be produced by a scanner 120 that includes a polygon mirror (e.g., polygon mirror 301 of FIG. 3), where each scan line 230 is associated with a particular reflective surface 320 of the polygon mirror. As an example, reflective surface 320A of polygon mirror 301 in FIG. 3 may produce scan line 230A in FIG. 5. Similarly, as the polygon mirror 301 rotates, reflective surfaces 320B, 320C, and 320D may successively produce scan lines 230B, 230C, and 230D, respectively. Additionally, for a subsequent revolution of the polygon mirror 301, the scan lines 230A′, 230B′, 230C′, and 230D′ may be successively produced by reflections of the output beam 125 from reflective surfaces 320A, 320B, 320C, and 320D, respectively. In particular embodiments, N successive scan lines 230 of a unidirectional scan pattern 200 may correspond to one full revolution of an N-sided polygon mirror. As an example, the four scan lines 230A, 230B, 230C, and 230D in FIG. 5 may correspond to one full revolution of the four-sided polygon mirror 301 in FIG. 3. Additionally, a subsequent revolution of the polygon mirror 301 may produce the next four scan lines 230A′, 230B′, 230C′, and 230D′ in FIG. 5.

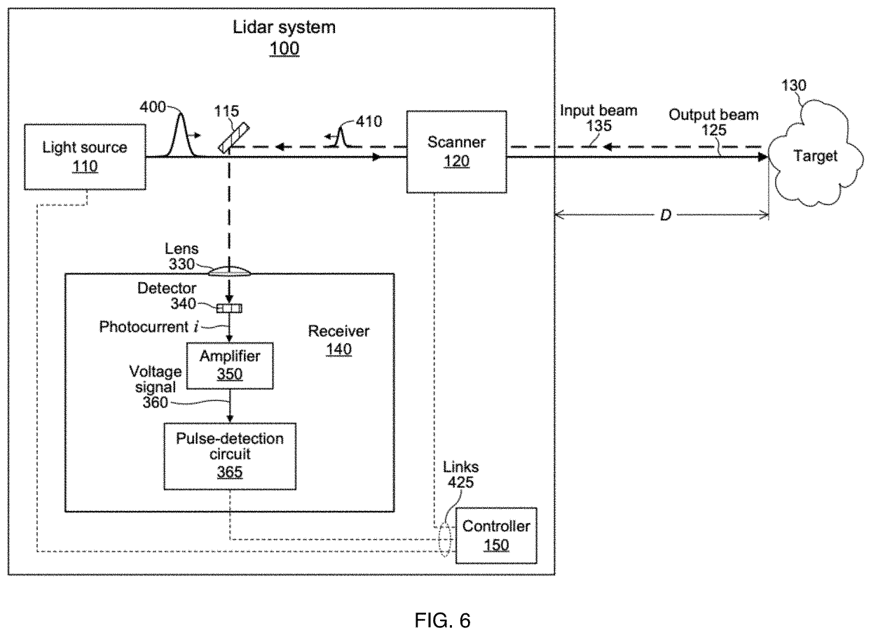

FIG. 6 illustrates an example lidar system 100 that includes a light source 110 that emits pulses of light 400. The lidar system 100 in FIG. 6, which may be referred to as a pulsed lidar system, includes a light source 110, a scanner 120, a receiver 140, and a controller 150. The receiver 140 includes a focusing lens 330, a detector 340, an electronic amplifier 350, and a pulse-detection circuit 365.

In particular embodiments, a pulsed lidar system 100 may include a light source 110 configured to emit pulses of light 400. The emitted pulses of light 400 may be part of an output beam 125 that is scanned by a scanner 120 across a field of regard of the lidar system 100. The light source 110 may include a seed laser that produces seed light and an optical amplifier that amplifies the seed light to produce the emitted pulses of light 400. For example, the optical amplifier may be a pulsed semiconductor optical amplifier (SOA) that amplifies temporal portions of the seed light to produce the emitted pulses of light 400, where each amplified temporal portion of the seed light corresponds to one of the emitted pulses of light 400. The pulses of light 400 emitted by the light source 110 may have one or more of the following optical characteristics: a wavelength between 900 nm and 1700 nm; a pulse energy between 0.01 μJ and 100 μJ; a pulse repetition frequency between 80 kHz and 10 MHz; and a pulse duration between 0.1 ns and 20 ns. For example, the light source 110 may emit pulses of light 400 with a wavelength of approximately 1550 nm, a pulse energy of approximately 0.5 μJ, a pulse repetition frequency of approximately 750 kHz, and a pulse duration of approximately 5 ns. As another example, the light source 110 may emit pulses of light with a wavelength from approximately 1500 nm to approximately 1510 nm.

In particular embodiments, a lidar system 100 may include a scanner 120 configured to scan an output beam 125 across a field of regard of the lidar system 100. The scanner 120 may receive the output beam 125 (which includes emitted pulses of light 400) from the light source 110, and the scanner 120 may include one or more scanning mirrors configured to scan the output beam 125. In addition to scanning the output beam 125, the scanner may also scan a FOV of the detector 340 across the field of regard so that the output beam 125 and the detector FOV are scanned at the same scanning speed or with the same relative position to one another. Alternatively, the lidar system 100 may be configured so that only the output beam 125 is scanned, and the detector has a static FOV that is not scanned. In this case, the input beam 135 (which includes received pulses of light 410) may bypass the scanner 120 and be directed to the receiver 140 without passing through the scanner 120.

In particular embodiments, a lidar system 100 may include a receiver 140 that detects received pulses of light 410. A received pulse of light 410 may include light from one of the emitted pulses of light 400 that is scattered by a target 130 located a distance D from the lidar system 100. The receiver 140 may include one or more detectors 340, and each detector may produce a photocurrent signal i that corresponds to the received pulse of light 410. The lidar system 100 in FIG. 6 includes a receiver 140 with one detector 340 that receives a pulse of light 410 and produces a photocurrent signal i that is amplified by an electronic amplifier 350.

In particular embodiments, a receiver 140 may include a pulse-detection circuit 365 that determines a time-of-arrival for a received pulse of light 410. The time-of-arrival for a received pulse of light 410 may correspond to a time associated with a rising edge, falling edge, peak, or temporal center of the received pulse of light 410. The time-of-arrival may be determined based at least in part on a photocurrent signal i produced by a detector 340 of the receiver 140. For example, a photocurrent signal i may include a pulse of current corresponding to the received pulse of light 410, and the electronic amplifier 350 may produce a voltage signal 360 with a voltage pulse that corresponds to the pulse of current. The pulse-detection circuit 365 may determine the time-of-arrival for the received pulse of light 410 based on a characteristic of the voltage pulse (e.g., based on a time associated with a rising edge, falling edge, peak, or temporal center of the voltage pulse). For example, the pulse-detection circuit 365 may receive an electronic trigger signal (e.g., from the light source 110 or the controller 150) when a pulse of light 400 is emitted, and the pulse-detection circuit 365 may determine the time-of-arrival for the received pulse of light 410 based on a time associated with an edge, peak, or temporal center of the voltage signal 360. The time-of-arrival may be determined based on a difference between a time when the pulse of light 400 is emitted and a time when the received pulse of light 410 is detected.

In particular embodiments, a lidar system 100 may include a processor (e.g., controller 150) that determines the distance to a target 130 based at least in part on a time-of-arrival for a received pulse of light 410. The time-of-arrival for the received pulse of light 410 may correspond to a round-trip time (ΔT) for at least a portion of an emitted pulse of light 400 to travel to the target 130 and back to the lidar system 100, where the portion of the emitted pulse of light 400 that travels back to the target 130 corresponds to the received pulse of light 410. The distance D to the target 130 may be determined from the expression D=c·Δτ/2. For example, if the pulse-detection circuit 365 determines that the time ΔT between emission of optical pulse 400 and receipt of optical pulse 410 is 1 μs, then the controller 150 may determine that the distance to the target 130 is approximately 150 m. In particular embodiments, a round-trip time may be determined by a receiver 140, by a controller 150, or by a receiver 140 and controller 150 together. For example, a receiver 140 may determine a round-trip time by subtracting a time when a pulse of light 400 is emitted from a time when a received pulse of light 410 is detected. As another example, a receiver 140 may determine a time when a pulse of light 400 is emitted and a time when a received pulse of light 410 is detected. These values may be sent to a controller 150, and the controller 150 may determine a round-trip time by subtracting the time when the pulse of light 400 is emitted from the time when the received pulse of light 410 is detected.

In particular embodiments, a controller 150 of a lidar system 100 may be coupled to one or more components of the lidar system 100 via one or more data links 425. Each link 425 in FIG. 6 represents a data link that couples the controller 150 to another component of the lidar system 100 (e.g., light source 110, scanner 120, receiver 140, or pulse-detection circuit 365). Each data link 425 may include one or more electrical links, one or more wireless links, or one or more optical links, and the data links 425 may be used to send data, signals, or commands to or from the controller 150. For example, the controller 150 may send a command via a link 425 to the light source 110 instructing the light source 110 to emit a pulse of light 400. As another example, the pulse-detection circuit 365 may send a signal via a link 425 to the controller with information about a received pulse of light 410 (e.g., a time-of-arrival for the received pulse of light 410). Additionally, the controller 150 may be coupled via a link (not illustrated in FIG. 6) to a processor of an autonomous-vehicle driving system. The autonomous-vehicle processor may receive point-cloud data from the controller 150 and may make driving decisions based on the received point-cloud data.

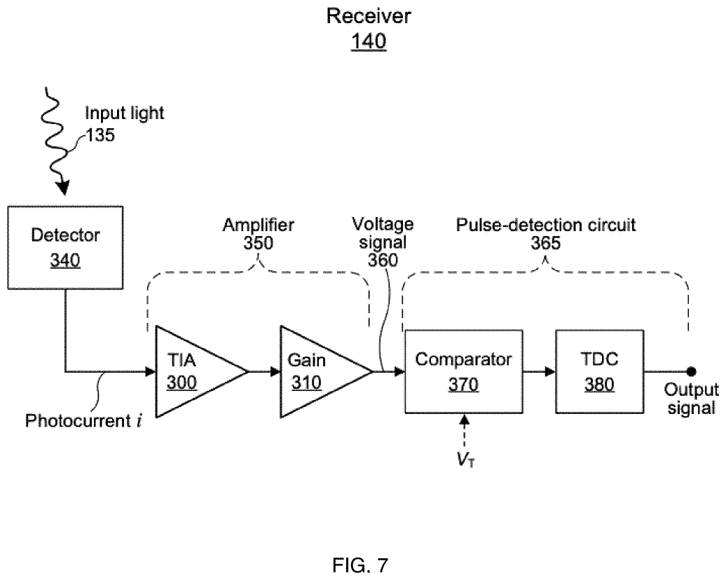

FIG. 7 illustrates an example receiver 140 that includes a detector 340, an electronic amplifier 350, and a pulse-detection circuit 365. In particular embodiments, an electronic amplifier 350 or a pulse-detection circuit 365 may include circuitry that receives an electrical-current signal (e.g., photocurrent i) from a detector 340 (e.g., from an APD) and performs current-to-voltage conversion, signal amplification, sampling, filtering, signal conditioning, analog-to-digital conversion, time-to-digital conversion, pulse detection, threshold detection, rising-edge detection, or falling-edge detection. A pulse-detection circuit 365 may be used to determine (i) whether an optical signal (e.g., a pulse of light 410) has been received by a detector 340 or (ii) a time associated with receipt of an optical signal by a detector 340. An electronic amplifier 350 may include a transimpedance amplifier (TIA) 300 or a voltage-gain circuit 310, and a pulse-detection circuit 365 may include a comparator 370 or a time-to-digital converter (TDC) 380. In particular embodiments, an electronic amplifier 350 and a pulse-detection circuit 365 may be included in a receiver 140 or a controller 150, or parts of an amplifier 350 or pulse-detection circuit 365 may be included in a receiver 140 and other parts may be included in a controller 150. As an example, a TIA 300 and a voltage-gain circuit 310 may be part of a receiver 140, and a comparator 370 and a TDC 380 may be part of a controller 150 that is coupled to the receiver 140. As another example, a TIA 300, gain circuit 310, comparator 370, and TDC 380 may be part of a receiver 140, and an output signal from the TDC 380 may be supplied to a controller 150.

In particular embodiments, an electronic amplifier 350 may include a TIA 300 configured to receive a photocurrent signal i from a detector 340 and produce a voltage signal that corresponds to the received photocurrent. As an example, in response to a received pulse of light 410 (e.g., light from an emitted pulse of light 400 that is scattered by a remote target 130), an APD 340 may produce a pulse of electrical current corresponding to the received pulse of light 410. A TIA 300 may receive the electrical-current pulse from the APD 340 and produce a voltage pulse that corresponds to the received current pulse. In particular embodiments, a TIA 300 may also act as an electronic filter. As an example, a TIA 300 may be configured as a low-pass filter that removes or attenuates high-frequency electrical noise by attenuating signals above a particular frequency (e.g., above 1 MHz, 10 MHz, 20 MHz, 50 MHz, 100 MHz, 200 MHz, 300 MHz, 1 GHz, or any other suitable frequency). In particular embodiments, an electronic amplifier 350 may include a voltage-gain circuit 310 (which may be referred to as a gain circuit or a voltage amplifier) configured to amplify a voltage signal. As an example, a gain circuit 310 may include one or more voltage-amplification stages that amplify a voltage signal received from a TIA 300. For example, the gain circuit 310 may receive a voltage pulse from a TIA 300, and the gain circuit 310 may amplify the voltage pulse by any suitable amount, such as for example, by a gain of approximately 3 dB, 10 dB, 20 dB, 30 dB, 40 dB, or 50 dB. Additionally, the gain circuit 310 may be configured to also act as an electronic filter to remove or attenuate electrical noise. In particular embodiments, an electronic amplifier 350 may not include a separate gain stage 310 (e.g., a TIA 300 may produce a voltage signal 360 that is directly coupled to a comparator 370 without an intervening gain circuit).

In particular embodiments, a pulse-detection circuit 365 may include a comparator 370 configured to receive a voltage signal 360 from a TIA 300 or gain circuit 310 and produce an electrical-edge signal (e.g., a rising edge or a falling edge) when the received voltage signal rises above or falls below a particular threshold voltage VT. As an example, when a received voltage signal 360 rises above VT, a comparator 370 may produce a rising-edge digital-voltage signal (e.g., a signal that steps from approximately 0 V to approximately 2.5 V, 3.3 V, 5 V, or any other suitable digital-high level). Additionally or alternatively, when a received voltage signal 360 falls below VT, a comparator 370 may produce a falling-edge digital-voltage signal (e.g., a signal that steps down from approximately 2.5 V, 3.3 V, 5 V, or any other suitable digital-high level to approximately 0 V). The voltage signal 360 received by the comparator 370 may be received from a TIA 300 or gain circuit 310 and may correspond to a photocurrent signal i produced by an APD 340. As an example, the voltage signal 360 received by the comparator 370 may include a voltage pulse that corresponds to an electrical-current pulse produced by the APD 340 in response to a received pulse of light 410. The voltage signal 360 received by the comparator 370 may be an analog signal, and an electrical-edge signal produced by the comparator 370 may be a digital signal.

In particular embodiments, a pulse-detection circuit 365 may include a time-to-digital converter (TDC) 380 configured to receive an electrical-edge signal from a comparator 370 and determine an interval of time between emission of a pulse of light 400 by a light source 110 and receipt of the electrical-edge signal. The interval of time may correspond to a round-trip time of flight for an emitted pulse of light 400 to travel from the lidar system 100 to a target 130 and back to the lidar system 100. The portion of the emitted pulse of light 400 that is received by the lidar system 100 (e.g., scattered light from target 130) may be referred to as a received pulse of light 410. The output of the TDC 380 may include one or more numerical values, where each numerical value (which may be referred to as a numerical time value, a time value, a digital value, or a digital time value) corresponds to a time interval determined by the TDC 380. In particular embodiments, a TDC 380 may have an internal counter or clock with any suitable period, such as for example, 5 ps, 10 ps, 15 ps, 20 ps, 30 ps, 50 ps, 100 ps, 0.5 ns, 1 ns, 2 ns, 5 ns, or 10 ns. As an example, the TDC 380 may have an internal counter or clock with a 20-ps period, and the TDC 380 may determine that an interval of time between emission and receipt of an optical pulse is equal to 25,000 time periods, which corresponds to a time interval of approximately 0.5 microseconds. The TDC 380 may send a digital output signal that includes the numerical value “25000” to a processor or controller 150 of the lidar system 100. In particular embodiments, a lidar system 100 may include a processor configured to determine a distance from the lidar system 100 to a target 130 based at least in part on an interval of time determined by one or more TDCs 380. As an example, the processor may be an ASIC or FPGA and may be a part of a receiver 140 or controller 150. The processor may receive a numerical value (e.g., “25000”) from the TDC 380, and based on the received value, the processor may determine the distance from the lidar system 100 to a target 130.

In particular embodiments, determining an interval of time between emission and receipt of a pulse of light may be based on determining (1) a time associated with the emission of the pulse of light 400 by light source 110 and (2) a time when scattered light from the pulse of light is detected by receiver 140. As an example, a TDC 380 may count the number of time periods or clock cycles between an electrical edge associated with emission of a pulse of light 400 and an electrical edge associated with detection of scattered light from the pulse. Determining when scattered light from the pulse of light is detected by receiver 140 may be based on determining a time for a rising or falling edge (e.g., a rising or falling edge produced by comparator 370) associated with the detected pulse of light. In particular embodiments, determining a time associated with emission of a pulse of light 400 may be based on an electrical trigger signal. As an example, light source 110 may produce an electrical trigger signal for each pulse of light 400 that is emitted, or an electrical device (e.g., controller 150) may provide a trigger signal to the light source 110 to initiate the emission of each pulse of light 400. A trigger signal associated with emission of a pulse of light may be provided to TDC 380, and a rising edge or falling edge of the trigger signal may correspond to a time when the pulse of light is emitted. In particular embodiments, a time associated with emission of a pulse of light 400 may be determined based on an optical trigger signal. As an example, a time associated with the emission of a pulse of light 400 may be determined based at least in part on detection of a portion of light from the emitted pulse of light prior to the emitted pulse of light exiting the lidar system 100 and propagating to a target 130. The portion of the emitted pulse of light (which may be referred to as an optical trigger pulse) may be detected by a separate detector (e.g., a PIN photodiode or an APD) or by the receiver 140. A portion of light from an emitted pulse of light may be scattered or reflected from a surface (e.g., a surface of a beam splitter or window, or a surface of light source 110, mirror 115, or scanner 120) located within lidar system 100. Some of the scattered or reflected light may be received by a detector 340 of receiver 140, and a pulse-detection circuit 365 coupled to the detector 340 may determine that an optical trigger pulse has been received. The time at which the optical trigger pulse was received may be associated with the emission time of the pulse of light 400.

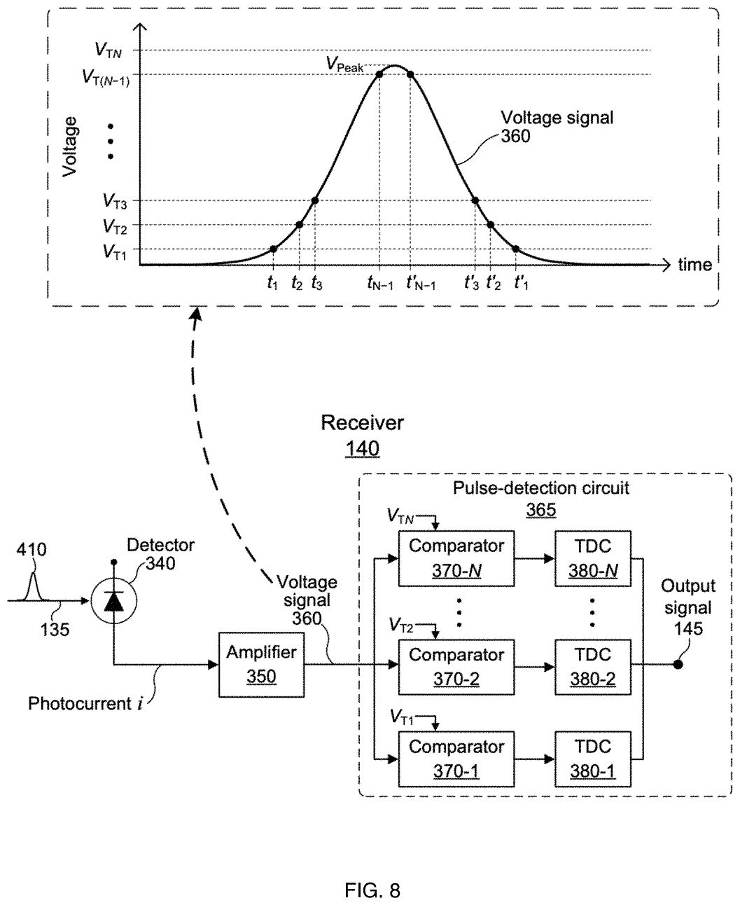

FIG. 8 illustrates an example receiver 140 and an example voltage signal 360 corresponding to a received pulse of light 410. A light source 110 of a lidar system 100 may emit a pulse of light 400, and a receiver 140 may be configured to detect an input optical signal 135 that includes a received pulse of light 410. In particular embodiments, a receiver 140 of a lidar system 100 may include one or more detectors 340, one or more amplifiers 350, or one or more pulse-detection circuits 365. A pulse-detection circuit 365 may include one or more comparators 370 or one or more time-to-digital converters (TDCs) 380.

The receiver 140 illustrated in FIG. 8 includes a detector 340 configured to receive input light 135 and produce a photocurrent i that corresponds to a received pulse of light 410 (which is part of the input light 135). The photocurrent i produced by the detector 340 may be referred to as a photocurrent signal or an electrical-current signal. The detector 340 may include an APD, PN photodiode, or PIN photodiode. For example, the detector 340 may include a silicon APD or PIN photodiode configured to detect light at an 800-1100 nm operating wavelength of a lidar system 100, or the detector 340 may include an InGaAs APD or PIN photodiode configured to detect light at a 1200-1600 nm operating wavelength. In FIG. 8, the detector 340 is coupled to an electronic amplifier 350 configured to receive the photocurrent and produce a voltage signal 360 that corresponds to the received photocurrent. For example, the detector 340 may be an APD that produces a pulse of photocurrent in response to detecting a received pulse of light 410, and the voltage signal 360 may be an analog voltage pulse that corresponds to the pulse of photocurrent. The amplifier 350 may include a transimpedance amplifier 300 configured to receive the photocurrent i and amplify the photocurrent to produce a voltage signal that corresponds to the photocurrent signal. Additionally, the amplifier 350 may include a voltage amplifier 310 that amplifies the voltage signal or an electronic filter (e.g., a low-pass or high-pass filter) that filters the photocurrent or the voltage signal.

In FIG. 8, the voltage signal 360 produced by the amplifier 350 is coupled to a pulse-detection circuit 365. The pulse-detection circuit includes N comparators (comparators 370-1, 370-2, . . . , 370-N), and each comparator is supplied with a particular threshold or reference voltage (V_{T1}, V_{T2}, . . . , V_{TN}). For example, receiver 140 may include N=10 comparators, and the threshold voltages may be set to 10 values between 0 volts and 1 volt (e.g., V_{T1}=0.1 V, V_{T2}=0.2 V, and V_{T10}=1.0 V). A comparator may produce an electrical-edge signal (e.g., a rising or falling electrical edge) when the voltage signal 360 rises above or falls below a particular threshold voltage. For example, comparator 370-2 may produce a rising edge when the voltage signal 360 rises above the threshold voltage V_{T2}. Additionally or alternatively, comparator 370-2 may produce a falling edge when the voltage signal 360 falls below the threshold voltage V_{T2}.

The pulse-detection circuit 365 in FIG. 8 includes N time-to-digital converters (TDCs 380-1, 380-2, . . . , 380-N), and each comparator is coupled to one of the TDCs. Each comparator-TDC pair in FIG. 8 (e.g., comparator 370-1 and TDC 380-1) may be referred to as a threshold detector. A comparator may provide an electrical-edge signal to a corresponding TDC, and the TDC may act as a timer that produces an electrical output signal (e.g., a digital signal, a digital word, or a digital value) that represents a time when the edge signal is received from the comparator. For example, if the voltage signal 360 rises above the threshold voltage V_{T1}, then the comparator 370-1 may produce a rising-edge signal that is supplied to the input of TDC 380-1, and the TDC 380-1 may produce a digital time value corresponding to a time when the edge signal was received by TDC 380-1. The digital time value may be referenced to the time when a pulse of light 400 is emitted, and the digital time value may correspond to or may be used to determine a round-trip time for the pulse of light 400 to travel to a target 130 and back to the lidar system 100. Additionally, if the voltage signal 360 subsequently falls below the threshold voltage V_{T1}, then the comparator 370-1 may produce a falling-edge signal that is supplied to the input of TDC 380-1, and the TDC 380-1 may produce a digital time value corresponding to a time when the edge signal was received by TDC 380-1.

In particular embodiments, a pulse-detection output signal may be an electrical signal that corresponds to a received pulse of light 410. For example, the pulse-detection output signal in FIG. 8 may be a digital signal that corresponds to the analog voltage signal 360, which in turn corresponds to the photocurrent signal i, which in turn corresponds to a received pulse of light 410. If an input light signal 135 includes a received pulse of light 410, the pulse-detection circuit 365 may receive a voltage signal 360 (corresponding to the photocurrent i) and produce a pulse-detection output signal that corresponds to the received pulse of light 410. The pulse-detection output signal may include one or more digital time values from each of the TDCs 380 that received one or more edge signals from a comparator 370, and the digital time values may represent the analog voltage signal 360. The pulse-detection output signal may be sent to a controller 150, and a time-of-arrival for the received pulse of light 410 may be determined based at least in part on the one or more time values produced by the TDCs. For example, the time-of-arrival may be determined from a time associated with the peak (e.g., Vₚₑₐₖ), a rising edge, or a temporal center of the voltage signal 360. The pulse-detection output signal in FIG. 8 may correspond to the electrical output signal 145 in FIG. 1.

In particular embodiments, a pulse-detection output signal may include one or more digital values that correspond to a time interval between (1) a time when a pulse of light 400 is emitted and (2) a time when a received pulse of light 410 is detected by a receiver 140. The pulse-detection output signal in FIG. 8 may include digital values from each of the TDCs that receive an edge signal from a comparator, and each digital value may represent a time interval between the emission of an optical pulse 400 by a light source 110 and the receipt of an edge signal from a comparator. For example, a light source 110 may emit a pulse of light 400 that is scattered by a target 130, and a receiver 140 may receive a portion of the scattered pulse of light as an input pulse of light 410. When the light source emits the pulse of light 400, a count value of the TDCs may be reset to zero counts. Alternatively, the TDCs in receiver 140 may accumulate counts continuously over multiple pulse periods (e.g., for 10, 100, 1,000, 10,000, or 100,000 pulse periods), and when a pulse of light 400 is emitted, the current TDC count may be stored in memory. After the pulse of light 400 is emitted, the TDCs may continue to accumulate counts that correspond to elapsed time (e.g., the TDCs may count in terms of clock cycles or some fraction of clock cycles).

In FIG. 8, when TDC 380-1 receives an edge signal from comparator 370-1, the TDC 380-1 may produce a digital signal that represents the time interval between emission of the pulse of light 400 and receipt of the edge signal. For example, the digital signal may include a digital value that corresponds to the number of clock cycles that elapsed between emission of the pulse of light 400 and receipt of the edge signal. Alternatively, if the TDC 380-1 accumulates counts over multiple pulse periods, then the digital signal may include a digital value that corresponds to the TDC count at the time of receipt of the edge signal. The pulse-detection output signal may include digital values corresponding to one or more times when a pulse of light 400 was emitted and one or more times when a TDC received an edge signal. A pulse-detection output signal from a pulse-detection circuit 365 may correspond to a received pulse of light 410 and may include digital values from each of the TDCs that receive an edge signal from a comparator. The pulse-detection output signal may be sent to a controller 150, and the controller may determine the distance to the target 130 based at least in part on the pulse-detection output signal. Additionally or alternatively, the controller 150 may determine an optical characteristic of a received pulse of light 410 based at least in part on the pulse-detection output signal received from the TDCs of a pulse-detection circuit 365.

In particular embodiments, a receiver 140 of a lidar system 100 may include one or more analog-to-digital converters (ADCs). As an example, instead of including multiple comparators and TDCs, a receiver 140 may include an ADC that receives a voltage signal 360 from amplifier 350 and produces a digital representation of the voltage signal 360. Although this disclosure describes or illustrates example receivers 140 that include one or more comparators 370 and one or more TDCs 380, a receiver 140 may additionally or alternatively include one or more ADCs. As an example, in FIG. 8, instead of the N comparators 370 and N TDCs 380, the receiver 140 may include an ADC configured to receive the voltage signal 360 and produce a digital output signal that includes digitized values that correspond to the voltage signal 360.

The example voltage signal 360 illustrated in FIG. 8 corresponds to a received pulse of light 410. The voltage signal 360 may be an analog signal produced by an electronic amplifier 350 and may correspond to a pulse of light detected by the receiver 140 in FIG. 8. The voltage levels on the y-axis correspond to the threshold voltages V_{T1}, V_{T2}, . . . , V_{TN} of the respective comparators 370-1, 370-2, . . . , 370-N. The time values t₁, t₂, t₃, t_{N-1} correspond to times when the voltage signal 360 exceeds the corresponding threshold voltages, and the time values t₁′, t₂′, t₃′, . . . , t_{N-1}′ correspond to times when the voltage signal 360 falls below the corresponding threshold voltages. For example, at time t₁ when the voltage signal 360 exceeds the threshold voltage V_{T1}, comparator 370-1 may produce an edge signal, and TDC 380-1 may output a digital value corresponding to the time t₁. Additionally, the TDC 380-1 may output a digital value corresponding to the time t₁ when the voltage signal 360 falls below the threshold voltage V_{T1}. Alternatively, the receiver 140 may include an additional TDC (not illustrated in FIG. 8) configured to produce a digital value corresponding to time t₁ when the voltage signal 360 falls below the threshold voltage V_{T1}. The pulse-detection output signal from pulse-detection circuit 365 may include one or more digital values that correspond to one or more of the time values t₁, t₂, t₃, . . . , t_{N-1} and t₁, t₂, t₃, . . . , t_{N-1}′. Additionally, the pulse-detection output signal may also include one or more values corresponding to the threshold voltages associated with the time values. Since the voltage signal 360 in FIG. 8 does not exceed the threshold voltage V_{TN}, the corresponding comparator 370-N may not produce an edge signal. As a result, TDC 380-N may not produce a time value, or TDC 380-N may produce a signal indicating that no edge signal was received.

In particular embodiments, a pulse-detection output signal produced by a pulse-detection circuit 365 of a receiver 140 may correspond to or may be used to determine an optical characteristic of a received pulse of light 410 detected by the receiver 140. An optical characteristic of a received pulse of light 410 may correspond to a time of arrival, a peak optical intensity, a peak optical power, an average optical power, an optical energy, a shape or amplitude, a temporal duration, or a temporal center of the received pulse of light 410. For example, a pulse of light 410 detected by receiver 140 may have one or more of the following optical characteristics: a peak optical power between 1 nanowatt and 10 watts; a pulse energy between 1 attojoule and 10 nanojoules; and a pulse duration between 0.1 ns and 50 ns. In particular embodiments, an optical characteristic of a received pulse of light 410 may be determined from a pulse-detection output signal provided by one or more TDCs 380 of a pulse-detection circuit 365 (e.g., as illustrated in FIG. 8), or an optical characteristic may be determined from a pulse-detection output signal provided by one or more ADCs of a pulse-detection circuit 365.

In particular embodiments, a peak optical power or peak optical intensity of a received pulse of light 410 may be determined from one or more values of a pulse-detection output signal provided by a receiver 140. As an example, a controller 150 may determine the peak optical power of a received pulse of light 410 based on a peak voltage (Vₚₑₐₖ) of the voltage signal 360. The controller 150 may use a formula or lookup table that correlates a peak voltage of the voltage signal 360 with a value for the peak optical power. In the example of FIG. 8, the peak optical power of a pulse of light 410 may be determined from the threshold voltage V_{T(N-1)}, which is approximately equal to the peak voltage Vₚₑₐₖ of the voltage signal 360 (e.g., the threshold voltage V_{T(N-1)} may be associated with a pulse of light 410 having a peak optical power of 10 mW). As another example, a controller 150 may apply a curve-fit or interpolation operation to the values of a pulse-detection output signal to determine the peak voltage of the voltage signal 360, and this peak voltage may be used to determine the corresponding peak optical power of a received pulse of light 410.

In particular embodiments, an energy of a received pulse of light 410 may be determined from one or more values of a pulse-detection output signal. For example, a controller 150 may perform a summation of digital values that correspond to a voltage signal 360 to determine an area under the voltage-signal curve, and the area under the voltage-signal curve may be correlated with a pulse energy of a received pulse of light 410. As an example, the approximate area under the voltage-signal curve in FIG. 8 may be determined by subdividing the curve into M subsections (where M is approximately the number of time values included in the pulse-detection output signal) and adding up the areas of each of the subsections (e.g., using a numerical integration technique such as a Riemann sum, trapezoidal rule, or Simpson's rule). For example, the approximate area A under the voltage-signal curve 360 in FIG. 8 may be determined from a Riemann sum using the expression A=Σₖ₌₁^{M}V_{Tk}×V_{Tk}×Δtₖ, where V_{Tk} is a threshold voltage associated with the time value tₖ, and Δtₖ is a width of the subsection associated with time value tₖ. In the example of FIG. 8, the voltage signal 360 may correspond to a received pulse of light 410 with a pulse energy of 1 picojoule.

In particular embodiments, a duration of a received pulse of light 410 may be determined from a duration or width of a corresponding voltage signal 360. For example, the difference between two time values of a pulse-detection output signal may be used to determine a duration of a received pulse of light 410. In the example of FIG. 8, the duration of the pulse of light 410 corresponding to voltage signal 360 may be determined from the difference (t₃′−t₃), which may correspond to a received pulse of light 410 with a pulse duration of 4 nanoseconds. As another example, a controller 150 may apply a curve-fit or interpolation operation to the values of the pulse-detection output signal, and the duration of the pulse of light 410 may be determined based on the curve-fit or interpolation. One or more of the approaches for determining an optical characteristic of a received pulse of light 410 as described herein may be implemented using a receiver 140 that includes multiple comparators 370 and TDCs 380 (as illustrated in FIG. 8) or using a receiver 140 that includes one or more ADCs.

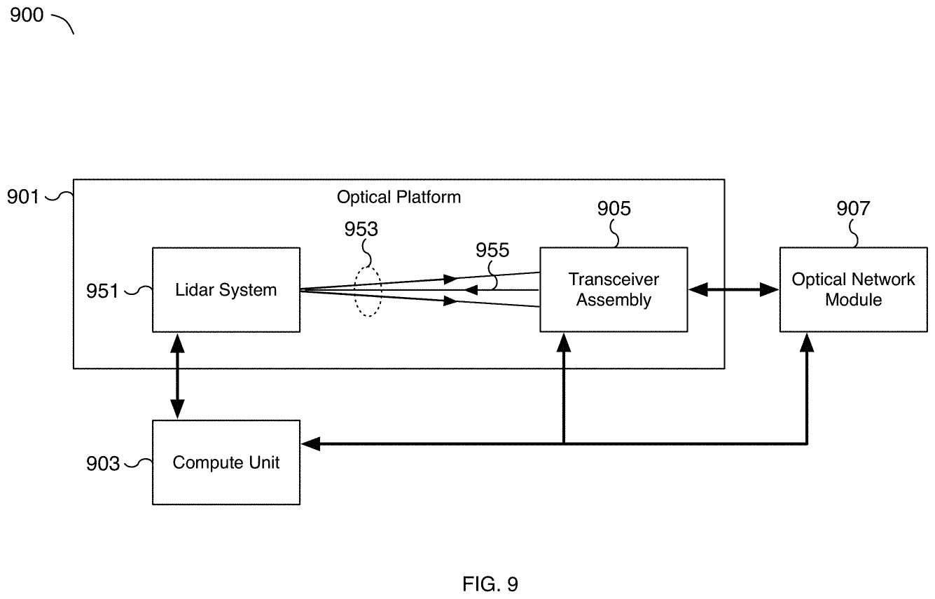

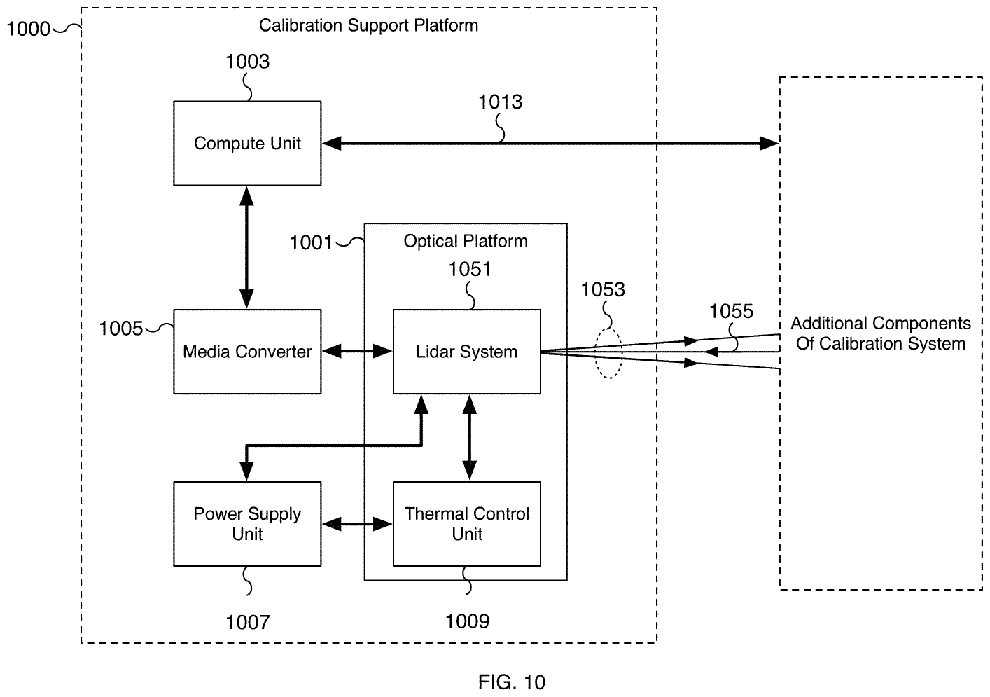

FIG. 9 illustrates an embodiment of a system for performing calibration of a lidar system. In the example shown, calibration system 900 is an embodiment of a system for calibrating a lidar system such as lidar system 951. Calibration system 900 includes optical platform 901, compute unit 903, transceiver assembly 905, and optical network module 907. As shown in FIG. 9, lidar system 951 is attached to optical platform 901. Lidar system 951 emits output beam 953, for example, as an output light pulse, directed at transceiver assembly 905. A portion of output beam 953 enters and is captured by transceiver assembly 905. The captured pulse is modulated and delayed and at least a portion returns to lidar system 951 as input beam 955. In various embodiments, calibration system 900 can be utilized to calibrate and verify the accuracy of lidar system 951. For example, calibration system 900 can be used to perform range calibration using optical network module 907 to simulate a target object at a configured distance. In some embodiments, calibration system 900 and/or portions of calibration system 900 are further utilized with additional geometric calibration components to perform geometric calibration of a lidar system. In some embodiments, lidar system 951 undergoing calibration by calibration system 900 is referred to as a lidar system under test or a device under test (DUT). In some embodiments, lidar system 951 is lidar system 100 of FIGS. 1-4 and 6 and lidar system 951 is the lidar system and its corresponding components as described with respect to FIGS. 5 and 7-8. In some embodiments, output beam 953 corresponds to output beam 125 of FIGS. 1-4 and 6 and input beam 955 corresponds to input beam 135 of FIGS. 1, 3-4, and 6-8. In various embodiments, calibration system 900 includes additional components not shown. For example, additional components of some embodiments of calibration system 900 are described in further detail herein such as with respect to at least FIGS. 10-21. Although only one instance of calibration system 900 is shown in FIG. 9, multiple instances of calibration system 900 and/or components of calibration system 900 can be utilized to simulate different points in the field of regard (FOR) of lidar device 951.

In some embodiments, optical platform 901 is an environment for components of calibration system 900 including at least transceiver assembly 905 and functions as a mounting platform for lidar device 951. In various embodiments, optical platform 901 is a vibration control platform suitable for alignment of the applicable components and for performing optical measurements. For example, optical platform 901 can include an optical table for mounting lidar device 951 and transceiver assembly 905. In various embodiments, optical platform 901 allows for the precise alignment of the various components of calibration system 900 and lidar device 951. For example, optical platform 901 can include gravity and/or alignment pins for precise alignment of lidar device 951 with respect to transceiver assembly 905. Although optical platform 901 can include an optical table, other optical platforms are appropriate as well such as an optical breadboard or bench. In some embodiments, optical platform 901 includes mechanical adjustable mounts to configure the exact positioning and orientation of the various components mounted to the platform. In some embodiments, using optical platform 901, lidar device 951 may be made to translate or rotate in order to probe performance at different locations in the field of regard (FOR) of lidar device 951. In some embodiments, optical platform 901 further provides a thermally managed test environment and electrical power to the associated components, such as lidar device 951. Although not shown in FIG. 9, in some embodiments, optical platform 901 is also used as a platform to support optical network module 907.

In some embodiments, compute unit 903 includes a computer system for operating calibration system 900. For example, compute unit 903 can be used to perform various operating steps related to calibration system 900 including for configuring the effective simulated distance of calibration system 900, for running calibration tests using calibration system 900 on lidar device 951, and/or for determining, capturing, and analyzing the results of applying calibration system 900 to lidar device 951. As shown in the example, compute unit 903 is connected to lidar device 951, transceiver assembly 905, and optical network module 907. In some embodiments, additional or fewer connections are appropriate as well. In some embodiments, compute unit 903 can be used to control the operational temperature(s) when calibrating lidar system 951.

In some embodiments, transceiver assembly 905 of calibration system 900 is an optical input and output device. For example, transceiver assembly 905 can include an interface configured to receive a pulse of light emitted by lidar system 951 and transmit a corresponding pulse of light back to lidar system 951. In various embodiments, transceiver assembly 905 is utilized for capturing at least a portion of output light beams from a lidar device and transmitting a return light beam that functions as an input beam to the lidar device. The returned light beam corresponds to the light reflected or scattered off a simulated target at a simulated distance away from lidar device 951. In various embodiments, the physical space between lidar device 951 and transceiver assembly 905 is physical free space. For example, in some embodiments, output beam 953 and input beam 955 can travel between the physical free space and the physical free space does not need to be enclosed.

In some embodiments, transceiver assembly 905 is a bistatic transceiver subsystem and includes a free-space beam splitter combined with two collimators with independent translation and rotation. Transceiver assembly 905 can couple incident energy from lidar device 951 into optical network module 907 and vice versa. In some embodiments, transceiver assembly 905 has a mechanism to adjust the optical focus on one or both collimators to simulate the range-dependent divergence of rays from a lidar target. In particular embodiments, multiple instances of transceiver assembly 905 exist and are multiplexed to provide for operation at several points in the field of regard (FOR) of lidar device 951.

In some embodiments, transceiver assembly 905 may include a single optical fiber (not shown) that acts as an input and output device. For example, the input face of the optical fiber may (i) receive light from lidar device 951 and couple at least a portion of the incident light into a core of the optical fiber and (ii) emit light as a free-space beam. For example, transceiver assembly 905 may include a lens or collimator that couples light into and out of the optical-fiber core. In some embodiments, transceiver assembly 905 may have an aperture or spatial filter configured to apodize the transmitted energy. In some embodiments, transceiver assembly 905 includes a computer-controlled mechanical adjustment to facilitate alignment with lidar device 951.

In some embodiments, optical network module 907 is used to simulate a target, such as a downrange target, at a configured distance. Optical network module 907 is connected to transceiver assembly 905. In some embodiments, the connection utilizes APC optical fibers to transmit light pulses between transceiver assembly 905 and optical network module 907. In particular embodiments, there are two separate single direction connections. The connections can utilize AR coated PC to APC optical fibers. In some embodiments, optical network module 907 is configured to provide a particular temporal delay of one or more different temporal delays to a received pulse of light. For example, optical network module 907 can include one or more delay lines, such as fiber optic delay lines, to insert a configurable delay corresponding to the delay introduced by the reflection of output beam 953 on the simulated target. In various embodiments, the delay introduced corresponds to the timing delay between output beam 953 and input beam 955. In some embodiments, optical network module 907 additionally attenuates input beam 955 to simulate the impact of reflecting output beam 953 off an object as a configured distance away from lidar system 951. For example, optical network module 907 can include a variable optical attenuator (not shown) to attenuate and/or modulate the signal by configured parameters. In some embodiments, the attenuation further simulates the reflectivity and other properties of the simulated target and its environment.

In various embodiments, optical network module 907 functions as a waveguide and while optical network module 907 can be implemented using a fiber optic waveguide, other implementations, including semiconductor waveguides, are appropriate as well. In some embodiments, optical network module 907 utilizes a double-pass configuration. For example, the captured portion of output beam 953 travels the same path as the reflected portion corresponding to input beam 955. In some embodiments, a double-pass configuration of optical network module 907 includes a retroreflector (not shown) that terminates an optical waveguide and reflects light back towards its source. In some embodiments, optical network module 907 utilizes a single-pass configuration and optical network module 907 is configured to include a loop that allows the captured light to take a single path through at least portions of optical network module 907.

In some embodiments, optical network module 907 contains one or more fiber-optic taps connected to a power meter or detector to monitor the propagating energy. Optical network module 907 may include a variable optical attenuator or other element to attenuate or modulate the transmitted optical power. Optical network module 907 may have one or more fiber-optic delay lines to induce a specific time-of-flight (ToF) in the pulse. Optical network module 907 may have one or more optical switches to modulate the optical path and provide for the use of different subsystems. For example, an optical switch (not shown) may be used to switch light between two fiber-optic delay lines having different optical path lengths. In various embodiments, optical network module 907 may include a pulse-pair generator subsystem (not shown) which can split an incoming pulse into a pulse pair, providing for measurements of pulse-pair resolution. In various embodiments, optical network module 907 can adjust, continuously or discretely, the relative time-of-flight between the pulses in the pulse pair.

In the example shown, lidar system 951 is the test lidar system that is calibrated using calibration system 900. Although lidar system 951 may be a complete lidar system, in various embodiments, lidar system 951 can be replaced with the rangefinder subassembly of a lidar system as opposed to a fully assembled lidar sensor head. In some embodiments, lidar system 951 is replaced with an optical-measurement device, such as an optical frequency-domain reflectometer (OFDR), an optical spectrum analyzer (OSA), or an optical time-domain reflectometer (OTDR). For example, an optical-measurement device can be used to calibrate calibration system 900.

FIG. 10 illustrates an embodiment of a calibration support platform for performing calibration of a lidar system. In the example shown, calibration support platform 1000 is an embodiment of a hardware support platform of a calibration system for calibrating a lidar system such as lidar system 1051. Calibration support platform 1000 includes optical platform 1001, compute unit 1003, media converter 1005, power supply unit 1007, and thermal control unit 1009. As shown in FIG. 10, lidar system 1051 is attached to optical platform 1001. Lidar system 1051 emits output beam 1053, for example, as an output light pulse, directed at one or more transceivers (not shown), such as transceiver assembly 905 of FIG. 9. A portion of output beam 1053 is returned by a transceiver as input beam 1055. In various embodiments, calibration support platform 1000 is used by a calibration system such as calibration system 900 of FIG. 9 to calibrate and verify the accuracy of a lidar system. In some embodiments, calibration support platform 1000 includes additional components not shown. In some embodiments, calibration support platform 1000 expands on the support platform components shown with respect to calibration system 900 of FIG. 9. To simplify the diagram of FIG. 10, other additional components of the calibration system associated with calibration support platform 1000, such as a transceiver assembly and an optical network, are not shown. In some embodiments, optical platform 1001 is optical platform 901 of FIG. 9, compute unit 1003 is compute unit 903 of FIG. 9, and lidar system 1051 is lidar system 951 of FIG. 9.

In some embodiments, optical platform 1001 is optical platform 901 of FIG. 9 and provides a mounting platform for performing calibration and verification tests. For example, optical platform 1001 allows for the alignment and physical manipulation of lidar system 1051. As shown in FIG. 10, optical platform 1001 may also include thermal control unit 1009. In various embodiments, additional functionality of optical platform 1001 is described with respect to optical platform 901 of FIG. 9.

In some embodiments, compute unit 1003 is compute unit 903 of FIG. 9 and functions as a computational unit for configuring the associated calibration system including individual components of the calibration system. As shown in FIG. 10, compute unit 1003 is connected to media converter 1005 and additional components of the calibration system that are not shown, such as a transceiver assembly and an optical network, via connection 1013. In some embodiments, compute unit 1003 is connected to media converter 1005 via a network connection such as an ethernet cable. Compute unit 1003 can be used to control lidar system 1051 via media converter 1005. Although not shown in FIG. 10, in some embodiments, compute unit 1003 is connected to thermal control unit 1009 and used at least in part to control and/or configure the thermal environment of the calibration system. In various embodiments, additional functionality of compute unit 1003 is described with respect to compute unit 903 of FIG. 9.

In some embodiments, media converter 1005 is utilized by compute unit 1003 to communicate with a lidar system such as lidar system 1051. In some embodiments, media converter 1005 is connected to lidar system 1051 via a BASE-T1 cable. Media converter 1005 can function as a translation layer to translate between the different computing protocols of compute unit 1003 and the lidar and/or automotive device protocols utilized by lidar system 1051. In some embodiments, media converter 1005 is included as part of compute unit 1003, for example, as an interface module or communication interface.

In some embodiments, power supply unit 1007 functions as an independent power supply for calibration support platform 1000. Power supply unit 1007 can function as a power source for lidar system 1051 and/or thermal control unit 1009, among other components. In some embodiments, power supply unit 1007 may be used to provide power to other components, such as components of a transceiver assembly and/or an optical network that are not shown. In various embodiments, power supply unit 1007 can provide regulated DC power to lidar system 1051. In some embodiments, power supply unit 1007 is a variable power supply that provides a range of operating voltage outputs including multiple different operating outputs to power different components. Although not shown, in some embodiments, power supply unit 1007 is connected to and can be configured and/or controlled by compute unit 1003

In some embodiments, thermal control unit 1009 is used to control the thermal environment of the calibration system including the thermal environment of lidar system 1051. For example, lidar system 1051 can be evaluated under different thermal conditions via thermal control unit 1009. As shown in FIG. 10, thermal control unit 1009 is connected to at least power supply unit 1007 (electrically) and lidar system 1051 (physically). For example, the connection between thermal control unit 1009 and lidar system 1051 can be a physical connection, for example, to manage and control the thermal operating environment of lidar system 1051. In some embodiments, thermal control unit 1009 is connected to compute unit 1003 (not shown) and the configuration parameters of thermal control unit 1009 can be controlled via compute unit 1003.

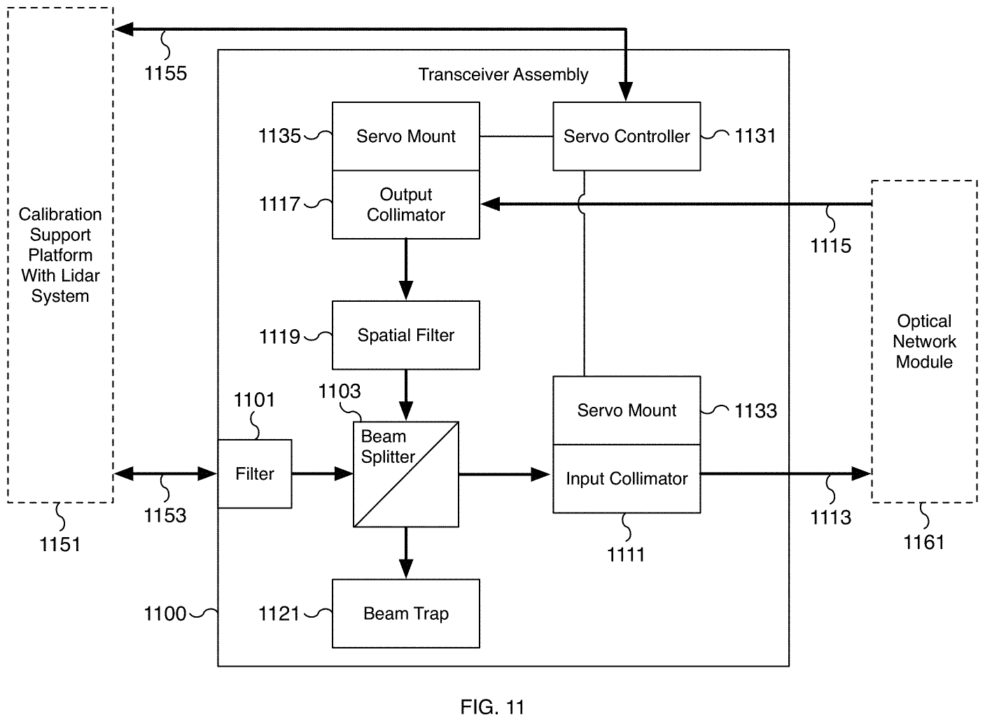

FIG. 11 illustrates an embodiment of a transceiver assembly for performing calibration of a lidar system. In the example shown, transceiver assembly 1100 is an embodiment of a transceiver unit as part of a calibration system for receiving and transmitting light pulses from a lidar system. In the embodiment shown, transceiver assembly 1100 includes filter 1101, beam splitter 1103, input collimator 1111, output collimator 1117, spatial filter 1119, beam trap 1121, servo controller 1131, and servo mounts 1133 and 1135. Transceiver assembly 1100 receives an input light source and transmits a corresponding simulated reflection of the input light source to a lidar system that is part of calibration support platform with lidar system 1151. The received signal and its corresponding simulated reflection travel together along light path 1153 to and from the lidar system being calibrated. Although shown as a single path in FIG. 11, the input and output light pulses associated with light path 1153 may take different paths, for example, depending on the type of lidar system and its configuration. Transceiver assembly 1100 further transmits at least a portion of the received light pulse to optical network module 1161 and receives in return a return signal with an inserted delay and potential modulation and/or attenuation. The two signals are shown as output source 1113 and input source 1115 and may travel over optical connections such as connections that use APC optical fibers. In various embodiments, output source 1113 and input source 1115 each include an optical isolator and only allow light to travel in one direction. As shown in the example, connection 1155 connects calibration support platform with lidar system 1151 to transceiver assembly 1100 and particularly with servo controller 1131.

In some embodiments, transceiver assembly 1100 is transceiver assembly 905 of FIG. 9. In some embodiments, calibration support platform with lidar system 1151 is optical platform 901, compute unit 903, and lidar system 951 of FIG. 9 and/or calibration support platform 1000 and lidar system 1051 of FIG. 10. In some embodiments, optical network module 1161 is optical network module 907 of FIG. 9.

In the example shown, a light pulse received at transceiver assembly 1100 along light path 1153 reaches filter 1101. Filter 1101 acts as an initial filter and allows the filtered light pulse to reach beam splitter 1103. In some embodiments, filter 1101 is a neutral-density filter and reduces and/or modifies the intensity of the received light pulse. In various embodiments, beam splitter 1103 receives light from filter 1101 and spatial filter 1119, splitting the received light sources to be directed towards input collimator 1111, beam trap 1121, and/or back towards the lidar system along light path 1153, as appropriate. For example, in some embodiments, light that has passed through filter 1101 is split and directed towards input collimator 1111 and spatial filter 1119, and light that has passed through spatial filter 1119 is split and directed towards light path 1153 and beam trap 1121. In some embodiments, beam splitter 1103 is a non-polarizing beam splitter. In some embodiments, filter 1101 is only applied to an input light source and not the output light source.

In some embodiments, input collimator 1111 is physically attached to beam splitter 1103. Input collimator 1111 transmits light received from beam splitter 1103 as output source 1113 to optical network module 1161. In various embodiments, optical network module 1161 will modify the signal, such as by inserting a time delay and attenuating the signal to simulate an object at a configured distance. The return signal from optical network module 1161 is received at transceiver assembly 1100 as input source 1115 by output collimator 1117. In various embodiments, output source 1113 and input source 1115 may each be associated with one or more free-space or fiber-optic optical isolators (not shown) in order to induce unidirectional propagation of pulses of light through the network. The isolators may reduce or eliminate optical back reflections which would otherwise induce noise. In some embodiments, the corresponding isolators are physically attached to input collimator 1111 and output collimator 1117, respectively.

In various embodiments, the light source simulating an object at a distance is received at output collimator 1117 and then passes through spatial filter 1119. In various embodiments, spatial filter 1119 removes certain fluctuations from the light beam such as intensity variations introduced while passing through transceiver assembly 1100 and optical network module 1161. Beam splitter 1103 receives a filtered light source from spatial filter 1119, splitting the received light and directing it towards beam trap 1121 and light path 1153. In some embodiments, the light directed towards light path 1153 passes through filter 1101, one or more filters that not shown, or without a filter. In various embodiments, beam trap 1121 absorbs the portions of the light split by beam splitter 1103 and directed to beam trap 1121.

In the example of FIG. 11, input collimator 1111 and output collimator 1117 are associated with servo mounts 1133 and 1135, respectively. Servo mounts 1133 and 1135 are controlled by servo controller 1131. For example, using servo controller 1131 to direct servo mounts 1133 and 1135, both input collimator 1111 and output collimator 1117, respectively, can be physically manipulated including by adjusting their orientations and/or aim. In some embodiments, servo mounts 1133 and 1135 are tip/tilt servo mounts and/or can be adjusted in at least two orthogonal directions. For example, in various embodiments, servo mounts 1133 and 1135 can adjust the angular position of input collimator 1111 and output collimator 1117, respectively, in two orthogonal directions. In some embodiments, servo mounts 1133 and 1135 can adjust their positions along corresponding fewer or more axes.

In various embodiments, input collimator 1111 and output collimator 1117 are physically mounted to servo mounts 1133 and 1135, respectively. As shown in FIG. 11, servo controller 1131 is connected to calibration support platform with lidar system 1151. For example, a compute unit of calibration support platform with lidar system 1151 can be connected to servo controller 1131 via connection 1155 for manipulating input collimator 1111 and output collimator 1117 by configuring and controlling servo mounts 1133 and 1135 using servo controller 1131. In some embodiments, the compute unit used to control servo controller 1131 is compute unit 903 of FIG. 9 and/or compute unit 1003 of FIG. 10.

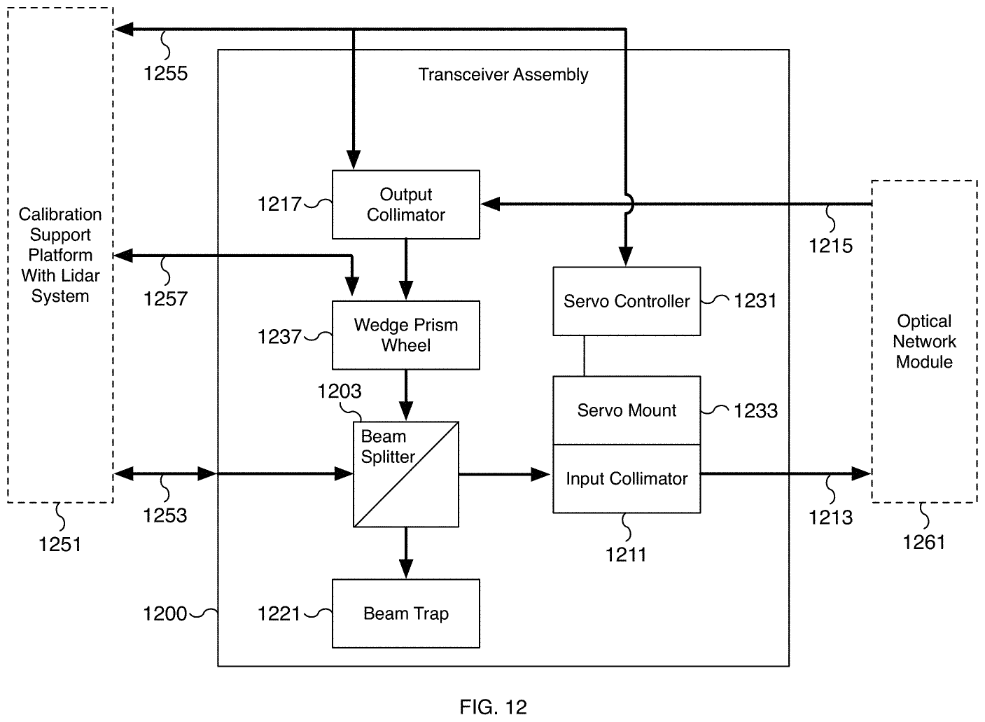

FIG. 12 illustrates an embodiment of a transceiver assembly for performing calibration of a lidar system. In the example shown, transceiver assembly 1200 is an embodiment of a transceiver unit as part of a calibration system for receiving and transmitting light pulses from a lidar system. Unlike transceiver assembly 1100 of FIG. 11, transceiver assembly 1200 utilizes different components including wedge prism wheel 1237 instead of a servo mount, such as servo mount 1135 of FIG. 11, for adjusting the return light beam to the test lidar system. In the embodiment shown, transceiver assembly 1200 includes beam splitter 1203, input collimator 1211, output collimator 1217, beam trap 1221, servo controller 1231, servo mount 1233, and wedge prism wheel 1237. Similar to transceiver assembly 1100 of FIG. 11, transceiver assembly 1200 receives an input light source and transmits a corresponding simulated reflection of the input light source to a lidar system that is part of calibration support platform with lidar system 1251. The received signal and its corresponding simulated reflection travel together along light path 1253 to and from the lidar system being calibrated. Although shown as a single path in FIG. 12, the input and output light pulses associated with light path 1253 may take different paths, for example, depending on the type of lidar system and its configuration. Transceiver assembly 1200 further transmits at least a portion of the received light pulse to optical network module 1261 and receives in return a return signal with an inserted delay and potential modulation and/or attenuation. The two signals are shown as output source 1213 and input source 1215 and may travel over optical connections such as connections that use APC optical fibers. In various embodiments, output source 1213 and input source 1215 each include an optical isolator and only allow light to travel in one direction. In some embodiments, some components of transceiver assembly 1200 are not shown, such as one or more filters, optical isolators, etc.

As shown in the example, connections 1255 and 1257 connect calibration support platform with lidar system 1251 to transceiver assembly 1200. In particular, connection 1255 connects calibration support platform with lidar system 1251 to servo controller 1231 and connection 1257 connects calibration support platform with lidar system 1251 to wedge prism wheel 1237. In various embodiments, connections 1255 and 1257 are used by a compute unit of calibration support platform with lidar system 1151 to communicate with servo controller 1231 and wedge prism wheel 1237, respectively, of transceiver assembly 1200.

In some embodiments, transceiver assembly 1200 is transceiver assembly 905 of FIG. 9. In some embodiments, calibration support platform with lidar system 1251 is optical platform 901, compute unit 903, and lidar system 951 of FIG. 9 and/or calibration support platform 1000 and lidar system 1051 of FIG. 10. In some embodiments, optical network module 1261 is optical network module 907 of FIG. 9.

In the example shown, a light pulse received at transceiver assembly 1200 along light path 1253 reaches beam splitter 1203. In various embodiments, beam splitter 1203 receives light from the test lidar system and wedge prism wheel 1237, splitting the received light sources to be directed towards input collimator 1211, beam trap 1221, and/or back towards the lidar system along light path 1253, as appropriate. For example, in some embodiments, light that is captured from the test lidar system is split and directed towards input collimator 1211 and wedge prism wheel 1237, and light that has passed through wedge prism wheel 1237 is split and directed towards light path 1253 and beam trap 1221. In some embodiments, beam splitter 1203 is a non-polarizing beam splitter.

In some embodiments, input collimator 1211 is physically attached to beam splitter 1203 and functions similar to and as described with respect to input collimator 1111 of FIG. 11. Input collimator 1211 transmits light received from beam splitter 1203 as output source 1213 to optical network module 1261. In various embodiments, optical network module 1261 functions similar to and as described with respect to optical network module 1161 of FIG. 11, and will modify the signal, such as by inserting a time delay and attenuating the signal to simulate an object at a configured distance. The return signal from optical network module 1261 is received at transceiver assembly 1200 as input source 1215 by output collimator 1217. In various embodiments, output source 1213 and input source 1215 may each be associated with one or more free-space or fiber-optic optical isolators (not shown) in order to induce unidirectional propagation of pulses of light through the network. The isolators may reduce or eliminate optical back reflections which would otherwise induce noise. In some embodiments, the corresponding isolators are physically attached to input collimator 1211 and output collimator 1217, respectively.

In various embodiments, the light source simulating an object at a distance is received at output collimator 1217 and then passes through wedge prism wheel 1237. In various embodiments, wedge prism wheel 1237 directs the received light beam from output collimator 1217 to beam splitter 1203. Beam splitter 1203 receives a light source from wedge prism wheel 1237, splitting the received light and directing it towards beam trap 1221 and light path 1253. In various embodiments, beam trap 1221 absorbs the portions of the light split by beam splitter 1203 and directed to beam trap 1221.

In the example of FIG. 12, input collimator 1211 is associated with servo mount 1233 and output collimator 1211 is associated with wedge prism wheel 1237. Servo mount 1233 is controlled by servo controller 1231 and the two components function as described with respect to servo mount 1133 and servo controller 1131 of FIG. 11, respectively. For example, using servo controller 1231 to direct servo mount 1233, input collimator 1211 can be physically manipulated including by adjusting its orientation and/or aim. In some embodiments, servo mount 1233 is a tip/tilt servo mount and/or can be adjusted in at least two orthogonal directions. For example, in various embodiments, servo mount 1233 can adjust the angular position of input collimator 1211 in two orthogonal directions. In some embodiments, servo mount 1233 can adjust its position along corresponding fewer or more axes. In various embodiments, input collimator 1211 is physically mounted to servo mount 1233. As shown in FIG. 12, output collimator 1217 does not require a corresponding servo mount. Instead, wedge prism wheel 1237 performs a similar function and can be used to direct the light from output collimator 1217 to beam splitter 1203.

As shown in FIG. 12, servo controller 1231 and wedge prism wheel 1237 are connected to calibration support platform with lidar system 1251. For example, a compute unit of calibration support platform with lidar system 1251 can be connected to servo controller 1231 via connection 1255 for manipulating input collimator 1211 by configuring and controlling servo mount 1233 using servo controller 1231. Similarly, a compute unit of calibration support platform with lidar system 1251 can be connected to wedge prism wheel 1237 via connection 1257 for manipulating the output of output collimator 1217 using wedge prism wheel 1237. In some embodiments, the compute unit used to control servo controller 1231 and wedge prism wheel 1237 is compute unit 903 of FIG. 9 and/or compute unit 1003 of FIG. 10.

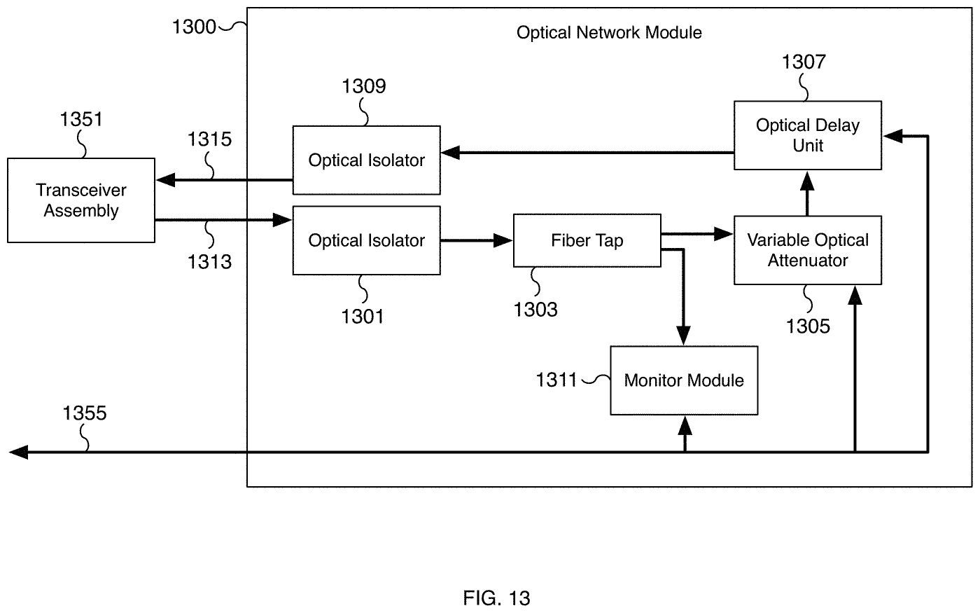

FIG. 13 illustrates an embodiment of an optical network for performing calibration of a lidar system. In the example shown, optical network module 1300 is an embodiment of an optical network used as part of a calibration system for simulating an object at a configured distance from a lidar system. In the embodiment shown, optical network module 1300 includes optical isolators 1301 and 1309, fiber tap 1303, variable optical attenuator 1305, optical delay unit 1307, and monitor module 1311. Optical network module 1300 receives input light source 1313 and transmits output light source 1315 from and to transceiver assembly 1351. Optical network module 1300 manipulates input light source 1313 such that output light source 1315 corresponds to a simulated reflection of a light source received at transceiver assembly 1351 and passed to optical network module 1300 as input light source 1313. Variable optical attenuator 1305, optical delay unit 1307, and monitor module 1311 are controlled by a compute unit (not shown) via connection 1355. In some embodiments, the compute unit is compute unit 903 of FIG. 9 and/or part of a calibration support platform such as calibration support platform 1000 of FIG. 10. Although not shown in FIG. 13, optical network module 1300 is a component of a calibration system such as calibration system 900 of FIG. 9 and is used to calibrate a test lidar system such as one mounted to a calibration support platform (not shown) of the associated calibration system.

In some embodiments, fewer or more components may exist as part of optical network 1300. For example, in some embodiments, fiber tap 1303 and monitor module 1311 are optional. Similarly, optical isolators 1301 and 1309 may be duplicative of different optical isolators found in other parts of the calibration system. In some embodiments, additional elements including optical elements such as filters, lenses, mirrors, etc. may exist but are not included in FIG. 13.

In some embodiments, optical network module 1300 is optical network module 907 of FIG. 9, optical network module 1161 of FIG. 11, and/or optical network module 1261 of FIG. 12. In some embodiments, transceiver assembly 1351 is transceiver assembly 905 of FIG. 9, transceiver assembly 1100 of FIG. 11, and/or transceiver assembly 1200 of FIG. 12. In some embodiments, optical network module 1300 is associated with a test lidar system and other components of the calibration system as shown in FIGS. 9-12.

In the example shown, optical network module 1300 receives input light source 1313 at optical isolator 1301. Optical isolator 1301 ensures that the light propagates in only one direction and is directed to fiber tap 1303. Fiber tap 1303 is a fiber tap that allows the received light to be directed to variable optical attenuator 1305 and monitor module 1311. In various embodiments, variable optical attenuator 1305 can be configured to introduce a variable amount of attenuation to the signal it receives. For example, the signal can be attenuated to simulate the influence on the signal by a target object at a simulated distance and its surrounding environment. In some embodiments, the signal is attenuated to simulate a desired reflectivity and/or other configurable properties of the simulated target and its environment. The output of variable optical attenuator 1305, which can be an attenuated and/or modulated signal, is received at optical delay unit 1307. In various embodiments, optical delay unit 1307 introduces an optical delay to simulate the light travelling to and from an object at a configured distance. In some embodiments, optical delay unit 1307 is implemented using one or more optical switches and fiber delay lines and allows for inserting a configurable delay. The delayed output of optical delay unit 1307 is received at optical isolator 1309. Optical isolator 1309 directs the delayed output to transceiver assembly 1351 as output light source 1315. In various embodiments, output light source 1315 corresponds to a simulated reflection of the light pulse emitted from a test lidar system from an object configured at a simulated distance. In some embodiments, transceiver assembly 1351 processes output light source 1315 before it is transmitted back towards the lidar system where it can be detected by a lidar system.

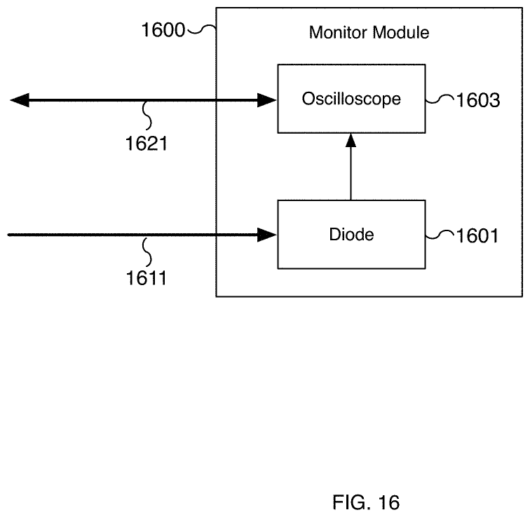

In some embodiments, monitor module 1311 can be used to monitor the light beam that enters optical network module 1300. For example, monitor module 1311 can be used to calibrate, diagnose, and/or test the functionality of optical network module 1300, such as whether it is correctly receiving a signal from transceiver assembly 1351. In some embodiments, monitor module 1311 is described in further detail with respect to FIG. 16.

As shown in the example, variable optical attenuator 1305, optical delay unit 1307, and monitor module 1311 have connection 1355 to an external component. Connection 1355 can function as a control connection for controlling and configuring each of variable optical attenuator 1305, optical delay unit 1307, and monitor module 1311. In some embodiments, a compute unit is used to send configuration parameters to and/or monitor the function of the different components, for example, as part of the process of simulating different distances for a target object. Although shown as a single connection, connection 1355 can be implemented as multiple independent connections to one or more compute units.

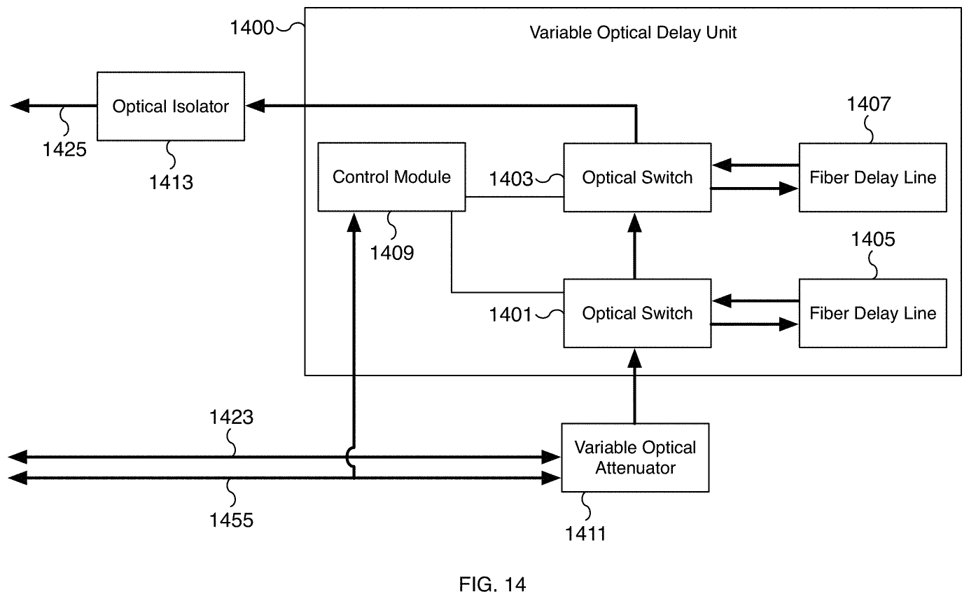

FIG. 14 illustrates an embodiment of a variable optical delay unit for performing calibration of a lidar system. In the example shown, variable optical delay unit 1400 is an embodiment of a configurable optical delay unit used as part of a calibration system for simulating an object at a configured distance from a lidar system. In various embodiments, variable optical delay unit 1400 is a component of an optical network used to introduce a delay to simulate the flight time of a light pulse as it travels to and back from a simulated target. In the embodiment shown, variable optical delay unit 1400 includes optical switches 1401 and 1403, fiber delay lines 1405 and 1407, and control module 1409. Variable optical attenuator 1411 receives source light signal 1423 and transmits an attenuated signal to variable optical delay unit 1400 to introduce a configured delay. Variable optical delay unit 1400 receives the input light source and transmits an output light source to optical isolator 1413. Optical isolator 1413 transmits the received signal as delayed output signal 1425. In the example shown, variable optical attenuator 1411 and control module 1409 are controlled by a compute unit (not shown) via connection 1455. For example, a compute unit can be configured to select a particular temporal delay of one or more different temporal delays to introduce to delayed output signal 1425. In some embodiments, the compute unit is compute unit 903 of FIG. 9 and/or part of a calibration support platform such as calibration support platform 1000 of FIG. 10. In some embodiments, variable optical delay unit 1400 is optical delay unit 1307 of FIG. 13, variable optical attenuator 1411 is variable optical attenuator 1305 of FIG. 13, optical isolator 1413 is optical isolator 1309 of FIG. 13, delayed output signal 1425 is output light source 1315 of FIG. 13, and connection 1455 is connection 1355 of FIG. 13.

In the example shown, variable optical delay unit 1400 includes optical switches that can modify the path the light travels through the unit by adding one or more fiber delay line loops. For example, optical switch 1401 can be configured to introduce fiber delay line 1405 into the path traveled by delayed output signal 1425. Similarly, optical switch 1403 can be configured to introduce fiber delay line 1407 into the path traveled by delayed output signal 1425. In various embodiments, control module 1409 is used to configure the path traveled by configuring optical switch 1401 and optical switch 1403. Control module 1409 can be an electrical relay control card used to independently control optical switch 1401 and optical switch 1403. In some embodiments, optical switch 1401 and optical switch 1403 are each 2×2 optical switches and can be crossover switches. In some embodiments, fiber delay line 1405 and fiber delay line 1407 have different lengths corresponding to different delays. For example, fiber delay line 1405 can utilize a 50 meter fiber and fiber delay line 1407 can utilize a 150 meter fiber, although other lengths can be appropriate as well. Using 50 meter and 150 meter fiber lines for fiber delay line 1405 and fiber delay line 1407, respectively, the associated calibration system is capable of verification at up to approximately 200 meters, with shorter configurable distances as well. In some embodiments, fiber delay line 1405 has a length and corresponding optical delay that is at least twice as long as an optical delay of fiber delay line 1407, or vice versa. In various embodiments, optical switch 1401 is connected to fiber delay line 1405 using a pair of APC optical fibers. Similarly, optical switch 1403 can be connected to fiber delay line 1407 using a pair of APC optical fibers. In some embodiments, variable optical attenuator 1411, optical switch 1401, optical switch 1403, and optical isolator 1413 can be connected using APC optical fibers.

Although shown with two optical switches in FIG. 14, optical switches 1401 and 1403, and two fiber delay lines, fiber delay line 1405 and 1407, a variable optical delay unit with additional switches and delay lines is appropriate as well. For example, in some embodiments, the addition of additional optical switches and delay lines can increase the granularity of the introduced delay.

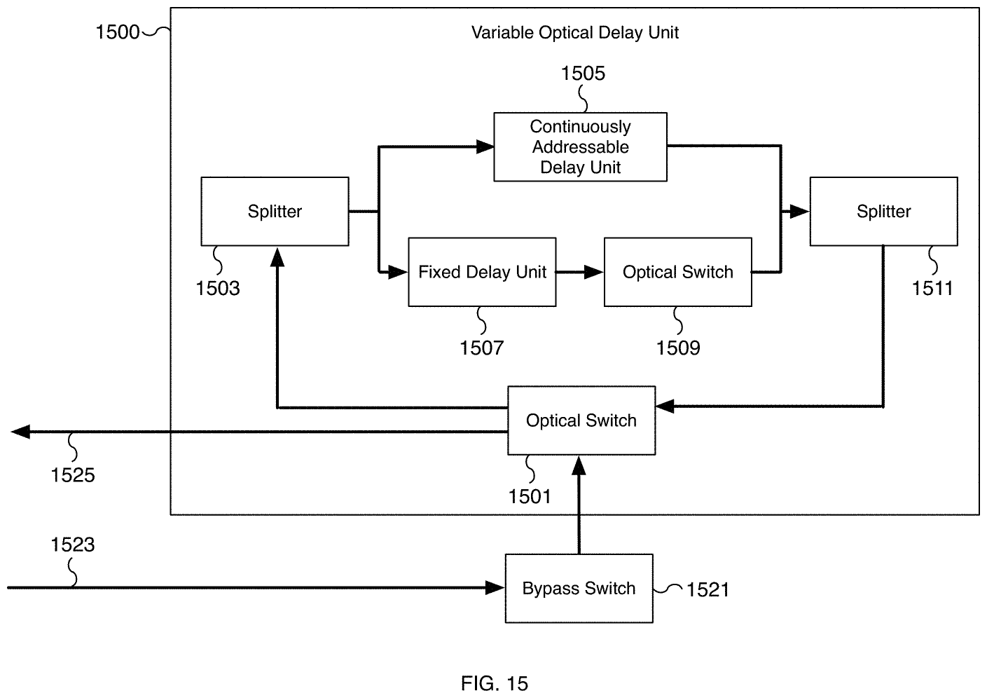

FIG. 15 illustrates an embodiment of a variable optical delay unit for performing calibration of a lidar system. In the example shown, variable optical delay unit 1500 is an embodiment of a configurable optical delay unit used as part of a calibration system for simulating an object at a configured distance from a lidar system. In various embodiments, variable optical delay unit 1500 is a component of an optical network used to introduce a delay to simulate the flight time of a light pulse as it travels to and back from a simulated target. In the embodiment shown, variable optical delay unit 1500 includes optical switches 1501 and 1509, splitters 1503 and 1511, fixed delay unit 1507, and continuously addressable delay unit 1505. Bypass switch 1521 receives source light signal 1523 and can transmit the signal to variable optical delay unit 1500. Variable optical delay unit 1500 receives an input light source from bypass switch 1521 and transmits delayed output signal 1525 using its internal components to introduce a variable and configurable delay. In some embodiments, some components of variable optical delay unit 1500 are not shown, such as one or more filters, optical isolators, connections to compute units, etc. In some embodiments, the surrounding components for interfacing with variable optical delay unit 1500 are not shown and variable optical delay unit 1500 can be included in a configuration similar to variable optical delay unit 1400 of FIG. 14. In some embodiments, variable optical delay unit 1500 is optical delay unit 1307 of FIG. 13 and delayed output signal 1425 corresponds to output light source 1315 of FIG. 13.

In some embodiments, optical switch 1501 is a 2×2 optical switch and optical switch 1509 is a 1×1 optical switch. Splitters 1503 and/or 1511 can be 50/50 splitters. In some embodiments, continuously addressable delay unit 1505 is a configurable variable delay unit. In various embodiments, for a particular pass, the path of delayed output signal 1525 can include travelling through continuously addressable delay unit 1505 or via the combination of fixed delay unit 1507 and optical switch 1509. In various embodiments, one or more of the components of variable optical delay unit 1500 are connected using APC optical fibers.

FIG. 16 illustrates an embodiment of a monitoring module for performing calibration of a lidar system. In the example shown, monitoring module 1600 is an embodiment of a monitoring unit used for a system to calibrate a lidar system. In various embodiments, monitoring module 1600 is used as part of an optical network for introducing optical delays to simulate an object at a simulated distance. In the example shown, monitoring module 1600 receives input signal 1611. Input signal can be sourced from a fiber tap such as fiber tap 1303 of FIG. 13. Additionally, monitoring module 1600 has a control connection 1621 that transfers information to and/or from oscilloscope 1603. In various embodiments, oscilloscope 1603 receives a signal from diode 1601, such as an analog signal, that can be measured by oscilloscope 1603. Monitoring module 1600 can be configured and data can be logged by interfacing with oscilloscope 1603 via control connection 1621. In some embodiments, control connection 1621 is connected to a compute unit such as compute unit 903 of FIG. 9. In some embodiments, control connection 1621 is connection 1355 of FIG. 13 and monitoring module 1600 is monitor module 1311 of FIG. 13. Although the monitoring module 1600 includes the disclosed components, other variations of monitoring components can be utilized as well. In various embodiments, monitoring module 1600 can be used to evaluate and diagnose a signal received by a component of the calibration system such as a signal received at an optical network module such as optical network module 907 of FIG. 9, optical network module 1161 of FIG. 11, optical network module 1261 of FIG. 12, and/or optical network module 1300 of FIG. 13.

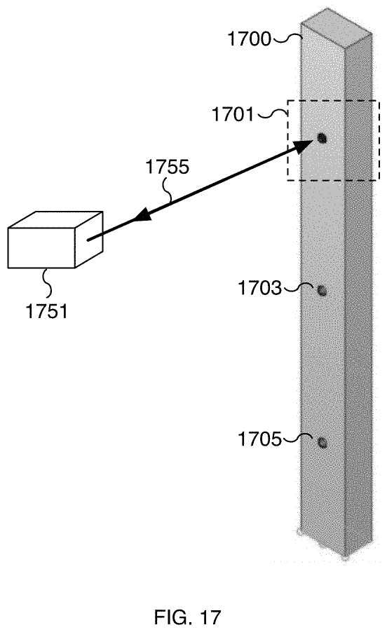

FIG. 17 illustrates an embodiment of a system for performing calibration of a lidar system. In the example shown, fixture 1700 is a geometric-calibration target and includes three target elements 1701, 1703, and 1705. Lidar system 1751 is positioned to emit beams at fixture 1700 and its target elements 1701, 1703, and 1705. In the example of FIG. 17, lidar system 1751 emits and detects the reflection and/or scatter of the emitted beam. Output and return light pulse 1755 is an example of an emitted light pulse and its corresponding return light pulse that is targeted at fixture 1700 and particularly at target element 1701. In some embodiments, the return light pulse is a free-space optical beam version of the light pulse emitted from lidar system 1751, received at target element 1701, and propagated through an optical network or guide to insert a delay. In various embodiments, lidar system 1751 is configured to scan the scene that includes fixture 1700 at least in part to calibrate lidar system 1751 for geometric accuracy. In some embodiments, additional components of the calibration system are not shown and may be described in further detail herein such as with respect to FIGS. 9-16 and 18-21. Although not shown, in various embodiments, lidar system 1751 is mounted on a calibration platform. In some embodiments, the calibration platform is an optical platform such as optical platform 901 of FIG. 9 and/or calibration and support platform 1000 of FIG. 10.

In some embodiments, fixture 1700 is a mounting fixture for target elements such as target elements 1701, 1703, and 1705. Each of target elements 1701, 1703, and 1705 simulate an object at a distance from lidar system 1751 that is further than fixture 1700 and its corresponding target elements are from lidar system 1751. For example, fixture 1700 may be much closer than 2 meters from lidar system 1751 and/or within the minimum operating distance and/or does not meet a minimal-distance limitation of lidar system 1751. However, when scanned by lidar system 1751, target elements 1701, 1703, and 1705 can register as much farther, such as 50 m, 100 m, 150 m, 200 m, 250 m or more. In some embodiments, target elements 1701, 1703, and 1705 each utilize an input interface to receive an input light pulse and an optical network or guide that introduces a delay to the received input light pulse that enters the associated target element. The introduced delay simulates an object at a much farther distance than the front or input interface of the target element. In some embodiments, the light pulse propagates through the optical network and a portion of the pulse is emitted back towards lidar system 1751. The emitted portion of the pulse can be a free-space optical beam. In some embodiments, the optical network is a waveguide and includes an optical fiber, such as a multi-mode optical fiber, with a back face and at least a portion of the entering pulse reflects off the back face and returns towards lidar system 1751. In various embodiments, target elements such as target elements 1701, 1703, and 1705 allow for a very compact geometric calibration system and allow fixture 1700 to be placed at a distance closer to lidar system 1751 than the minimum sensor distance typically allows. In various embodiments, the simulated distances of target elements 1701, 1703, and 1705 are configurable, for example, via a compute unit (not shown).

In some embodiments, the geometric and/or distance (range) values associated with target elements 1701, 1703, and 1705 are measured using an optical-measurement device. For example, an optical-measurement device can be placed at the location of lidar system 1751 and used to establish a ground truth for the geometric and distance properties of target elements 1701, 1703, and 1705 as configured to simulate objects that are farther away. The optical-measurement device may include an optical frequency-domain reflectometer (OFDR), an optical spectrum analyzer (OSA), or an optical time-domain reflectometer (OTDR).

In some embodiments, multiple fixtures such as fixture 1700 are placed in the surrounding environment of lidar system 1751. For example, three or more fixtures can be placed around lidar system 1751 and each fixture can include additional (or fewer) target elements. In some embodiments, each of target elements 1701, 1703, and 1705 can be further configured for a different distance. The ground truth values of the simulated distances along with their geometric positions are determined and used to evaluate the accuracy of lidar system 1751. In some embodiments, the measured values for each target element include azimuth, elevation, range (distance) and/or reflectance values, among others. In some embodiments, the calibration values associated with the measurements are geometric calibration results and include an azimuth correction value, an elevation correction value, and/or a distance (range) correction value. In some embodiments, the calibration results are transformation parameters that correspond to a geometric calibration for lidar system 1751.

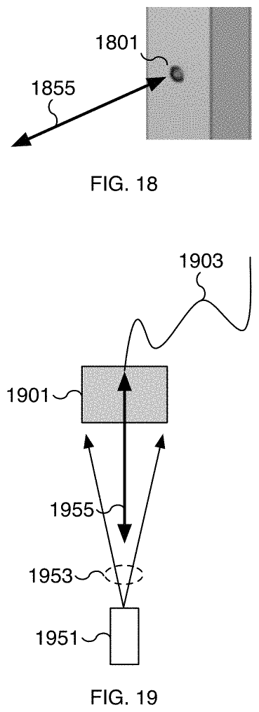

FIG. 18 illustrates an embodiment of a target element for performing calibration of a lidar system. In the example shown, target element 1801 is an example of a target element mounted on a geometric-calibration target, such as fixture 1700 of FIG. 17. In some embodiments, target element 1801 is target element 1701, 1703, and/or 1705 of FIG. 17. In the example of FIG. 18, output and return light pulse 1855 is an emitted pulse that is directed at target element 1801 and includes a corresponding return pulse that is transmitted back towards its source. In various embodiments, the source of output and return light pulse 1855 is a test lidar system. In some embodiments, output and return light pulse 1855 is output and return light pulse 1755 of FIG. 17. In various embodiments, the output light pulse and the return light pulse of output and return light pulse 1855 enter and exit target element 1801 from the same location. In some embodiments, the output and the return light pulse of output and return light pulse 1855 enter and exit target element 1801 from different locations (not shown). For example, the entrance and exit may be offset.

FIG. 19 illustrates an embodiment of a cross section of a fixture with a target element for performing calibration of a lidar system. The example of FIG. 19 is shown from a top-down perspective and illustrates a cross section of fixture with a target element 1901. In the example of FIG. 19, lidar system 1951 emits output beam 1953. A portion of output beam 1953 enters the target element of fixture with a target element 1901 and propagates through waveguide 1903 before a portion is reflected back towards lidar system 1951. The captured and reflected light pulses are shown as output and return light pulse 1955. As shown in the example, only a portion of output beam 1953 must enter waveguide 1903 for a reflection to be transmitted back to lidar system 1951. In some embodiments, fixture with a target element 1901 is fixture 1700 and target element 1701 of FIG. 17 and/or target element 1801 of FIG. 18 and its associated fixture. In some embodiments, lidar system 1951 is lidar system 1751 of FIG. 17 and output and return light pulse 1955 is output and return light pulse 1755 of FIG. 17 and/or output and return light pulse 1855 of FIG. 18.

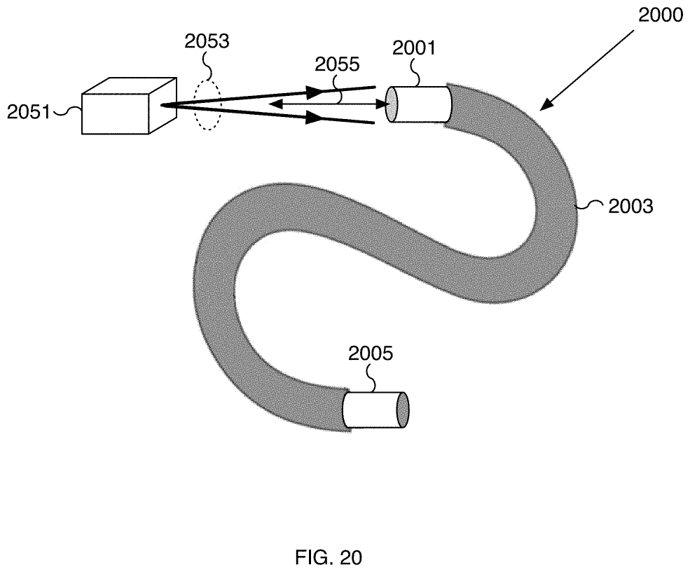

FIG. 20 illustrates an embodiment of a target element for performing calibration of a lidar system. In the example shown, lidar system 2051 emits output beam 2053. Target element 2000 is in the path of output beam 2053. In various embodiments, target element 2000 is mounted to a fixture (not shown), such as fixture 1700 of FIG. 17. Target element 2000 includes near ferrule 2001, waveguide 2003, and far ferrule 2005. A portion of output beam 2053 enters target element 2000 at near ferrule 2001, propagates through waveguide 2003, and reflects off a back face associated with far ferrule 2005. The light pulse that enters and the corresponding light pulse that exits target element 2000 are shown as output and return light pulse 2055. In some embodiments, lidar system 2051 is lidar system 1751 of FIG. 17 and/or lidar system 1951 of FIG. 19, output beam 2053 is output beam 1953 of FIG. 19, output and return light pulse 2055 is output and return light pulse 1755 of FIG. 17, output and return light pulse 1855 of FIG. 18, and/or output and return light pulse 1955 of FIG. 19, and target element 2000 is target element 1701, 1703, and/or 1705 of FIG. 17, target element 1801 of FIG. 18, and/or the target element of FIG. 19.

In some embodiments, near ferrule 2001 is associated with a front (or near) face of target element 2000. The front face and/or near ferrule 2001 can be coated with an anti-reflective coating to minimize the partial reflection off target element 2000 and to maximize the partial transmission to waveguide 2003. In some embodiments, when output beam 2053 strikes target element 2000, the partial transmission of output beam 2053 to waveguide 2003 is maximized and the partial reflection is minimized by an anti-reflective coating. In some embodiments, the front face is angled to minimize undesirable reflections. For example, the front face associated with near ferrule 2001 can be angled relative to the principal axis to minimize undesirable reflections.

In some embodiments, waveguide 2003 is a fiber optic such as a multi-mode optical fiber. In some embodiments, waveguide 2003 is 0.5 to 138 meters in length, although other lengths may be appropriate as well. In various embodiments, the length of waveguide 2003 determines at least in part the delay introduced to the return pulse received at lidar system 2051. In some embodiments, waveguide 2003 is an optical network or guide. For example, in some embodiments, waveguide 2003 includes an optical loop and functions as optical network module 1300 of FIG. 13.

In some embodiments, far ferrule 2005 is associated with a back (or far or end) face of target element 2000. In some embodiments, far ferrule 2005 and/or the back face is further associated with a beam dump or light trap for capturing the portion of output beam 2053 that reaches far ferrule 2005 and is not reflected back. For example, with respect to the portion of output beam 2053 that reaches the back face of far ferrule 2005, a partial reflection is directed back through waveguide 2003 towards lidar system 2051 and a partial transmission is captured by a beam dump and/or light trap (not shown). In some embodiments, a beam dump and/or light trap capture or extinguish at least a portion of the light that is transmitted through the waveguide 2003. In various embodiments, the portion of output beam 2053 that propagates through waveguide 2003 is the input light source to target element 2000 and corresponds to the output pulse of output and return light pulse 2055. The reflected portion that reflects off the back face of target element 2000 corresponds to the return light pulse of output and return light pulse 2055. In various embodiments, the back face associated with waveguide 2003 and far ferrule 2005 is uncoated to generate the desired return pulse.

In some embodiments, at the far end of waveguide 2003 near far ferrule 2005, reflections are generated and returned along waveguide 2003 toward the lidar system 2051. In some embodiments, these reflections are generated by Fresnel reflection (e.g., from the end face of the optical fiber of waveguide 2003). From the perspective of lidar system 2051, the return pulses appear to arrive from a much further distance than the near face of target element 2000 due to the time-of-flight (ToF) of the pulse through waveguide 2003. This ToF delay of the pulses of light may allow the geometric-calibration system to overcome a minimum-distance limitation for geometric calibration. For example, lidar system 2051 may be unable to detect a pulse of light scattered from a target located less than 5 meters away but will detect a distant target simulated by target element 2000 even if target element 2000 is less than 5 meters away.

In some embodiments, one or more devices or components not shown may be coupled to target element 2000. For example, a device can be coupled along the length of waveguide 2003, close to near ferrule 2001, or close to far ferrule 2005. In some embodiments, the device is an optical attenuator, such as variable optical attenuator 1305 of FIG. 13. An attenuator or a variable optical attenuator can be used to tune or set the amount of optical power that is returned back to lidar system 2051. In some embodiments, the device is a fiber-coupled retroreflector (not shown) connected near the far end of waveguide 2003. In some embodiments, target element 2000 may include one or more lenses. For example, a lens may be positioned at the input of target element 2000 and/or waveguide 2003 to couple light into the waveguide 2003.

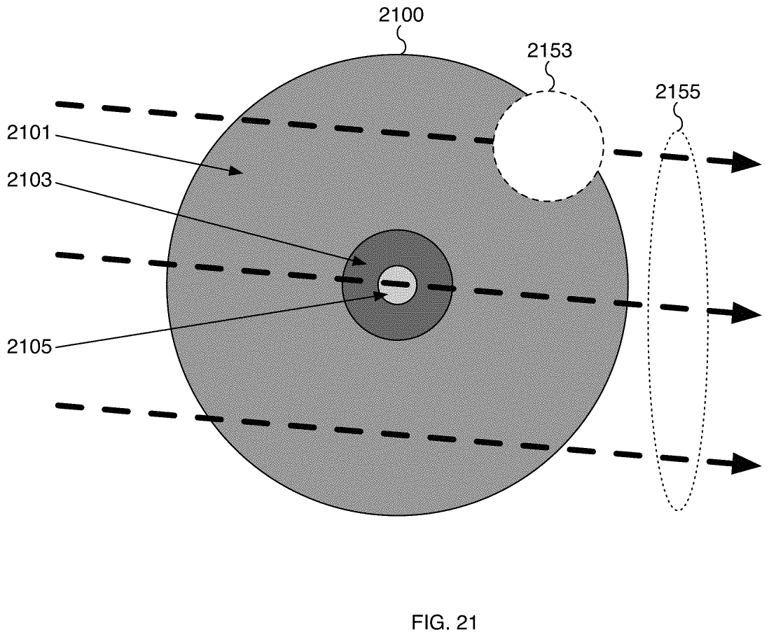

FIG. 21 illustrates an embodiment of a target element for performing calibration of a lidar system. In FIG. 21, target element 2100 is shown head on looking at the front face of target element 2100. Target element 2100 is shown with ferrule 2101, cladding 2103, and fiber core 2105. In various embodiments, emits output beam 2153 is emitted from a lidar system being calibrated according to scan pattern 2155. In some embodiments, the lidar system is lidar system 1751 of FIG. 17, lidar system 1951 of FIG. 19, and/or lidar system 2051 of FIG. 20, output beam 2153 is output beam 1953 of FIG. 19 and/or output beam 2053 of FIG. 20, and scan pattern 2155 is scan pattern 200 of FIGS. 2 and/or 5, and target element 2100 is target element 1701, 1703, and/or 1705 of FIG. 17, target element 1801 of FIG. 18, the target element of FIG. 19, and/or target element 2000 of FIG. 20. In some embodiments, ferrule 2101 is 2.5 mm, cladding 2103 is up to 1550 μm, fiber core 2105 is between 9 μm to 1500 μm, and output beam 2153 has a beam diameter of approximately 1.1 mm.

In some embodiments, a lidar system is instructed to scan a scene as part of a calibration process. The lidar system will scan output beam 2153 along scan pattern 2155. In some embodiments, scan pattern 2155 is an optical scan pattern or scan path and is described further with respect to FIGS. 2 and 5. When output beam 2153 passes over fiber core 2105, at least a portion of output beam 2153 is captured and propagates through the waveguide of target element 2100 before being reflected and directed back towards the lidar system. In some embodiments, fiber core 2105 functions as an interface for target element 2100.

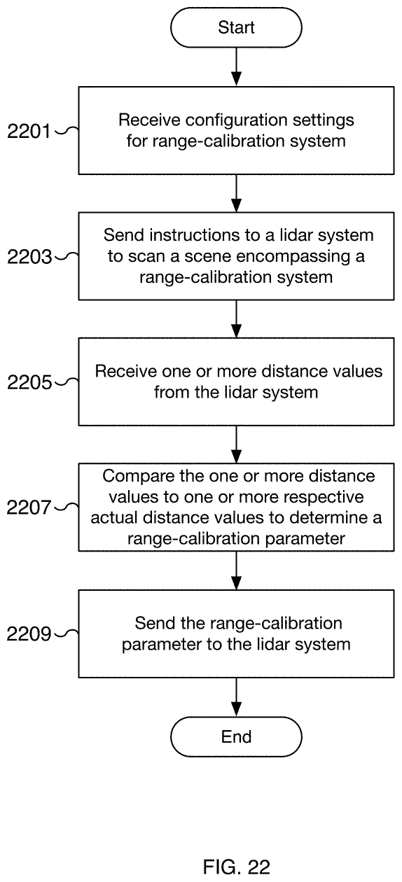

FIG. 22 is a flow chart illustrating an embodiment of a process for performing a range calibration of a lidar system. Using the process of FIG. 22, a lidar system can be calibrated to determine the accuracy of its distance or range readings. In various embodiments, reference or ground truth measurements are first determined and then compared to the lidar system readings to determine and potentially calibrate the lidar system using a distance correction parameter. In some embodiments, the lidar system can also be calibrated for other measurement values such as reflectivity and geometric position. In some embodiments, the calibration process of FIG. 22 is performed using a calibration system such as calibration system 900 of FIG. 9 and/or the calibration system and components described with respect to FIGS. 10-21. In some embodiments, the lidar system being calibrated is lidar system 100 of FIGS. 1-4 and 6, lidar system 951 of FIG. 9, and/or the lidar system associated with FIGS. 10-21.

At 2201, configuration settings for the range-calibration system are received. The received configuration can include alignment settings, operational temperature settings, a distance setting, and/or a reflectivity setting, among others. For example, the range-calibration system can receive parameters to simulate an object at a particular distance with a specified reflectivity and parameters to run a distance and reflectivity calibration for a particular temperature or temperature range.

At 2203, instructions are sent to a lidar system to scan a scene encompassing a range-calibration system. For example, a lidar system is mounted to a calibration system via an optical platform. The lidar system is sent instructions to scan a scene that includes the range-calibration system including the transceiver assembly or target element of a calibration system.

At 2205, one or more distance values are received from the lidar system. For example, the lidar system responds to the instructions sent at 2203 and determines one or more distance values. The distance values are determined using a return light pulse delayed by the calibration system. In some embodiments, the delay is inserted by an optical network and the distance values received from the lidar system are based on the configured optical network of the calibration system and not the actual distance between the lidar system to the immediate target of the calibration system. In some embodiments, the return light pulse is a free-space pulse of light.

At 2207, the received one or more distance values are compared to one or more respective actual distance values to determine a range-calibration parameter. For example, one or more actual distance values are first determined and used as reference measurements. In some embodiments, the reference measurements are the actual distances or ground truth values. In various embodiments, the actual distance values can be determined using an optical-measurement device, such as an optical frequency-domain reflectometer (OFDR), an optical spectrum analyzer (OSA), and/or an optical time-domain reflectometer (OTDR). For example, the optical-measurement device is used in place of the test lidar system in the calibration system to measure the simulated distance associated with the configured temporal delay. Using the reference measurements, the received distance values as determined and measured by the lidar unit are compared to the reference distances. A range-calibration parameter, such as a range offset or distance correction parameter, is determined that when applied to the lidar system, allows the lidar system to account for discrepancies between the lidar system readings and the reference measurements.

At 2209, the range-calibration parameter is sent to the lidar system. For example, a range-calibration parameter is provided to the lidar system and used to adjust the accuracy of the lidar distance readings. In some embodiments, the range-calibration parameter is a range offset or a distance correction parameter that is used to modify an initial distance reading by the lidar system. In some embodiments, the range-calibration parameter is used to adjust a detection threshold for range measurements. In some embodiments, the range-calibration parameter is a transformation parameter.

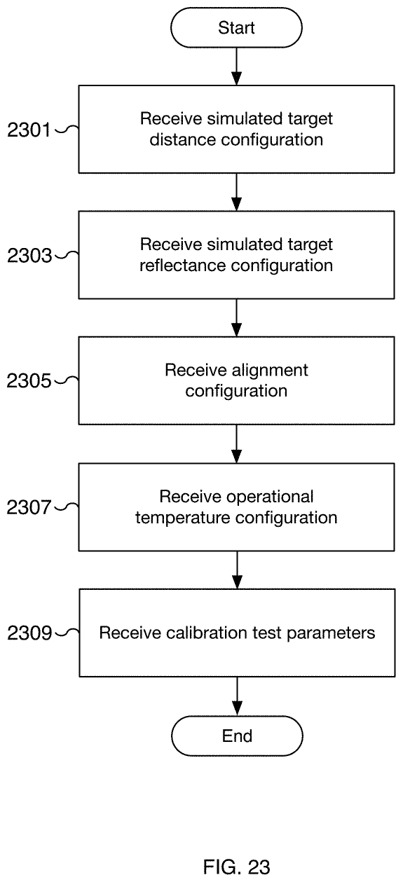

FIG. 23 is a flow chart illustrating an embodiment of a process for configuring a calibration system for performing range calibration of a lidar system. Using the process of FIG. 23, a range-calibration system can be configured to test, verify, and/or calibrate the accuracy of distance measurements performed by a lidar system. In some embodiments, the process of FIG. 23 is performed at 2201 of FIG. 22. In some embodiments, the calibration process of FIG. 23 is performed using a calibration system such as calibration system 900 of FIG. 9 and/or the calibration system and components described with respect to FIGS. 10-21. In some embodiments, the lidar system being calibrated is lidar system 100 of FIGS. 1-4 and 6, lidar system 951 of FIG. 9, and/or the lidar system associated with FIGS. 10-21.

At 2301, a simulated target distance configuration is received. For example, a distance configuration is received specifying the distance of a target object that the calibration system should simulate. In some embodiments, the target distance is specified as a distance, such as 100 meters away. In some embodiments, the target distance is specified as a temporal delay that should be added to the return pulse of a lidar system. In some embodiments, the distance or delay is selectable from one or more different distances and/or temporal delays. In various embodiments, the received configuration is used by an optical network. For example, an optical delay unit of an optical network module uses the provided distance configuration to determine the amount of delay to add to a pulse emitted by the lidar device and received at an interface of the calibration system.

At 2303, a simulated target reflectance configuration is received. For example, a reflectance configuration is received specifying the reflectance of a target object that the calibration system should simulate. In various embodiments, the calibration system uses the provided reflectance configuration to attenuate light pulses received from the lidar system to simulate a target object having a particular reflectance value, such as an object with 10% reflectivity. In some embodiments, the reflectance configuration is used by a variable optical attenuator to modulate a received light pulse before the return pulse is directed back to the lidar system. For example, based on the provided reflectance configuration, a variable optical attenuator will apply a particular amount of optical attenuation.

At 2305, an alignment configuration is received. For example, in some embodiments, an alignment configuration is received to align one or more components of the calibration system to the lidar system. For example, an alignment configuration can be used to aim and/or stabilize the position of the lidar system. In some embodiments, the alignment configuration is used to adjust the position and/or orientation of input and/or output collimators of a transceiver assembly of the calibration system. In some embodiments, an alignment configuration is used to adjust a wedge prism wheel of a transceiver assembly of the calibration system.

At 2307, an operational temperature configuration is received. For example, in some embodiments, an operational temperature configuration is received to determine the one or more operational temperatures at which the lidar system should be tested. In some embodiments, the received operational temperature configuration is used by a thermal control unit to control the temperature environment that the lidar system operates in when performing distance calibration. In some embodiments, the configuration is a specific temperature or acceptable temperature range. In some embodiments, the configuration specifies multiple temperatures at which to test the lidar system.

At 2309, calibration test parameters are received. For example, one or more test parameters for defining a calibration test are received. The received parameters can describe the test including the length of the test, the number of targets to simulate, the type of lidar system being tested, and the type of test to perform, among other parameters. For example, the calibration test parameters can specify whether the calibration test is a test to calibrate a new lidar system, a test to either fail or pass a lidar system, a test to recertify a repaired lidar system, or a test to collect accuracy data across multiple lidar systems, among other types of calibration tests.

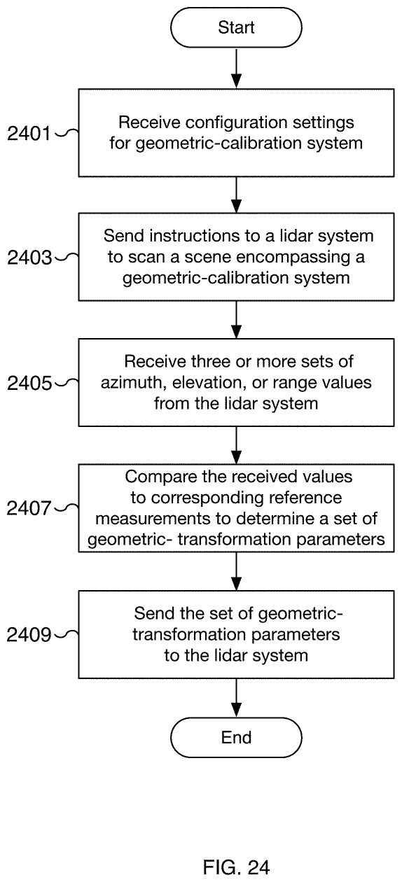

FIG. 24 is a flow chart illustrating an embodiment of a process for performing a geometric calibration of a lidar system. Using the process of FIG. 24, a lidar system can be calibrated to determine the accuracy of its geometric readings. In various embodiments, reference or ground truth measurements are first determined and then compared to the lidar system readings to determine and potentially calibrate the lidar system. In various embodiments, the geometric calibration includes calibrating for at least azimuth and elevation and potentially range (or distance). In some embodiments, the calibration process of FIG. 24 is performed using one or more geometric-calibration targets such as fixture 1700 of FIG. 17 and its target elements. In some embodiments, the calibration system functions as described with respect to the calibration systems and components described with respect to FIGS. 9-21. In some embodiments, the lidar system being calibrated is lidar system 100 of FIGS. 1-4 and 6, lidar system 951 of FIG. 9, and/or the lidar system associated with FIGS. 10-21.

At 2401, configuration settings for the geometric-calibration system are received. The received configuration can include alignment settings, operational temperature settings, a distance setting, and/or a reflectivity setting, among others. In some embodiments, the configuration settings include the positioning of targets in the field-of-view of the lidar system. For example, three or more calibration targets or target elements are placed in the lidar system's field of view. In some embodiments, the geometric-calibration system can receive parameters to simulate multiple objects at a particular position and distance with a specified reflectivity and parameters to run a geometric calibration for a particular temperature or temperature range.

At 2403, instructions are sent to a lidar system to scan a scene encompassing a geometric-calibration system. For example, a lidar system is mounted to a calibration system via an optical platform and placed in an environment with one or more geometric-calibration targets. In some embodiments, three or more target elements are used to calibrate for geometric accuracy. In various embodiments, the lidar system is sent instructions to scan a scene that includes the geometric-calibration targets.

At 2405, three or more sets of azimuth, elevation, or range values are received from the lidar system. For example, the lidar system scans the scene and detects at least three targets with three corresponding sets of measurements. The measurements can include azimuth, elevation, and/or range values for each target. In various embodiments, each target corresponds to a target element mounted on a geometric-calibration fixture.

At 2407, the received values are compared to corresponding reference measurements to determine a set of geometric-transformation parameters. For example, actual geometric values, such as values for azimuth, elevation, or range of each target element are determined and can be based on reference measurements made using an optical-measurement device, such as an optical frequency-domain reflectometer (OFDR), an optical spectrum analyzer (OSA), and/or an optical time-domain reflectometer (OTDR). In various embodiments, the reference measurements correspond to the actual distances or ground truth values. Using the reference measurements, the received values as determined and measured by the lidar unit are compared to the reference measurements. In various embodiments, geometric calibration results are determined. The geometric calibration results can include geometric-transformation parameters. For example, geometric-transformation parameters, such as azimuth, elevation, and/or range offsets or transformation parameters, are determined that when applied to the lidar system, allows the lidar system to account for discrepancies between the lidar system readings and the reference measurements. In some embodiments, the geometric calibration results are correction values such as an azimuth correction value and/or an elevation correction value, that are used to calibrate the lidar system.

At 2409, the set of geometric-transformation parameters is sent to the lidar system. For example, geometric-transformation parameters are provided to the lidar system and used to adjust the accuracy of the lidar geometric readings. In some embodiments, the geometric-calibration parameters are transformation parameters or correction values that are used to modify initial geometric readings by the lidar system. In some embodiments, the geometric-transformation parameters are used to adjust a detection threshold for geometric measurements.

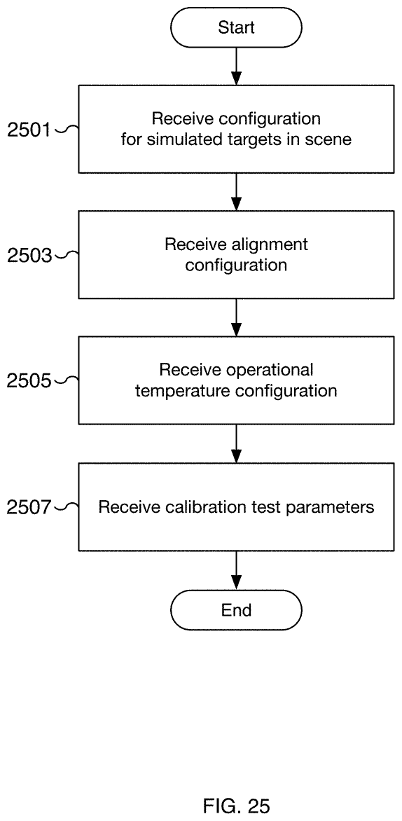

FIG. 25 is a flow chart illustrating an embodiment of a process for configuring a calibration system for performing geometric calibration of a lidar system. Using the process of FIG. 25, a geometric-calibration system can be configured to test, verify, and/or calibrate the accuracy of geometric measurements performed by a lidar system. In some embodiments, the process of FIG. 25 is performed at 2401 of FIG. 24. In some embodiments, the calibration process of FIG. 25 is performed using one or more geometric-calibration targets such as fixture 1700 of FIG. 17 and its target elements. In some embodiments, the calibration system functions as described with respect to the calibration systems and components described with respect to FIGS. 9-21. In some embodiments, the lidar system being calibrated is lidar system 100 of FIGS. 1-4 and 6, lidar system 951 of FIG. 9, and/or the lidar system associated with FIGS. 10-21.

At 2501, the configuration for simulated targets in the scene are received. For example, the lidar system being calibrated is placed near three or more calibration targets or target elements that each simulate a target at a simulated distance in the field-of-view of the lidar system. Configurations for each of the targets is received. In some embodiments, the configurations include configuration settings for the distance of each object and a reflectance value. In some embodiments, the configuration for the simulated targets includes geometric parameters based on their geometric positions relative to the lidar system. In various embodiments, the received configuration is used by the calibration system, for example, to attenuate and/or introduce delays to return pulses for the lidar system.

At 2503, an alignment configuration is received. For example, in some embodiments, an alignment configuration is received to align one or more components of the calibration system to the lidar system. For example, an alignment configuration can be used to aim and/or stabilize the position of the lidar system and to ensure that the target elements are within the field-of-view of the lidar system. In some embodiments, the alignment configuration is used to adjust the position and/or orientation of the geometric-calibration targets.

At 2505, an operational temperature configuration is received. For example, in some embodiments, an operational temperature configuration is received to determine the one or more operational temperatures at which the lidar system should be tested. In some embodiments, the received operational temperature configuration is used by a thermal control unit to control the temperature environment that the lidar system operates in when performing geometric calibration. In some embodiments, the configuration is a specific temperature or acceptable temperature range. In some embodiments, the configuration specifies multiple temperatures at which to test the lidar system.

At 2507, calibration test parameters are received. For example, one or more test parameters for defining a calibration test are received. The received parameters can describe the test including the length of the test, the number of targets to simulate, the type of lidar system being tested, and the type of test to perform, among other parameters. For example, the calibration test parameters can specify whether the calibration test is a test to calibrate a new lidar system, a test to either fail or pass a lidar system, a test to recertify a repaired lidar system, or a test to collect accuracy data across multiple lidar systems, among other types of calibration tests.

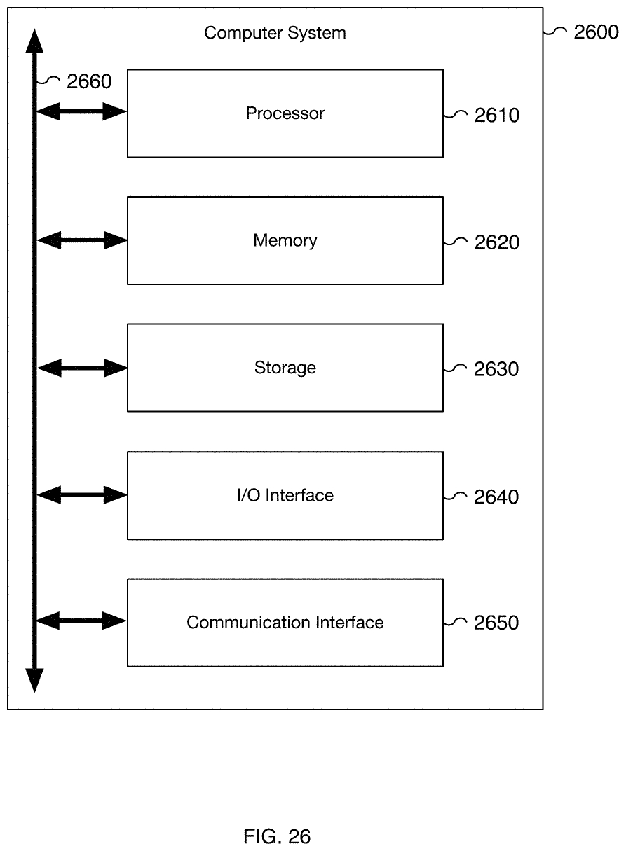

FIG. 26 illustrates an example computer system 2600. In particular embodiments, one or more computer systems 2600 may perform one or more steps of one or more methods described or illustrated herein. In particular embodiments, one or more computer systems 2600 may provide functionality described or illustrated herein. In particular embodiments, software running on one or more computer systems 2600 may perform one or more steps of one or more methods described or illustrated herein or may provide functionality described or illustrated herein. Particular embodiments may include one or more portions of one or more computer systems 2600. In particular embodiments, a computer system may be referred to as a processor, a controller, a computing device, a computing system, a computer, a general-purpose computer, or a data-processing apparatus. Herein, reference to a computer system may encompass one or more computer systems, where appropriate. In some embodiments, computer system 2600 is used to perform one or more of the processes of FIGS. 22-25. In some embodiments, instances of computer system 2600 are part of a compute unit of a calibration system such as calibration system 900 of FIG. 9. In some embodiments, the corresponding compute unit is compute unit 903 of FIG. 9, compute unit 1003 of FIG. 10, and/or the compute unit(s) associated with systems, components, and/or devices of FIGS. 11-21.

Computer system 2600 may take any suitable physical form. As an example, computer system 2600 may be an embedded computer system, a system-on-chip (SOC), a single-board computer system (SBC), a desktop computer system, a laptop or notebook computer system, a mainframe, a mesh of computer systems, a server, a tablet computer system, or any suitable combination of two or more of these. As another example, all or part of computer system 2600 may be combined with, coupled to, or integrated into a variety of devices, including, but not limited to, a camera, camcorder, personal digital assistant (PDA), mobile telephone, smartphone, electronic reading device (e.g., an e-reader), game console, smart watch, clock, calculator, television monitor, flat-panel display, computer monitor, vehicle display (e.g., odometer display or dashboard display), vehicle navigation system, lidar system, ADAS, autonomous vehicle, autonomous-vehicle driving system, cockpit control, camera view display (e.g., display of a rear-view camera in a vehicle), eyewear, or head-mounted display. Where appropriate, computer system 2600 may include one or more computer systems 2600; be unitary or distributed; span multiple locations; span multiple machines; span multiple data centers; or reside in a cloud, which may include one or more cloud components in one or more networks. Where appropriate, one or more computer systems 2600 may perform without substantial spatial or temporal limitation one or more steps of one or more methods described or illustrated herein. As an example, one or more computer systems 2600 may perform in real time or in batch mode one or more steps of one or more methods described or illustrated herein. One or more computer systems 2600 may perform at different times or at different locations one or more steps of one or more methods described or illustrated herein, where appropriate.

As illustrated in the example of FIG. 26, computer system 2600 may include a processor 2610, memory 2620, storage 2630, an input/output (I/O) interface 2640, a communication interface 2650, or a bus 2660. Computer system 2600 may include any suitable number of any suitable components in any suitable arrangement.

In particular embodiments, processor 2610 may include hardware for executing instructions, such as those making up a computer program. As an example, to execute instructions, processor 2610 may retrieve (or fetch) the instructions from an internal register, an internal cache, memory 2620, or storage 2630; decode and execute them; and then write one or more results to an internal register, an internal cache, memory 2620, or storage 2630. In particular embodiments, processor 2610 may include one or more internal caches for data, instructions, or addresses. Processor 2610 may include any suitable number of any suitable internal caches, where appropriate. As an example, processor 2610 may include one or more instruction caches, one or more data caches, or one or more translation lookaside buffers (TLBs). Instructions in the instruction caches may be copies of instructions in memory 2620 or storage 2630, and the instruction caches may speed up retrieval of those instructions by processor 2610. Data in the data caches may be copies of data in memory 2620 or storage 2630 for instructions executing at processor 2610 to operate on; the results of previous instructions executed at processor 2610 for access by subsequent instructions executing at processor 2610 or for writing to memory 2620 or storage 2630; or other suitable data. The data caches may speed up read or write operations by processor 2610. The TLBs may speed up virtual-address translation for processor 2610. In particular embodiments, processor 2610 may include one or more internal registers for data, instructions, or addresses. Processor 2610 may include any suitable number of any suitable internal registers, where appropriate. Where appropriate, processor 2610 may include one or more arithmetic logic units (ALUs); may be a multi-core processor; or may include one or more processors 2610.

In particular embodiments, memory 2620 may include main memory for storing instructions for processor 2610 to execute or data for processor 2610 to operate on. As an example, computer system 2600 may load instructions from storage 2630 or another source (such as, for example, another computer system 2600) to memory 2620. Processor 2610 may then load the instructions from memory 2620 to an internal register or internal cache. To execute the instructions, processor 2610 may retrieve the instructions from the internal register or internal cache and decode them. During or after execution of the instructions, processor 2610 may write one or more results (which may be intermediate or final results) to the internal register or internal cache. Processor 2610 may then write one or more of those results to memory 2620. One or more memory buses (which may each include an address bus and a data bus) may couple processor 2610 to memory 2620. Bus 2660 may include one or more memory buses. In particular embodiments, one or more memory management units (MMUs) may reside between processor 2610 and memory 2620 and facilitate accesses to memory 2620 requested by processor 2610. In particular embodiments, memory 2620 may include random access memory (RAM). This RAM may be volatile memory, where appropriate. Where appropriate, this RAM may be dynamic RAM (DRAM) or static RAM (SRAM). Memory 2620 may include one or more memories 2620, where appropriate.

In particular embodiments, storage 2630 may include mass storage for data or instructions. As an example, storage 2630 may include a hard disk drive (HDD), a floppy disk drive, flash memory, an optical disc, a magneto-optical disc, magnetic tape, or a Universal Serial Bus (USB) drive or a combination of two or more of these. Storage 2630 may include removable or non-removable (or fixed) media, where appropriate. Storage 2630 may be internal or external to computer system 2600, where appropriate. In particular embodiments, storage 2630 may be non-volatile, solid-state memory. In particular embodiments, storage 2630 may include read-only memory (ROM). Where appropriate, this ROM may be mask ROM (MROM), programmable ROM (PROM), erasable PROM (EPROM), electrically erasable PROM (EEPROM), flash memory, or a combination of two or more of these. Storage 2630 may include one or more storage control units facilitating communication between processor 2610 and storage 2630, where appropriate. Where appropriate, storage 2630 may include one or more storages 2630.

In particular embodiments, I/O interface 2640 may include hardware, software, or both, providing one or more interfaces for communication between computer system 2600 and one or more I/O devices. Computer system 2600 may include one or more of these I/O devices, where appropriate. One or more of these I/O devices may enable communication between a person and computer system 2600. As an example, an I/O device may include a keyboard, keypad, microphone, monitor, mouse, printer, scanner, speaker, camera, stylus, tablet, touch screen, trackball, another suitable I/O device, or any suitable combination of two or more of these. An I/O device may include one or more sensors. Where appropriate, I/O interface 2640 may include one or more device or software drivers enabling processor 2610 to drive one or more of these I/O devices. I/O interface 2640 may include one or more I/O interfaces 2640, where appropriate.

In particular embodiments, communication interface 2650 may include hardware, software, or both providing one or more interfaces for communication (such as, for example, packet-based communication) between computer system 2600 and one or more other computer systems 2600 or one or more networks. As an example, communication interface 2650 may include a network interface controller (NIC) or network adapter for communicating with an Ethernet or other wire-based network or a wireless NIC (WNIC); a wireless adapter for communicating with a wireless network, such as a WI-FI network; or an optical transmitter (e.g., a laser or a light-emitting diode) or an optical receiver (e.g., a photodetector) for communicating using fiber-optic communication or free-space optical communication. Computer system 2600 may communicate with an ad hoc network, a personal area network (PAN), an in-vehicle network (IVN), a local area network (LAN), a wide area network (WAN), a metropolitan area network (MAN), or one or more portions of the Internet or a combination of two or more of these. One or more portions of one or more of these networks may be wired or wireless. As an example, computer system 2600 may communicate with a wireless PAN (WPAN) (such as, for example, a BLUETOOTH WPAN), a WI-FI network, a Worldwide Interoperability for Microwave Access (WiMAX) network, a cellular telephone network (such as, for example, a Global System for Mobile Communications (GSM) network), or other suitable wireless network or a combination of two or more of these. As another example, computer system 2600 may communicate using fiber-optic communication based on 100 Gigabit Ethernet (100 GbE), 10 Gigabit Ethernet (10 GbE), or Synchronous Optical Networking (SONET). Computer system 2600 may include any suitable communication interface 2650 for any of these networks, where appropriate. Communication interface 2650 may include one or more communication interfaces 2650, where appropriate.

In particular embodiments, bus 2660 may include hardware, software, or both coupling components of computer system 2600 to each other. As an example, bus 2660 may include an Accelerated Graphics Port (AGP) or other graphics bus, a controller area network (CAN) bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local bus (VLB), or another suitable bus or a combination of two or more of these. Bus 2660 may include one or more buses 2660, where appropriate.

In particular embodiments, various modules, circuits, systems, methods, or algorithm steps described in connection with the implementations disclosed herein may be implemented as electronic hardware, computer software, or any suitable combination of hardware and software. In particular embodiments, computer software (which may be referred to as software, computer-executable code, computer code, a computer program, computer instructions, or instructions) may be used to perform various functions described or illustrated herein, and computer software may be configured to be executed by or to control the operation of computer system 2600. As an example, computer software may include instructions configured to be executed by processor 2610. In particular embodiments, owing to the interchangeability of hardware and software, the various illustrative logical blocks, modules, circuits, or algorithm steps have been described generally in terms of functionality. Whether such functionality is implemented in hardware, software, or a combination of hardware and software may depend upon the particular application or design constraints imposed on the overall system.

In particular embodiments, a computing device may be used to implement various modules, circuits, systems, methods, or algorithm steps disclosed herein. As an example, all or part of a module, circuit, system, method, or algorithm disclosed herein may be implemented or performed by a general-purpose single- or multi-chip processor, a digital signal processor (DSP), an ASIC, a FPGA, any other suitable programmable-logic device, discrete gate or transistor logic, discrete hardware components, or any suitable combination thereof. A general-purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In particular embodiments, one or more implementations of the subject matter described herein may be implemented as one or more computer programs (e.g., one or more modules of computer-program instructions encoded or stored on a computer-readable non-transitory storage medium). As an example, the steps of a method or algorithm disclosed herein may be implemented in a processor-executable software module which may reside on a computer-readable non-transitory storage medium. In particular embodiments, a computer-readable non-transitory storage medium may include any suitable storage medium that may be used to store or transfer computer software and that may be accessed by a computer system. Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs (e.g., compact discs (CDs), CD-ROM, digital versatile discs (DVDs), blu-ray discs, or laser discs), optical disc drives (ODDs), magneto-optical discs, magneto-optical drives, floppy diskettes, floppy disk drives (FDDs), magnetic tapes, flash memories, solid-state drives (SSDs), RAM, RAM-drives, ROM, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

In particular embodiments, certain features described herein in the context of separate implementations may also be combined and implemented in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

While operations may be depicted in the drawings as occurring in a particular order, this should not be understood as requiring that such operations be performed in the particular order shown or in sequential order, or that all operations be performed. Further, the drawings may schematically depict one more example processes or methods in the form of a flow diagram or a sequence diagram. However, other operations that are not depicted may be incorporated in the example processes or methods that are schematically illustrated. For example, one or more additional operations may be performed before, after, simultaneously with, or between any of the illustrated operations. Moreover, one or more operations depicted in a diagram may be repeated, where appropriate. Additionally, operations depicted in a diagram may be performed in any suitable order. Furthermore, although particular components, devices, or systems are described herein as carrying out particular operations, any suitable combination of any suitable components, devices, or systems may be used to carry out any suitable operation or combination of operations. In certain circumstances, multitasking or parallel processing operations may be performed. Moreover, the separation of various system components in the implementations described herein should not be understood as requiring such separation in all implementations, and it should be understood that the described program components and systems may be integrated together in a single software product or packaged into multiple software products.

Various embodiments have been described in connection with the accompanying drawings. However, it should be understood that the figures may not necessarily be drawn to scale. As an example, distances or angles depicted in the figures are illustrative and may not necessarily bear an exact relationship to actual dimensions or layout of the devices illustrated.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes or illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend.

The term “or” as used herein is to be interpreted as an inclusive or meaning any one or any combination, unless expressly indicated otherwise or indicated otherwise by context. Therefore, herein, the expression “A or B” means “A, B, or both A and B.” As another example, herein, “A, B or C” means at least one of the following: A; B; C; A and B; A and C; B and C; A, B and C. An exception to this definition will occur if a combination of elements, devices, steps, or operations is in some way inherently mutually exclusive.

As used herein, words of approximation such as, without limitation, “approximately, “substantially,” or “about” refer to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skill in the art recognize the modified feature as having the required characteristics or capabilities of the unmodified feature. In general, but subject to the preceding discussion, a numerical value herein that is modified by a word of approximation such as “approximately” may vary from the stated value by ±0.5%, ±1%, ±2%, ±3%, ±4%, ±5%, ±10%, ±12%, or ±15%. The term “substantially constant” refers to a value that varies by less than a particular amount over any suitable time interval. For example, a value that is substantially constant may vary by less than or equal to 20%, 10%, 1%, 0.5%, or 0.1% over a time interval of approximately 10⁴ s, 10³ s, 10² s, 10 s, 1 s, 100 ms, 10 ms, 1 ms, 100 us, 10 us, or 1 us. The term “substantially constant” may be applied to any suitable value, such as for example, an optical power, a pulse repetition frequency, an electrical current, a wavelength, an optical or electrical frequency, or an optical or electrical phase.

As used herein, the terms “first,” “second,” “third,” etc. may be used as labels for nouns that they precede, and these terms may not necessarily imply a particular ordering (e.g., a particular spatial, temporal, or logical ordering). As an example, a system may be described as determining a “first result” and a “second result,” and the terms “first” and “second” may not necessarily imply that the first result is determined before the second result.

As used herein, the terms “based on” and “based at least in part on” may be used to describe or present one or more factors that affect a determination, and these terms may not exclude additional factors that may affect a determination. A determination may be based solely on those factors which are presented or may be based at least in part on those factors. The phrase “determine A based on B” indicates that B is a factor that affects the determination of A. In some instances, other factors may also contribute to the determination of A. In other instances, A may be determined based solely on B.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
an interface configured to receive a pulse of light emitted by a lidar device; and
an optical network configured to provide a particular temporal delay of one or more different temporal delays to the received pulse of light;
wherein the system is configured to direct the temporal delayed pulse to the lidar device.

2. The system of claim 1, wherein the temporal delayed pulse is directed to the lidar device as a free-space pulse of light.

3. The system of claim 1, wherein the optical network includes one or more optical fibers having different lengths corresponding to the different temporal delays, and a member of the one or more optical fibers is selectable to select a desired temporal delay among the different temporal delays.

4. The system of claim 1, wherein the interface includes an input optical collimator and an output optical collimator.

5. The system of claim 4, wherein the input optical collimator or the output optical collimator is mounted to a servo mount.

6. The system of claim 5, wherein the servo mount is configurable in at least two orthogonal directions.

7. The system of claim 1, wherein the optical network includes a variable optical attenuator.

8. The system of claim 7, wherein the variable optical attenuator is configured to apply a particular amount of optical attenuation to the received pulse of light.

9. The system of claim 1, wherein the optical network includes two or more optical switches, wherein each of the two or more optical switches is optically connected to a single fiber delay line of a plurality of fiber delay lines.

10. The system of claim 9, wherein a first fiber delay line of the plurality of fiber delay lines has an optical delay that is at least twice as long as an optical delay of a second fiber delay line of the plurality of fiber delay lines.

11. The system of claim 1, wherein the optical network includes a fiber tap configured to send a portion of the received pulse of light to a monitoring module.

12. The system of claim 11, wherein the monitoring module includes an oscilloscope configured to measure the received pulse of light.

13. The system of claim 1, further comprising a compute unit, wherein the compute unit is configured to select the particular temporal delay of the one or more different temporal delays.

14. The system of claim 13, wherein the particular temporal delay is selected by providing a corresponding distance measurement.

15. The system of claim 13, wherein the compute unit is further configured to select a particular attenuation to apply to the received pulse of light.

16. The system of claim 1, further comprising:
an optical platform, wherein the lidar device is mounted to the optical platform; and
a thermal control unit, wherein the thermal control unit is configured to modify an operational temperature of the lidar device.

17. A method comprising:
sending instructions to a lidar device to scan a scene, wherein the lidar device is mounted to a calibration system;
receiving at an interface a pulse of light emitted by the lidar device;
inserting using an optical network a particular temporal delay of one or more different temporal delays to generate a temporal delayed pulse; and
directing the temporal delayed pulse to the lidar device.

18. The method of claim 17, further comprising:
applying a particular amount of optical attenuation to the received pulse of light.

19. The method of claim 17, further comprising:
determining one or more distance correction parameters based on a distance measurement determined by the lidar device, wherein the distance measurement is based on the pulse of light emitted by the lidar device and the temporal delayed pulse.

20. A system, comprising:
an interface configured to receive a pulse of light emitted by a lidar device; and
an optical network configured to attenuate the received pulse of light and provide a temporal delay to the received pulse of light;
wherein the system is configured to direct the attenuated and temporal delayed received pulse of light to the lidar device.
